(19) United States
(12) Patent Application Publication
(10) Pub. No.: US 2013/0254126 A1
(43) Pub. Date: Sep. 26, 2013

(54) Method of annotating portions of a transactional legal document related to a merger or acquisition of a business entity with graphical display data related to current metrics in merger or acquisition transactions

(71) Applicants: William P. KOENIG, Denver, CO (US); Glenn A. Kramer, San Francisco, CA (US); Daniel A. Urbano, Oakland, CA (US); Mark B. Vogel, San Francisco, CA (US)

(72) Inventors: William P. KOENIG, Denver, CO (US); Glenn A. Kramer, San Francisco, CA (US); Daniel A. Urbano, Oakland, CA (US); Mark B. Vogel, San Francisco, CA (US)

(73) Assignee: SHAREHOLDER REPRESENTATIVE SERVICES, LLC., Denver, CO (US)

(21) Appl. No.: 13/542,042

(22) Filed: Jul. 5, 2012

Related U.S. Application Data
(60) Provisional application No. 61/614,231, filed on Mar. 22, 2012.

(51) Int. Cl. G06Q 50/18

(52) U.S. Cl. 705/311

(57) ABSTRACT

A method is provided for annotating portions of a transactional legal document related to a merger or acquisition of a business entity. An electronic data source is maintained that stores data related to a plurality of different metrics in merger or acquisition transactions. At least some of the data is updated as new merger or acquisition transactions occur. Portions of a legal document are electronically annotated with one or more annotations that graphically display data related to different metrics in merger or acquisition transactions. The annotations are created using the data stored in the electronic data source. The annotations reflect the most current data stored in the electronic data source. At least some of the annotations change over time as new merger or acquisition transactions occur.

### CROSS-REFERENCE TO RELATED APPLICATIONS

This application claims priority to U.S. Provisional Patent Application No. 61/614,231 filed Mar. 22, 2012, which is incorporated herein by reference.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

The present invention relates to a method and system of creating annotated documents, wherein such annotations can be used to help people understand a document more fully, revise it to be conformant with best practices, or extract information from the document into more structured storage such as a conventional database.

Many document entry systems and collaboration systems allow users to annotate documents with their own information. For example, U.S. Pat. No. 7,493,559 (Wolff et al.) discloses a method of annotating images with information of interest to a user, and more specifically, attaches user-specific annotations to the content. In this patent, the annotation does not exist in any data store, but rather the user creates it as a mnemonic for recalling the image.

Collaborative systems exist in several forms. One collaboration method is sharing markups as an overlay to an otherwise static document. U.S. Pat. No. 6,859,909 (Lerner et al.) discloses a method of annotating a document by “freezing” the document, and adding an overlay image on which annotations are placed. A related method of using overlays is disclosed in U.S. Pat. No. 5,826,025 (Gramlich).

Another method of collaboration is disclosed in U.S. Pat. No. 7,827,253 (Jones et al.), which uses messaging to allow two remote collaborators to “point to” or “emphasize” a portion of a web page in real time. This patent states that the emphasized portion of the document is not persistent, and is not stored on the back end with the document.

Still other systems allow annotating a document with static metadata, which applies to a wide class of documents, but they do not make inferences about the semantic structure of document. See, for example, U.S. Pat. No. 7,979,405 (Cahill et al.). U.S. Pat. No. 6,901,409 (Dessloch et al.) discloses assembling static content (a software module) from a variety of sources, but this is applied to a static software template, not to a human-generated document of high variability.

The prior art discussed above exposes a need for a method of augmenting documents not with arbitrary, user-supplied annotations, but with specific annotations that come from a body of analysis of similar documents, along with data summarizing any effects resulting from those documents. Furthermore, unlike annotations in U.S. Pat. No. 7,979,405 (Cahill et al.) and U.S. Pat. No. 6,901,409 (Dessloch et al.), the desired annotations are not static in nature, but rather are required to reflect the state of knowledge about the document corpus as known at the time of annotation, with data updated regularly.

The present invention differs from those described above in that it applies to documents that have some formal structure (generally formatting instructions), but less formal semantic structure. An example of such a document is a merger agreement or other contract. Since mergers must cover certain statutory and customary details, they tend to have a small inventory of predictable sections, albeit arranged differently and named differently according to the conventions of the people who authored the agreements or the conventions of the specific practice area of the companies involved. Nonetheless, each document contains a list of definitions of terms, a description of the consideration for the transaction, a list of representations and warranties, indemnification clauses, and the like.

Because of this similarity among documents, any entity which has accumulated data on large numbers of transactions or has access to a large number of documents (such as merger agreements, contracts, technical manuals, and the like) may be able to use the accumulated data to help provide feedback on drafting any new documents.

Other legal documents, such as more general contracts also follow a similar set of conventions. Many documents, particularly contracts, specify a series of actions that must take place over time, with portions of the consideration being paid as certain milestones are met. Thus, the document may be abstracted into a docket, and the calendar of docketed events can be entered into a workflow system.

While the present invention is described in the context of legal documents, it should be clear to those skilled in the art that the same invention is applicable to other areas. Such areas include, but are not limited to: Other legal documents—licensing agreements and financing agreements; Medical—augmenting doctors' dictation and electronic medical records, response training documents that can be fed back to real-time information on treatments vs. outcomes, treatment interactions, etc.; Construction—architecture detailing, code compliance, and site planning; and, Large-scale manufacturing—checklists and best practices in areas such as automotive and aerospace engineering.

### SUMMARY OF THE INVENTION

Preferred embodiments of the present invention provide a computer-based system for adding annotations to documents based on a dynamic database of data gathered from similar transactions to allow a reader of the annotated version to practically assess relative risks of various subject matter and how their terms compare with the terms of other similar transactions, with structure determined via a combination of document tags and key words/phrases.

Documents are informally structured (also, referred to herein as “semi-structured”), meaning that the semantic content of a document is derived from a combination of tagging and natural language Annotations take various forms, including charts, graphs, and text items, all of which can be queried from a database whose contents may be updated in real time. Annotations reflect data that are current as of annotation time.

A user of the system navigates a set of context-sensitive menus to insert annotations, which are derived from sources of data that may be updated in real time. Each time a user annotates a document, a machine learning system optionally augments a database associating key words and phrases with the annotations, allowing the system to learn to disambiguate between various parts of the document.

The user provides implied guidance to the learning system by placing annotations at specific locations. This disambiguation is used to make context-sensitive menus more accurate and to create automated recommendations for document annotation, improving as more documents are processed by the system. Another benefit of this learning process is that the same automated document understanding can drive other data interpretation applications than that used for the original annotation.

One preferred embodiment of the present invention comprises a system for storing, annotating, retrieving, and printing documents; a method and apparatus for structuring menu data and associating menu items with database queries that can be run against sources of data that could be updated at arbitrary intervals; and, a system and method of employing user-provided annotation cues to increase the accuracy of key phrase recognition to aid in automated analysis and annotation of documents.

### BRIEF DESCRIPTION OF DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. However, the invention is not limited to the precise arrangements and instrumentalities shown.

FIGS. 1A and 1B are illustrations of a system architecture in accordance with one preferred embodiment of the present invention.

FIGS. 2-7 illustrate the usage of the system on a typical merger agreement document.

FIG. 2 illustrates the user interaction screen, including the document and annotation areas.

FIG. 3 illustrates a context-sensitive cascading menu.

FIG. 4 depicts the annotations inserted from the menu selection of FIG. 3.

FIG. 5 illustrates a second menu.

FIG. 6 depicts the content from the menu selection of FIG. 5.

FIG. 7 illustrates how clicking the document in a different context leads to a different menu.

FIG. 8 is a flowchart illustrating the process of inserting context-sensitive information into a document in response to user interaction.

FIG. 9 is a flowchart depicting the process of inserting content in the Uniform Resource Name (URN) database, including checks for consistency of the data.

FIG. 10 is a code fragment illustrating how URNs are stored in the Annotation Database.

FIG. 11 is a code fragment illustrating how context-sensitive menus are dynamically created from a table of URNs.

FIG. 12 is a flowchart illustrating the process of dynamically building a context sensitive menu from the URN database.

FIG. 13 is a flowchart illustrating the process of importing a document into the system and preparing it for the annotation process.

FIG. 14 is a flowchart illustrating the initialization of the machine learning component.

FIG. 15 is a flowchart illustrating the incremental update of prior probabilities into the machine learning component, based upon a newly annotated document.

FIG. 16 is a flowchart illustrating how the probability of a text fragment pertaining to a particular URN concept is determined.

FIG. 17 is a diagram illustrating how a tentative annotation may be indicated vs. one which has been user-verified in an embodiment that utilizes machine learning.

FIG. 18 illustrates how dynamic menu reordering helps guide default annotations in an embodiment that utilizes machine learning.

FIG. 19 is a flowchart illustrating the use of an annotation ranking engine.

FIG. 20 is a flowchart illustrating the use of a disambiguation engine.

FIGS. 21-75 shows examples of annotations for merger agreements.

### DETAILED DESCRIPTION OF THE INVENTION

Certain terminology is used herein for convenience only and is not to be taken as a limitation on the present invention.

This patent application includes an Appendix having a file named Appendix688398-2U1.txt, created on Jun. 28, 2012, and having a size of 71,430 bytes. The Appendix is incorporated by reference into the present patent application. One preferred embodiment of the present invention is implemented via the source code in the Appendix. The Appendix is subject to the “Copyright Notice and Authorization” stated above.

The present invention is described in the context of features provided in a web-based commercially available product/service called SRS Merger Agreement Extender (MAX™) marketed by Shareholder Representative Services LLC, Denver, Colo. However, the scope of the present invention is not limited to this particular implementation of the invention.

There are several embodiments of the present invention, falling into two main classes: Embodiments without machine learning, and embodiments with machine learning. The embodiments with machine learning use the embodiments without machine learning as incorporated components, so the embodiments are described first without machine learning, then with machine learning.

### I. Embodiments Without Machine Learning

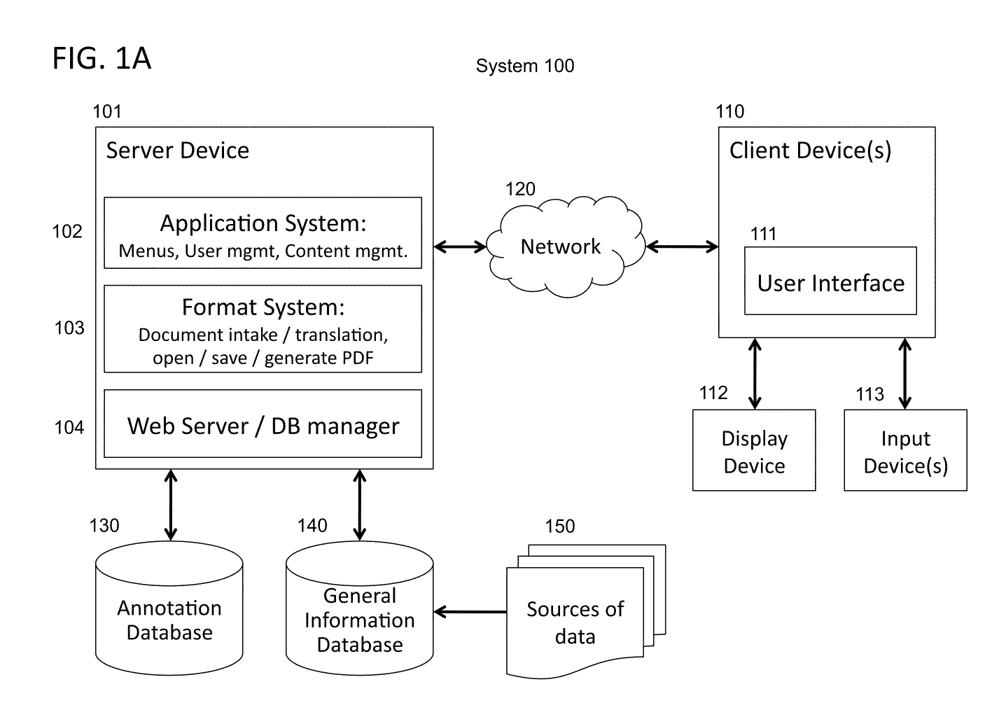

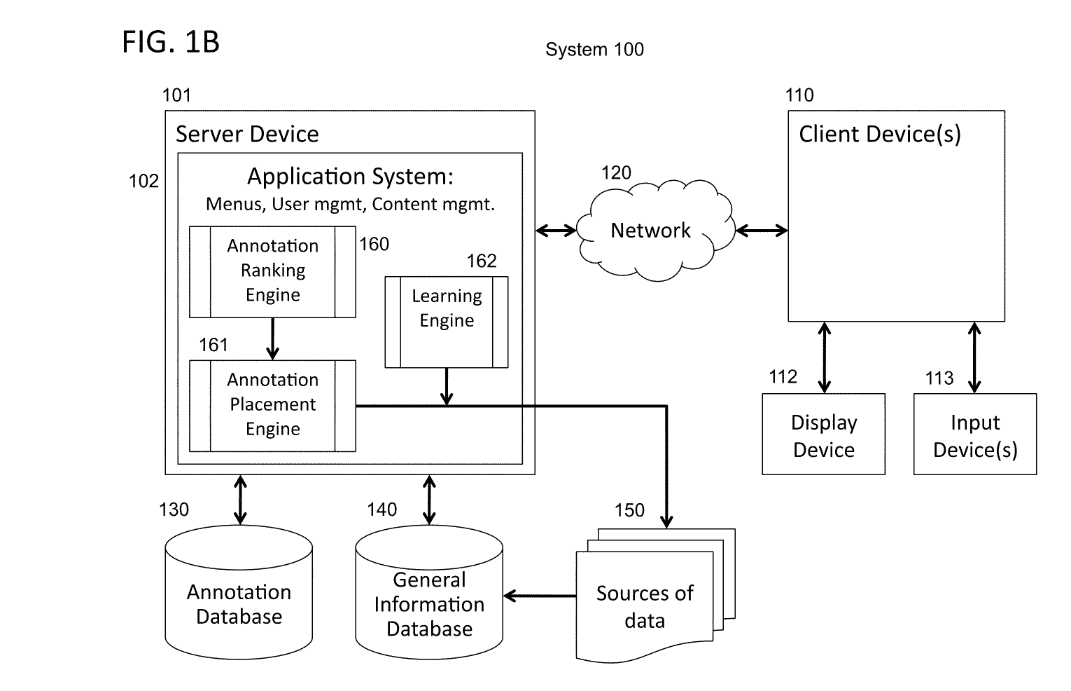

FIG. 1A shows one embodiment of a system in accordance with the present invention. The system 100 includes a Server Device 101 attached to at least one data store, wherein some of the data is in an Annotation Database 130, with information pertaining to the process of annotating and storing specific documents. Other data resides in General Information Database 140. Such data could include information distilled from a number of Sources of Data 150, such as prior documents, spreadsheets, analysis of performance of contracts governed by those documents, statistical distillations of performance, and simulations of potential performance. While Annotation Database 130 and General Information Database 140 are shown separately, they may be installed in the same physical database system, or may comprise several different types of data stores, including but not limited to: spreadsheets, relational databases, document-oriented databases, and object-oriented databases. The data stores and the information contained therein are also referred to herein as “data sources.”

Server Device 101 contains Web Server/DB manager 104, which provides the basic machinery for connecting Application System 102 and Format System 103 to Client Device(s) 110. Application System 102 contains the systems to create menus, format content, manage system users, and provide other business-level functions to Client Device(s) 110. Format System 103 handles translation of documents between various formats, storage of documents in the Annotation Database 130, and creation of printer-ready or device-ready formats including, but not limited to Portable Document Format (PDF), PostScript format, and ePub format.

In some embodiments, an annotated document is viewed in a printer-ready or device-ready format, either on paper or on a computer or specialized document viewing device. In such cases, formats such as PDF, PostScript, or ePub are appropriate for the annotated document. In other embodiments, an annotated document is viewed interactively on a client device. In such case, more interactive formats, such as HTML, JavaScript®, and Adobe Flash®, may be more appropriate. A preferred embodiment supports both forms of viewing annotated documents.

While in some embodiments, Server Device 101 and one or more Client Device(s) 110 can reside on the same physical hardware, in most embodiments Server Device and multiple Client Devices will reside on separate hardware, communicating via Network 120. This Network may be a local area network or a wide area network (the Internet, for example).

In a preferred embodiment, Server Device 101 communicates with Client Device 110 using standard established protocols, such as TCP/IP and HTTPS, and using data interchange formats such as XML and JSON. However, any acceptable communications protocols and data formats may be substituted.

There may in fact be multiple instances of Client Device 110 connected to a single instance of the Server Device. In a preferred embodiment, communications between Server Device and Client Device are encrypted.

Client Device 110 is generally a device with significant computational ability. In a preferred embodiment, Client Device 110 runs the User Interface 111 code locally. In other embodiments, Client Device 110 may be a “thin” device, with most of the User Interface code being run in Application System 102. In the described embodiment, User Interface 111 code consists of a web browser interpreting HTML, running JavaScript, running the jQuery extensions to JavaScript, and using the embedded HTML editing capabilities of the underlying browser.

Client Device 110 has a Display Device 112 and one or more Input Devices 113, such as keyboard or mouse. In some embodiments, the Display Device and Input Device may be the same, as in the case of a touch-screen on a tablet computer.

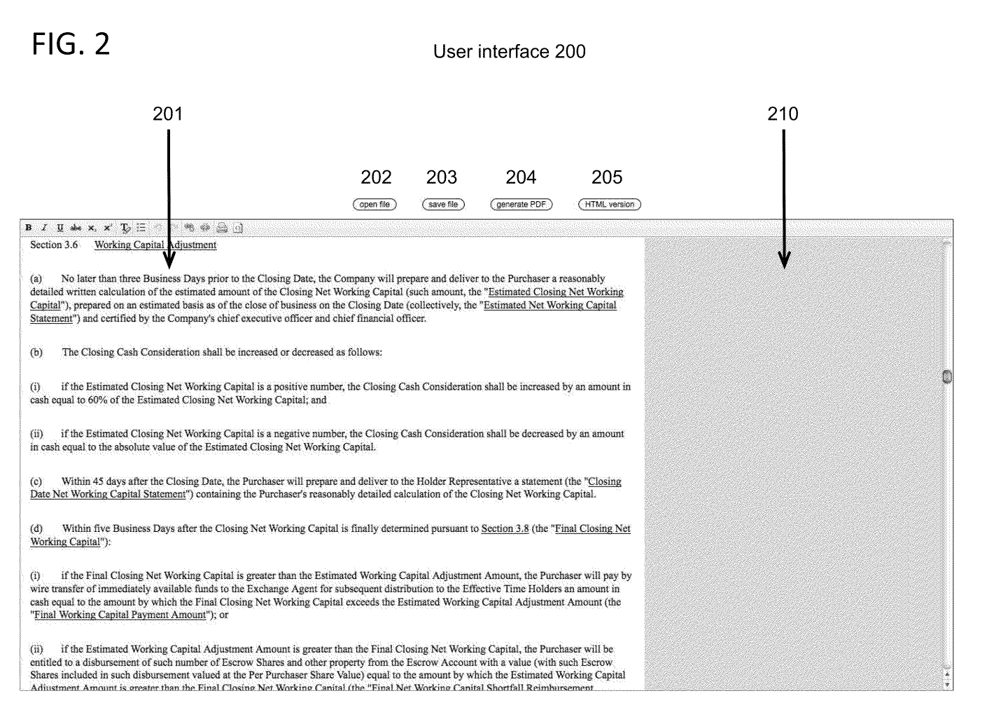

FIG. 2-FIG. 7 illustrate the user interface (also, referred to herein as a “user interface display screen”) of one preferred embodiment of the present invention, as seen on a Client Device 110.

FIG. 2 depicts the user interface 200 of the system when a document has been loaded, but before any annotations have been made. The left hand side is the document area 201, which contains an editable version of the document. This document is loaded into the system via uploading to the Server Device 101 and using the Format System 103. Once in an appropriate format, annotations can be added to the document. Annotations are added to the right-hand side, the Annotation Area 210 (with the exception of redlining, which occurs in document area 201). Other than these areas, there are buttons 202, 203, 204, 205 to handle tasks like opening and saving files, and generating other formats such as HTML or PDF.

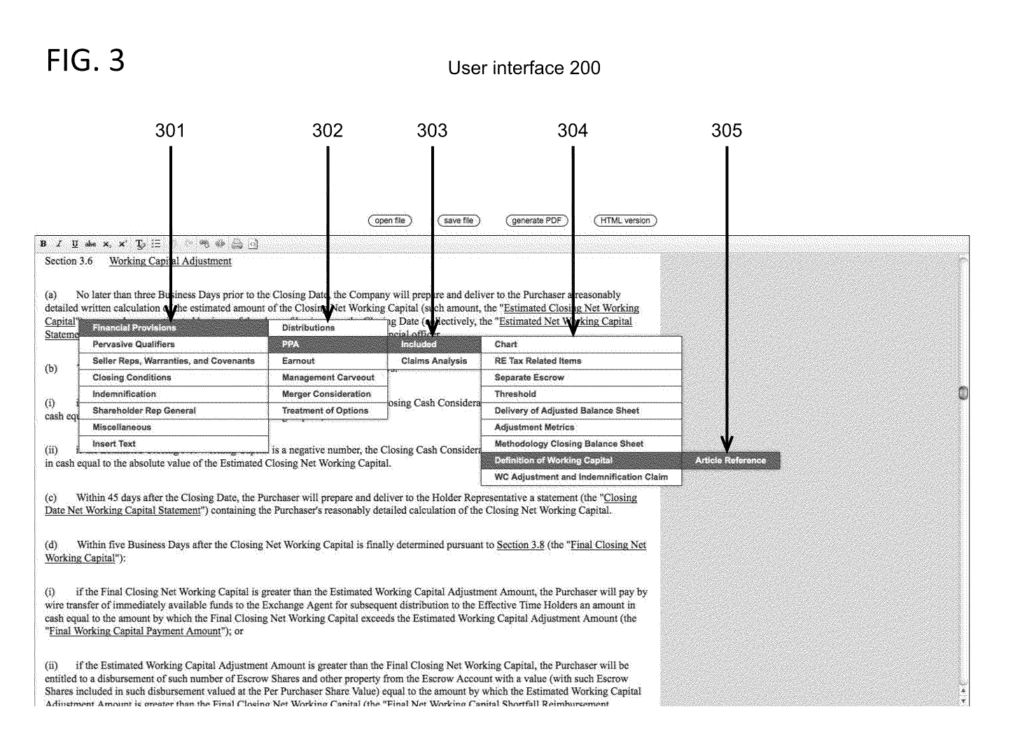

To add an annotation, the user places the cursor at an appropriate position in the document, where the user would like to add some commentary. The user right-clicks at this point in main document 201 to get a context menu. FIG. 3 depicts User Interface 200 with five levels of menu 301, 302, 303, 304, 305, exposed in response to a series of mouse (or other pointing device 113) movements. The path through the menu structure traverses a data structure that reflects the hierarchy of information stored in Annotation Database 130 and/or General Information Database 140.

The first menu 301 brings up “Financial Provisions,” “Pervasive Qualifiers,” and other top-level concepts. When the user selects “Financial Provisions,” by rolling the mouse over it or indicating with a pointing device) the next level 302 automatically appears. Similarly, when the user chooses “PPA” on submenu 302, the process continues, until a leaf node is reached—menu item 305, “Article Reference.” Only leaf nodes of the menu structure are clickable.

The structure of these menus are described by a series of Uniform Resource Names (URNs), similar in concept to a Uniform Resource Identifier (URI), of which the Uniform Resource Locator (URL) used on web servers is an example. The flowchart that explains how these menus get created is described in detail below. The present invention uses a slightly different notation, in that the “|” character separates levels of the hierarchy, whereas a “/” character is used in URLs. The reason for this is that the “/” character appears in the names of menu hierarchy concepts, and it is simpler to use a character that does not appear frequently to avoid quoting issues.

The URN that describes the menu path in FIG. 3 is:

srs:||Financial Provisions|PPA|Included|

[symbol]
Definition of Working Capital|Article Reference

The character “ [symbol] ” denotes that the line should continue unbroken (the break is only present due to formatting limitations of the present document).

This URN denotes two concepts, as follows:
1. The URN as a whole references a particular piece of content to be placed in the annotations section 210 of the document.
2. The URN, using the “|” character as a separator, denotes the path hierarchy through the cascading menu that results in the content represented by the leaf node of the menu.

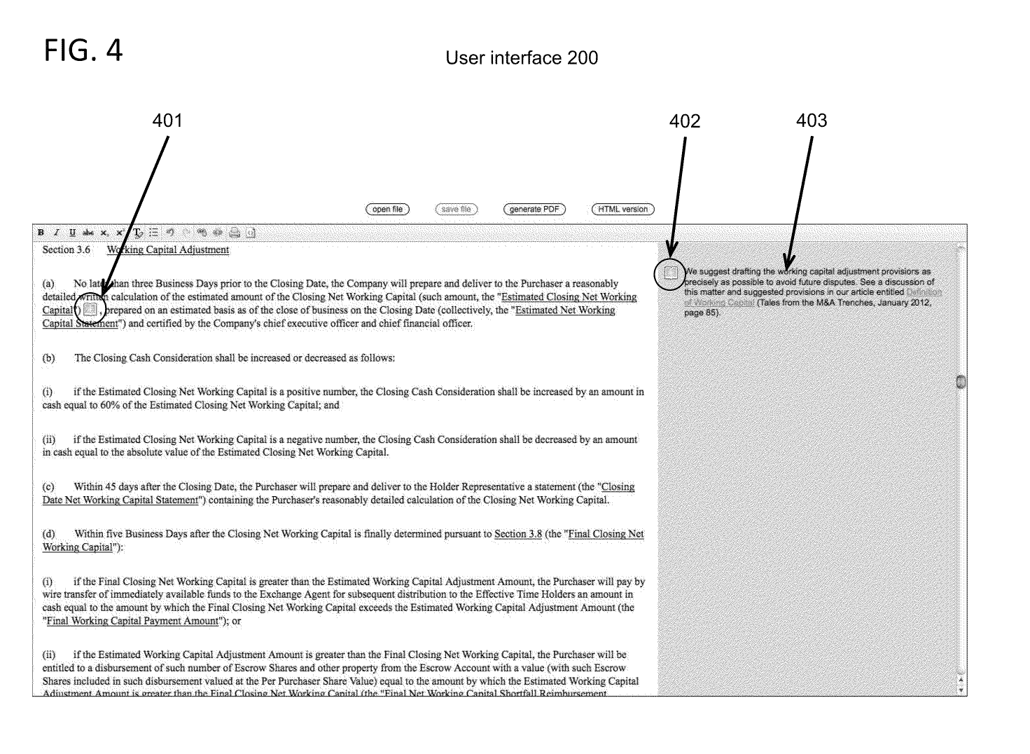

FIG. 4 illustrates the state of the user interface after the user has clicked on the leaf node of the menu. Three items have been added to the document. Inline icon 401 is placed in the text exactly where the user clicked to bring up the menu. A corresponding icon 402 is inserted at the edge of the annotation area; the icon in the text area is linked to the icon in the annotation area so they can reference each other. The specific content denoted by the URN has been inserted at 403.

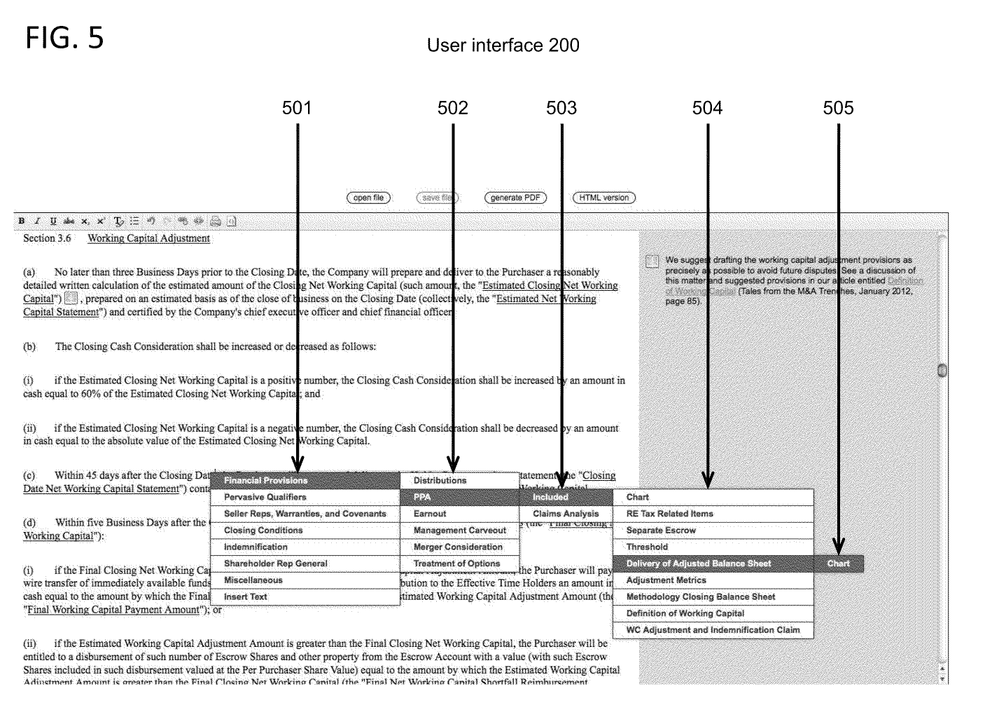

FIG. 5 illustrates another menu selection through cascading menu items 501, 502, 503, 504, and 505, ending in a chart.

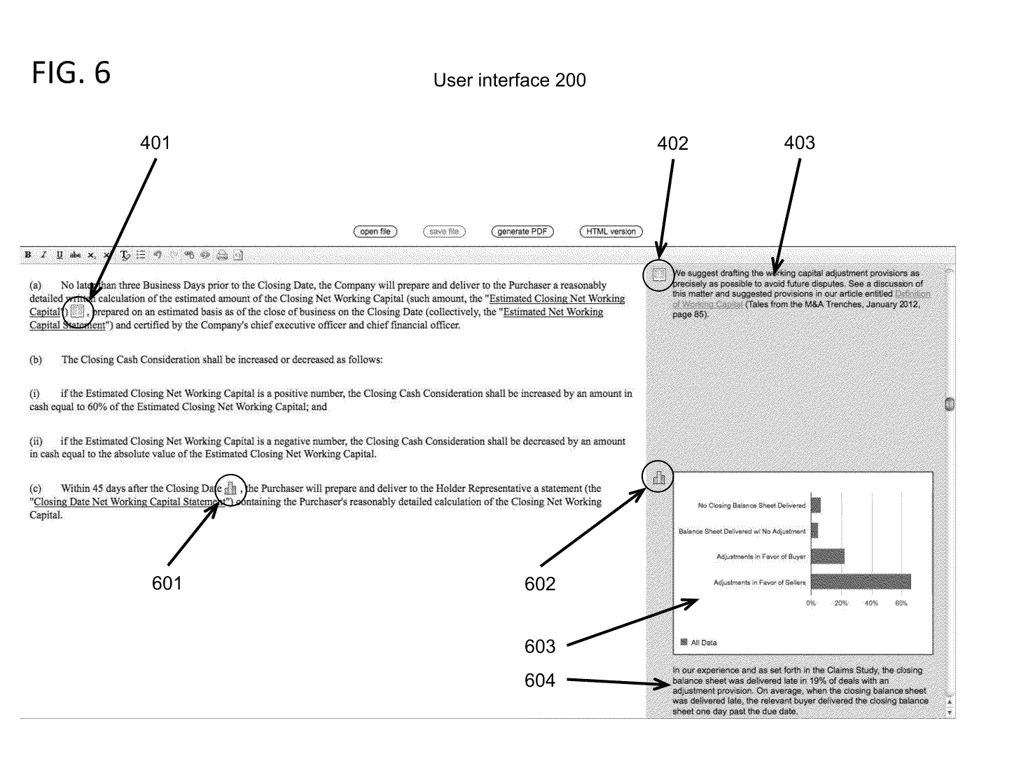

FIG. 6 shows the result of the user clicking on the “Chart” menu item 505. As with FIG. 4, there is a new inline icon 601 in the text, a new annotation icon 602, and the content, chart 603. There is also a text element 604. A single click by the user can annotate a document with any combination of annotations of different types, in this case chart 603 and text block 604. The manner in which the chart is generated is inventive. When the user clicks on menu item 505 of FIG. 5, the corresponding URN is sent from the user interface code 111 of Client Device 110, to the Server Device 101:

srs:||Financial Provisions|PPA|Included|

[symbol]
Delivery of Adjusted Balance Sheet|Chart

When Server Device 101 receives this URN, the Application System 102 checks a local database table urn_data in Annotation Database 130, looking up the URN, and obtaining three items: An action, which denotes what type of data exists in the urn_data table; and icon identifier, which denotes what icon to display; and the actual content to operate on. The logic of Application System 102 is based on a number of factors, but the dispatch function getReturnObj below determines at a high level what happens to the data.

```
function getReturnObj ($action, $icon, $content) {
  $obj = new JsonError(“Unknown error parsing action and
content”);
  switch ($action) {
  case “USERTEXT”:
    $obj = new UserHtml($icon);
    $obj = $obj->toSerializable( );
    break;
  case “SUBMENU”:
    $obj = new JsonError(“Dangling SUBMENU”);
    break;
  case “TEXT”:
  case “REFERENCE”:
    $obj = new StoredHtml($action, $icon, $content);
    $obj = $obj->toSerializable( );
    break;
  case “GRAPH”:
    $obj = new GraphData($icon, $content);
    $obj = $obj->toSerializable( );
    break;
  default:
    $obj = new JsonError(“Unknown action: $action”);
  } // end switch
  return $obj;
} // end getReturnObj
```

As can be seen, there are several types of actions:
1. USERTEXT allows the user to add free-form comments
2. SUBMENU should not occur if the system is properly configured; this is only for error recovery
3. REFERENCE allows for adding content that points off-page to other references
4. TEXT allows for adding content in the form of HTML text
5. GRAPH interprets the content stored in the urn_data table is SQL, and executes this SQL on data in the General Information Database 140, and plots the result using a graphical display subsystem.

While the present embodiment of this invention is designed for static textual and graphical presentation, other embodiments may incorporate active data, dynamic graphs, and audio.

Other embodiments include a REDLINE function, which allows the user to record annotations on the left side 201 of user interface 200, but changing selected existing text to red with a strikethrough font, and placing a cursor for the user to insert new text, also in red for easy identification. One skilled in the art can easily add new types of annotations into the system.

For the chart 603 of FIG. 6 the first row returned from looking up the URN in urn_data has a content field which is the text of the following SQL query:

```
SELECT “bar” AS chart_type,
        grouping_object AS row_name,
        “percent” AS value_format,
        pct_no_balance_sheet_delivered AS
          ‘No Closing Balance Sheet Delivered’,
        pct_balance_sheet_delivered_no_adjustment AS
          ‘Balance Sheet Delivered w/ No Adjustment’,
        pct_balance_sheet_delivered_buyer_favorable AS
          ‘Adjustments in Favor of Buyer’,
        pct_balance_sheet_delivered_seller_favorable AS
          ‘Adjustments in Favor of Sellers’
FROM deal_data.cs_ppa_analysis;
```

The deal_data database, against which this query is run, is part of the General Information Database 140. This database is kept up to date with summary information that aggregates data from large numbers of merger agreements. If data from another merger deal is entered into this database, the summary statistics will be different, and the chart generated by this query next time will be different from the chart generated previously. In this way, an analyst, lawyer, or other operator of the system can compare the present document terms with aggregate data from other documents, with the information being constantly kept current with the state of the art.

For example, referring to FIG. 6, if a succession of transactions that occurred after the creation of FIG. 6 had adjustments only in favor of the Seller, a subsequently created version of FIG. 6 would show a graph with a larger percentage for “Adjustments in Favor of Sellers” and a proportionally smaller percentage for the other outcomes, such as “Adjustments in Favor of Buyers”.

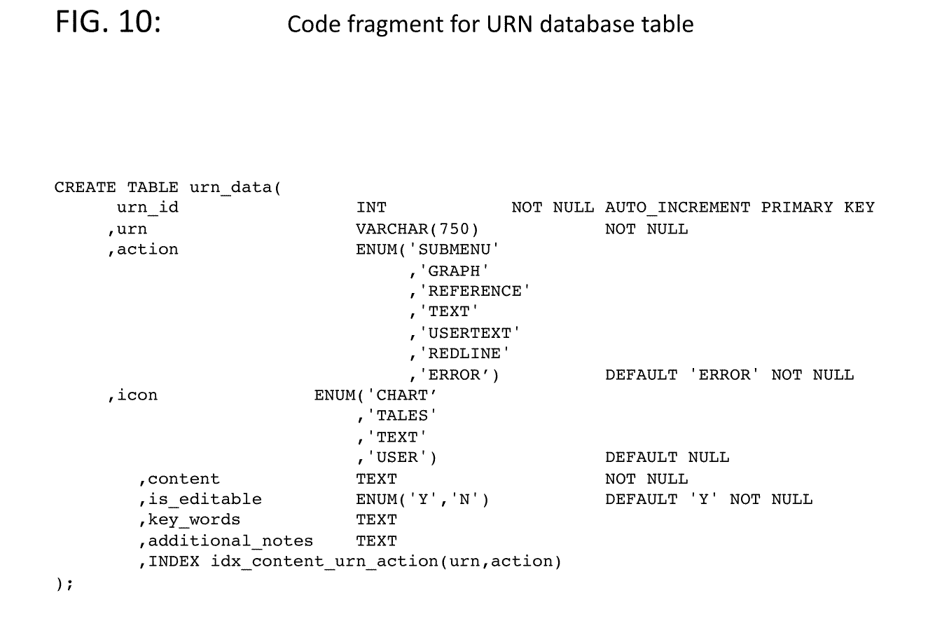

The urn_data table definition is found in FIG. 10. Portions of a deal_data database structure, designed as series of SQL tables and views, are shown in the attached Appendix, Part 1.

Since the historical data can be partitioned in any sensible way, for example, by year or by month, trends in data can become obvious quickly, and documents annotated using the present invention can provide valuable feedback to creators of new documents, helping them refine the terms of the contract to be conformant to best practices.

The second row returned from looking up the URN has a content value which is equal to the text found in content item 604. Through appropriate indexing schemes, all the content can be ordered in the way which makes most sense; in the case of FIG. 6, for the chart 603 to appear first, followed by the text block 604.

Similarly, if the interpretation of chart 603 changes, an analyst can update content text 604 to reflect the new reality.

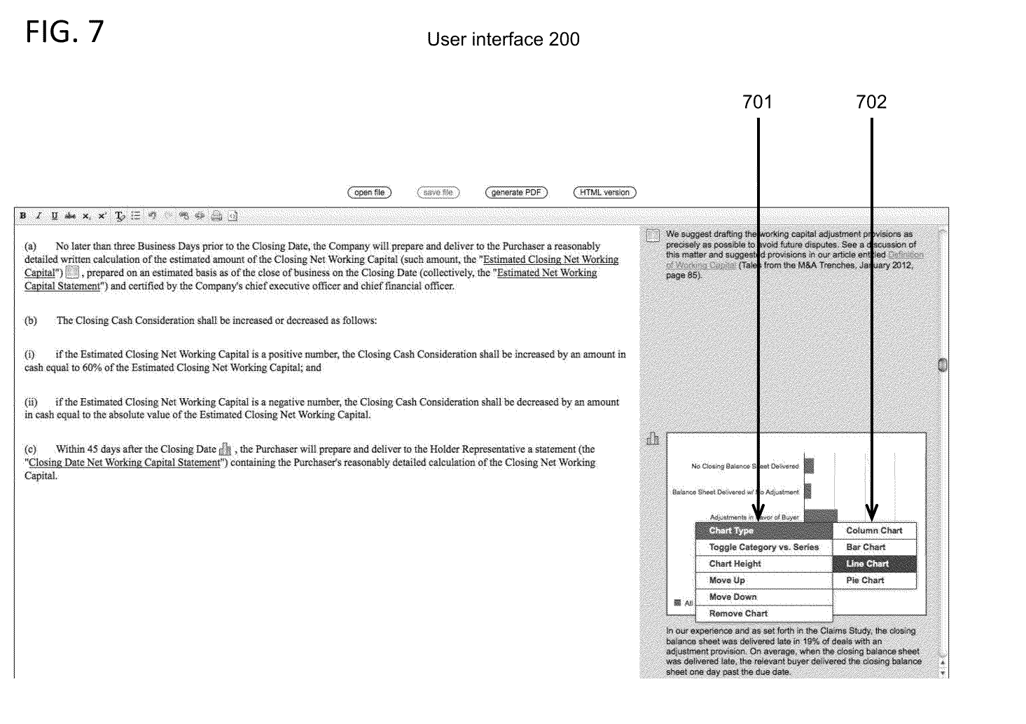

The user may also click on an annotation, bringing up a menu of actions appropriate for that context. FIG. 7 shows how right clicking over a chart brings up a menu specific to charts. Top-level menu 701 provides a list of actions appropriate to this chart, such as changing the type, the way the raw data is presented, altering the height, moving, or deleting the chart. In FIG. 7, “Chart Type” is highlighted in top-level menu 701; this exposes submenu 702, which shows a list of supported chart types.

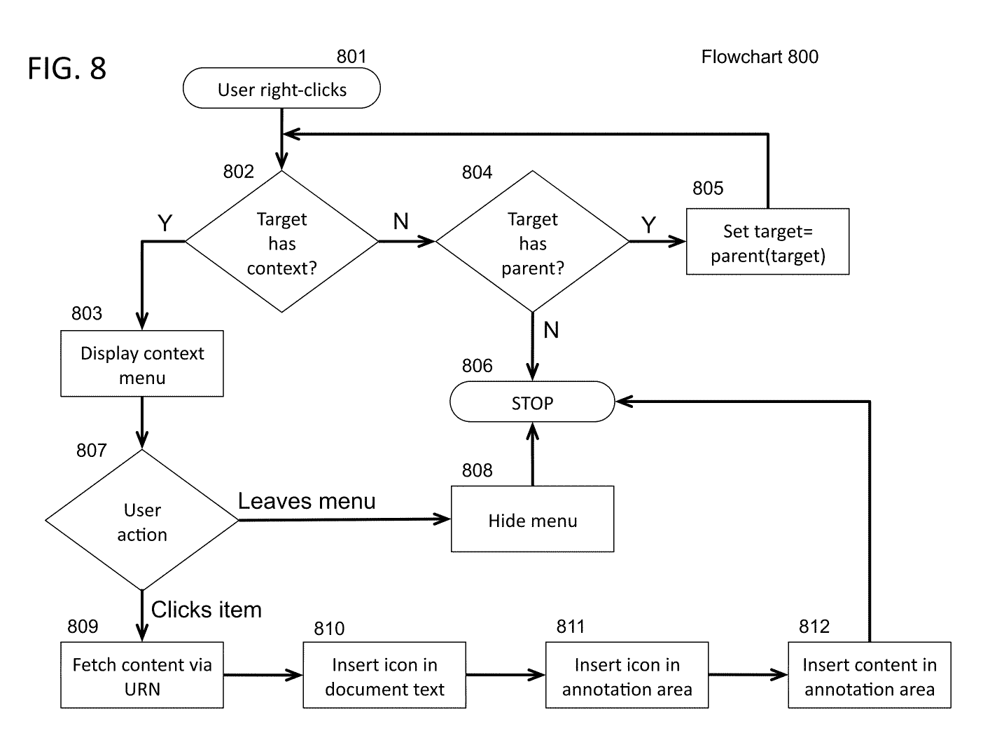

Determining the proper context-sensitive menu to bring up in User Interface 111 follows the logic of the flowchart 800 shown in FIG. 8. A decision whether to bring up a menu, and if so, which one, is triggered when the user right-clicks within the system. When the user clicks on a document area, the underlying web browser provides a “target” element as part of the information returned concerning the mouse click.

One preferred embodiment of the present invention has in its source code an ordered list of <className, contextMenu> tuples (See Appendix Part 2 for the menu code; the tuples are stored in variable classToContext). This list is ordered from most specific item to least specific. For example, the entry for charts is before the entry for general annotations.

In state 802 of flowchart 800, a test is done to see if the className of the target matches one of the context tuples. This is shortened to “Target has context?” in decision state 802's label. If so, the system proceeds to state 803, wherein the appropriate context menu is displayed. If the target does not have any context, it is possible that a parent of the target has an actionable context. Decision state 804 checks to see if the target has a parent. If not, either the system has reached the root document node, or there is some unknown error. In either case, execution terminates at state 806. If there is a parent node, then in state 805, target is replaced by its parent, and execution resumes at decision state 802. This loop is guaranteed to terminate, since each document item has a finite parentage.

In the case where a context menu was found, it is displayed in state 803. The remainder of flowchart 800 addresses the case where the context menu is the menu of annotation choices that appears over document area 201; however, all other cases are treated analogously, in that either the menu is hidden if no action is taken, or a sequence of actions takes place in response to a click.

Decision state 807 is where the user either successfully navigates the menu structure to an item that is clicked, or leaves the menu by moving the mouse off of it or clicking elsewhere. If the user leaves the menu, the menu is hidden is state 806, and the system returns to quiescence, waiting for another click.

If the user clicks on an item, the system goes into state 809. Here, the Client Device 110 sends the URN represented by the series of cascading menus back to Server Device 101, where the Application System 102 queries the Annotation Database 130 to determine what to return to the Client Device. Some content will be static, but in other cases, such as statistics or chart information, the content will be a SQL query to be run against General Information Database 140. Because General Information Database may be updated at any time, the SQL query will reflect up to date information in the data it returns.

An optional function in some embodiments allows the user to hide (or unhide) selected portions of the documents, so as to make the overall document smaller, easier to read, and focused on the specific annotations made by the user.

The source code for processing data on Server Device 101 and transmitting to Client Device 110 is provided in Appendix Part 3; one data type, Graph, is shown in source code in Appendix Part 4.

The Server Device 101 returns the static data or a data structure representing the results of the SQL query. One preferred embodiment of the present invention uses JSON as the representation for the response data, but XML or a custom-designed representation would work equally well.

In state 810, the Client Device 110 (via User Interface software 111) receives the response, and in states 810, 811, and 812, it inserts the appropriate icons and contents into the inline document area 201 and the annotation area 210. The exact location to insert the inline icon is determined by the target node as originally passed from state 801 to 802.

The functionality of FIG. 8 is implemented in the source code of Appendix Part 2. As one skilled in the art would expect, the consistency of a set of URNs is key to creating the context sensitive menus. One must make sure that every item can be reached via menu traversal and that no menu traversal terminates in a menu item for which there is no action and content. This can be achieved by performing a number of consistency checks on the data.

If the URN:

srs:||Financial Provisions|PPA|Included|

[symbol]
Delivery of Adjusted Balance Sheet|Chart

is in the database, then the following parents must be in the database as well:

srs:||Financial Provisions|PPA|Included [symbol]
Delivery of Adjusted Balance Sheet
srs:||Financial Provisions|PPA|Included
srs:||Financial Provisions|PPA
srs:||Financial Provisions
srs:||

The action type for the above five menu items (and corresponding URNs) is “SUBMENU,” meaning that there is no action associated with the menu item, but rather that further specialization is expected.

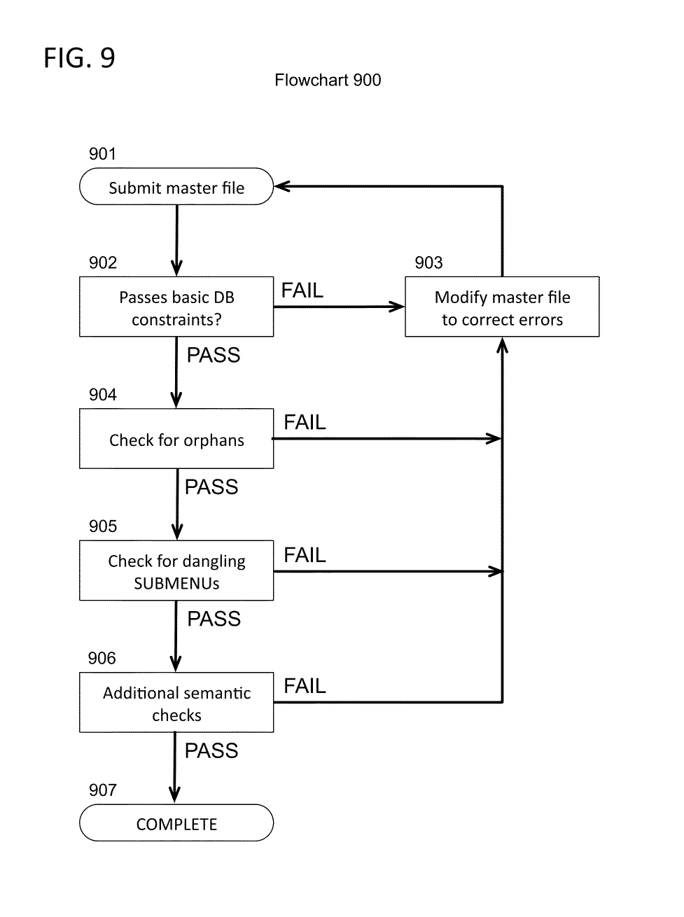

FIG. 9 shows flowchart 900 for taking a master file of content (mappings of URNs to text, HTTP references, SQL queries, etc.), and ensuring there are no orphans (URNs in the database that don't have a complete parentage as describe above), and no dangling submenus (no URNs of action type SUBMENU where there are no child nodes to display if the user selects that URN).

In state 901, a master file of content is submitted for verification. First, it is imported into the database. The database table definition (shown in FIG. 10) will impose certain basic constraints, such as ensuring an ENUM value is one of the allowed values, and that the URN is not null.

In state 902 of FIG. 9, these basic DB constraints are checked. If these constraints are not satisfied, control proceeds to state 903. This is a manual state in which inputs to the master file are corrected, based on error messages provided, and the file is re-submitted in state 901 again.

If SQL created in the database is state 902 is valid, the system continues checks in state 904, which checks for orphan nodes. Passing these checks leads to the check for dangling SUBMENUs in state 905. In general, any number of additional semantic checks can be done in state 906, depending on what is appropriate for the specific embodiment.

Source code (SQL stored procedures) for findOrphans( ) and findDanglingSubmenus( ) are found in Appendix Part 5 and Part 6, respectively.

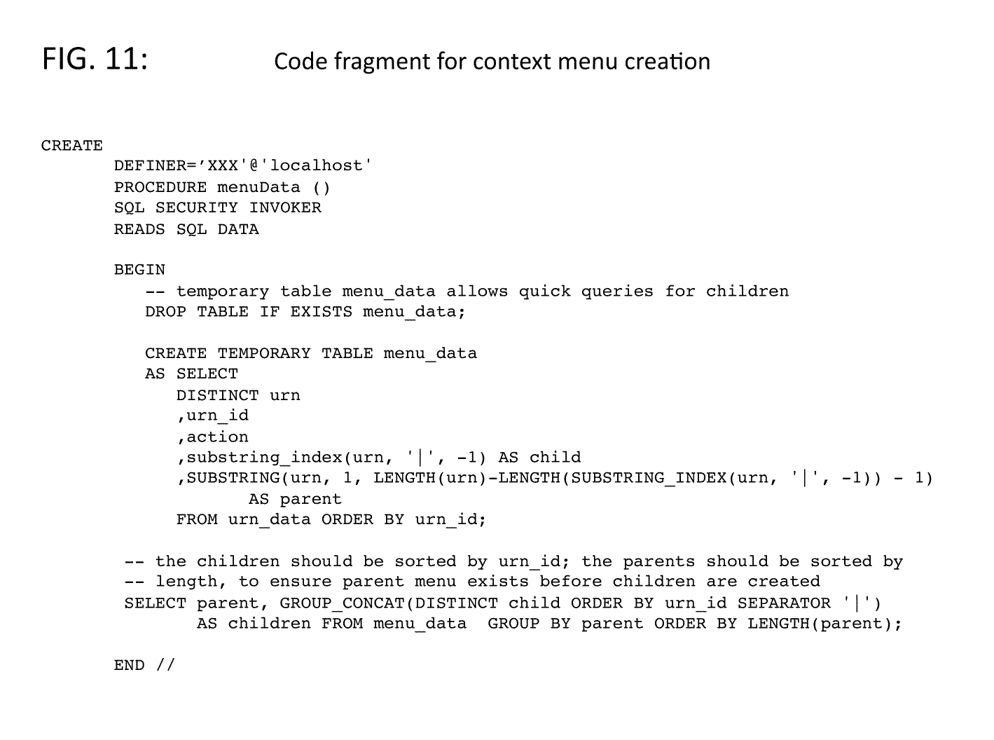

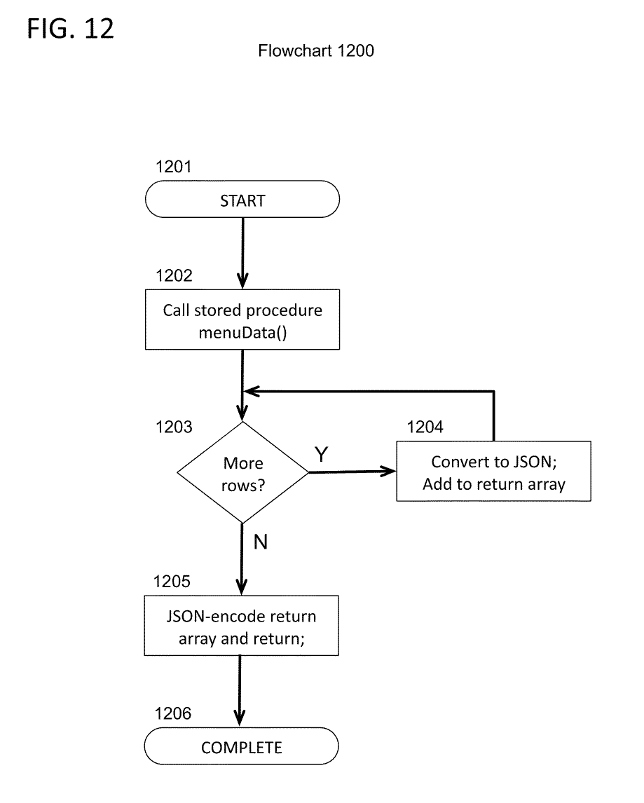

FIG. 11 illustrates a code fragment that implements SQL instructions to find the complete list of parents and children. Using the menuData( ) function thus defined, FIG. 12 depicts flowchart 1200 for converting the SQL data to JSON objects, which are returned from Server Device 101 to Client Device 110. In FIG. 12, the loop of states 1203 and 1204 converts a string-concatenated list of children into a JSON-encoded array, and adds a parent property to the resulting object. The resulting array of objects is converted to JSON in state 1205, and returned to the Client Device. The code of Appendix Part 2 decodes this data and constructs the cascading menus and associated leaf-node actions dynamically. Code that implements flowchart 1200 is found in Appendix Part 7.

Whenever a new concept is added to the URN structure, the systems and methods described above ensure that the Client Device 110 receives a new menu structure that properly reflects the new concept hierarchy reflected by the addition of the new URN.

Since the present invention is intended to annotate structured documents such as legal agreements, contracts, instruction guides, etc., it is essential to keep the formatting of a document imported into this system. Those skilled in the art are aware that many converters from proprietary formats to open formats such as HTML do not necessarily preserve section numbers or other relevant references.

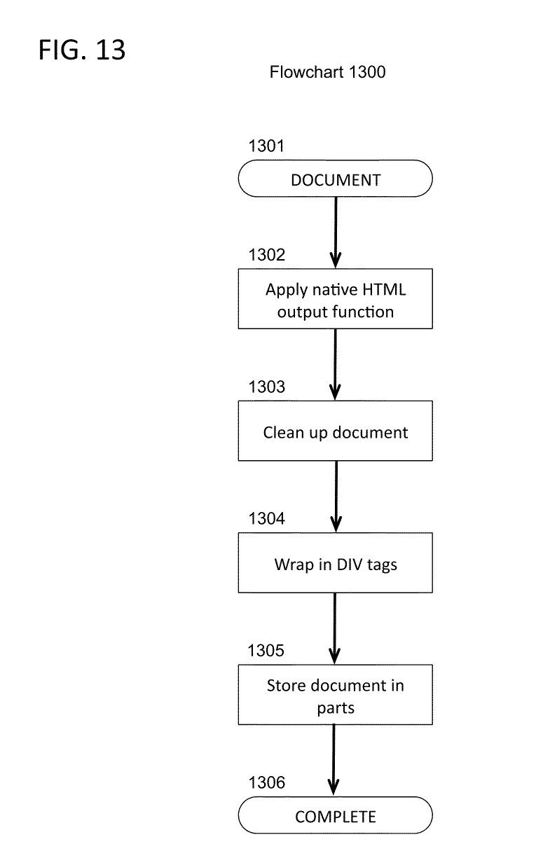

Thus, in a preferred embodiment, format conversion is handled using the built-in converters of proprietary software. Appendix Part 8 contains AppleScript code allowing the conversion of a Microsoft Word document and upload the converted document to Server Device 101. FIG. 13 illustrates a flowchart illustrating how that uploaded document is processed.

In state 1301, the document exists in its native format (in the present example, Microsoft Word .doc or .docx format). State 1302 applies the native conversion routines to HTML, as detailed in Appendix Part 8.

The converted document is not truly HTML compliant, as Microsoft has a number of proprietary extensions written into their HTML, such as conditional comments, and additional format tags, to allow conversion back to the proprietary native document format. In state 1303, a set of cleanup routines removes the proprietary code, resulting in clean HTML format. Next, in state 1304, the document is “wrapped” in additional DIV tags that allow the present invention to add annotations and format the output in a sensible way. While this will be apparent to a skilled practitioner, sample code is presented in a shell script in Appendix Part 9.

Finally, in state 1305, the document is saved, but in multiple parts (DOCTYPE declaration, HTML declaration, HEAD, CSS, and BODY). In this way, the document may be re-assembled with CSS and JavaScript injected in the proper places to allow the document, which resides in an IFRAME, to interact with the surrounding tool.

What has been described above constitutes one embodiment of the present invention, which provides useful and novel functionality to those wishing to annotate a corpus of documents. Other embodiments to be described shortly may be preferred in certain circumstances, where learning capability is desired.

While merger agreements have been discussed fully above, it will be apparent to one skilled in the art that the same techniques apply to other documents in which there is a reasonable amount of structure, but where parameters vary. For example, in a licensing agreement, the structure can cover a number of common terms, including, but not limited to:

1. Limitations on use of licensed material

2. Exclusivity

3. Term of agreement

4. Warranties

5. Limitations of liability

6. Indemnification

7. Assignability

Analogously to the description of merger agreements above, a database of existing agreement terms, actual license histories, etc. can be created. This can be used to then annotate newer license agreements with information from the database.

Financing agreements, medical record interpretation, and other semi-structured documents are also contemplated in the present invention, and are handled in the same manner.

The present invention differs from other annotation systems in that the references in the annotation area 210 are generated from a dynamic database of information about documents, which can be updated periodically, or even in real time.

The present invention also differs from other annotation systems in that the placement of the icon in the original text gives clues to the system as to how to interpret this and future documents. Unlike the collaboration methods which use static overlays, this method allows inspection of the original document, to see what the immediately surrounding context of the inline icon is. This is important in preferred embodiments of the present invention, in which document structure and language cues help guide the annotation of the document.

The present invention differs from content management systems in that there is an additional step of data synthesis (combining elements with another document), rather than content simply being stored and then creatively arranged.

II. Embodiments with Machine Learning

As mentioned previously, the documents analyzed by the present invention are semantically structured, but that structure may not be evidenced in the document tagging in, for example, an HTML document.

It is unreasonable to expect that non-computer professionals, such as lawyers and doctors, would learn how to classify their documents using, for example, XML schema. Thus, salient features cannot be extracted by analyzing the tags alone. Some documents may use the paragraph tag <P> for everything, changing font sizes and weights to create section headings; other documents might misuse <H2> or <H3> level tags, turning them into full paragraphs, and altering their fonts so they are indistinguishable from <P> tags. Thus, extraction of relevant information must use other means, such as rule-based or statistical learning.

FIG. 1B depicts a version of the system described in FIG. 1A, augmented for machine learning via the inclusion of Annotation Ranking Engine 160, Annotation Placement Engine 161 (also referred to herein as a “Disambiguation Engine”), and Learning Engine 162 inside of Application System 102. All of the reference engines make use of data in the General Information Database 140, and all of the engines may read from and update the Annotation Database 130. Furthermore, the outputs of the various engines are used to augment Sources of Data 150, in a continuous learning feedback loop.

Extraction of section headings in a document is achieved via regular expression searches, since section numbers appear as the first visible markings in a given piece of text. Additionally, the level of heading is deduced from a combination of document markup and the formatting of the sections, e.g., section 1 (a) (ii) is part of section 1 (a), which in turn is part of section 1. Such extractions are readily apparent to one skilled in the art.

Text fragments beginning with section numbers and containing small amounts of text (less than N characters; a value of 100 for N is used in one embodiment of the present invention) are labeled as “headings”; other text fragments are labeled as “paragraphs.” Additionally, the text of the entire document is labeled the “document,” each text fragment between certain punctuation characters (“.”, “;”) is labeled as a “sentence,” and each fragment between parentheses is labeled as a “parenthetical.” In preferred embodiments, these different types of text fragments are associated with particular concepts, as further described.

The machine learning embodiments of the present invention deal with determining which combinations of words in the document correspond to the concepts described by the URNs of the present invention, with the understanding that not all concepts are present in all documents. As an example in the domain of mergers and acquisitions, there are easy to classify sections of the document, such as the definitions, wherein the section is titled something like “Definitions” and each line consists of a quoted name (in some documents underlined or in bold typeface), followed by a word such as “means” or a phrase such as “is defined as.” For example:

### “Per Share Representative Fund Amount” Means

Concepts such as “Working Capital Adjustment” or “Delivery of Adjusted Balance Sheet” are more difficult because there are many more variations in the terms of art used by practitioners. For example:

### “Working Capital Adjustment”

### “Adjustments to Working Capital”

### “Closing Working Capital Amount”

### “Net Working Capital Adjustment”

### “Net Cash”

### “Net Current Assets”

Note that in some instances the phrase “Working Capital” does not even appear, although it is the same abstract concept. To complicate the task further, the concept of a working capital adjustment is only present in a portion of merger deals, so it may or may not be present in any particular document that is analyzed, even though the sub-phrases “Working Capital” and “Current Assets” may appear multiple times in other contexts in documents that don't mention working capital adjustments.

Disambiguating the phrase from other similar combinations of the same words may involve analyzing other words and phrases in the enclosing paragraph, where the other words and phrases may not appear in the actual name of the content.

Owing to the unique feature of the present invention, wherein the user places an icon inline in the document area 201, which is linked to an annotation icon and specific annotations in annotation area 210, there is more information available to use in computing whether a given sentence or paragraph is referencing a concept described by one of the URNs.

Concepts that map to URNs are described using a series of single words plus N-grams, which are compound terms of N words each. In order to get a reasonable estimate of real-world word frequency, a relatively large corpus of documents is analyzed.

State of the art machine learning techniques such as N-gram-based text categorization are quite accurate for tasks such as language determination, but have about an 80% success rate generally in classification of documents. See, William B. Cavnar and John M. Trenkle (1994) “N-Gram-Based Text Categorization” Proceedings of SDAIR-94, 3rd Annual Symposium on Document Analysis and Information Retrieval (Cavnar & Trenkle). Thus, while the N-grams frequencies themselves are easy to calculate from a corpus of documents, their predictive power is not optimal.

But the N-grams themselves generate a more accurate Zipf's Law behavior than single words alone. See, Le Quan Ha, E. I. Sicilia-Garcia, Ji Ming, F. J. Smith (2002) “Extension of Zipf's Law to Words and Phrases” Proceeding COLING '02 Proceedings of the 19th international conference on Computational linguistics—Volume 1. Zipf's Law states that the frequency of word tokens in a large corpus of natural language is inversely proportional to the rank. A refinement to Zipf's Law was made by Mandelbrot. Either such distribution will be called “Zipfian” in nature, and it will be understood by those skilled in the art that either Zipf's formulation or Mandelbrot's formulation may be used, depending on accuracy vs. computational effort.

Legal documents in particular have been shown to follow Zipfian behavior quite closely. See, Smith, F. J. & Devine, K. (1985) “Storing and Retrieving Word Phrases” Information Processing & Management, Vol. 21, No. 3, pp 215-224. With Zipfian behavior, the probability of occurrence of a given N-gram is easily determined from the N-gram's frequency rank via Zipf's or Mandelbrot's formula. For Zipf:

$$P ( r ) = \frac{k}{{r}^{a}} \qquad ( Zipf )$$

where k is a constant, r is the rank of the rth N-gram by frequency, and a is an empirically derived constant, close to 1.0 in value. Mandelbrot's formula is a refinement:

$$P ( r ) = \frac{k}{{( r + v )}^{a}} \qquad ( Mandelbrot )$$

where the additional parameter v is another constant, also empirically derived.

Thus, with a standard analysis of a corpus of documents, one preferred embodiment of the present invention determines the frequency rank, and hence the independent probabilities for each N-gram's occurrence in the corpus of documents.

Since the set of annotated documents grows over time, and because it is preferable for the information obtained from annotating one document to influence all future document annotations, a preferred embodiment allows for incremental learning. One such preferred embodiment using Bayesian classification is described here, because of the ease of incremental updating, but one skilled in the art could substitute any number of supervised or unsupervised learning algorithms in its place.

Let Wᵢ denote an N-gram (a word or a word phrase) found in the document corpus, where N-grams are computed at the word level, and Cⱼ denote a concept defined by a particular URN with urn_id=j in table urn_data of FIG. 10. Then Bayes' Theorem applied to the present invention states that the a posteriori probability of a text fragment denoting concept Cⱼ given the occurrence of N-gram Wᵢ is the conditional probability of finding Wᵢ given the concept Cⱼ, multiplied by the a priori probability that the text fragment contains concept Cⱼ, divided by the unconditional probability of finding W, in the corpus. Mathematically, this is expressed by Bayes' Theorem as:

$$P ( {C}_{j} \vert {W}_{i } ) = \frac{P ( {W}_{i} \vert {C}_{j} ) P ( {C}_{j} )}{P ( {W}_{i} )} \qquad ( 1 )$$

P(Cⱼ) is the a priori probability that the text fragment describes concept Cⱼ.
P(Wᵢ|Cⱼ) is the a priori probability that N-gram Wᵢ is associated with concept Cⱼ.
P(Wᵢ) is the probability of finding N-gram Wᵢ in the corpus of documents.
P(Cⱼ|Wᵢ) is the a posteriori probability that the text fragment describes concept Cⱼ.

Unlike the general problem of machine learning applied to document understanding, in the present invention Bayes' Theorem is applied to a text fragment, defined herein as a sentence, a parenthetical expression, a paragraph or a heading, or any other sort of text delimited by punctuation, grammatical construct, or formatting markup.

The values of P(Wᵢ) for all N-grams are computed in advance (using either Zipf's or Mandelbrot's formula), and thus are treated as constants for calculations involving any one document. They do, however, get updated during the incremental learning process, as shown below.

Because the present invention inserts an inline icon in the document text at exactly the point where the user identifies the concept, there is a special case where it is known absolutely that a given text fragment contains concept Cⱼ. In this case, the a priori probability P(Cⱼ) is 1. In this situation equation (1) above is simplified and used to compute values of P(Wᵢ|Cⱼ) as follows:

$$\begin{matrix}P ( {C}_{j} \vert {W}_{i } ) = \frac{P ( {W}_{i} \vert {C}_{j} ) \cdot 1}{P ( {W}_{i} )} \\ or & ( 2 ) \\ P ( {W}_{i} \vert {C}_{j} ) = P ( {C}_{j} \vert {W}_{i} ) P ( {W}_{i} ) & ( 3 )\end{matrix}$$

In equation (3), which applies to situations in which the concept Cⱼ has been confirmed by a user as occurring in a text fragment of the document, the value of P(Cⱼ|Wᵢ) is computed by examining the ratio of text fragments identified as containing Cⱼ divided by the total number of text fragments containing Wⱼ over the corpus of annotated documents. This fraction is labeled fⱼ in equation (4) below:

$$P ( {C}_{j} \vert {W}_{i} ) = \frac{\# text fragments having both {C}_{j} and {W}_{i}}{\# text fragments having {W}_{i}} = {f}_{j} \qquad ( 4 )$$

In alternative embodiments, these values are computed and indexed multiple times for different kinds of text fragments (e.g. sentences and paragraphs).

Equations (3) and (4) are used for updating P(Wᵢ|Cⱼ) values once a body of annotated documents has been created, but the learning system must be “bootstrapped” at the beginning to give initial values for these probabilities.

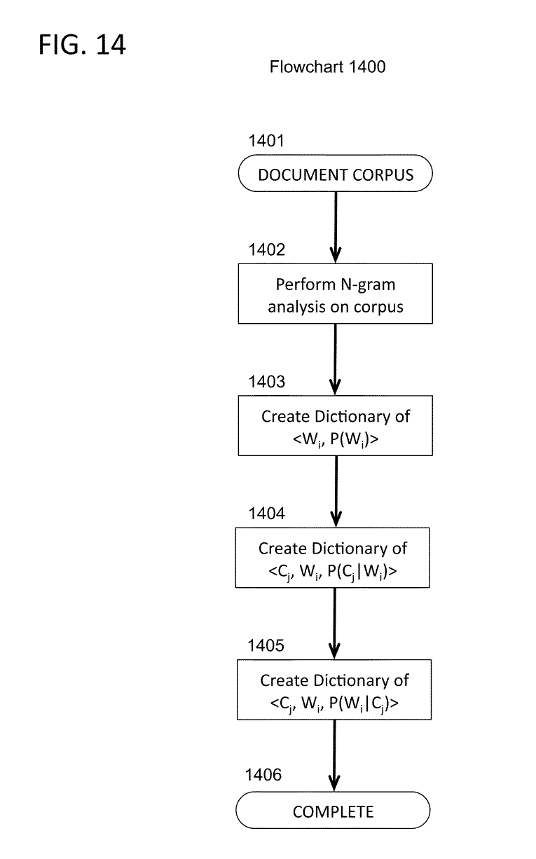

FIG. 14 illustrates the bootstrap process. Initially, all URN concepts are manually seeded with key words, which appear in a delimited list in table variable key_words in the urn_data table of FIG. 10. In state 1401 of flowchart 1400, a corpus of documents is entered. In state 1402, standard N-gram analysis (as taught by Cavnar & Trenkle) is performed. In state 1403, a dictionary is created which links the N-gram to its probability of occurrence; this is done using either equation (Zipf) or equation (Mandelbrot). In a preferred embodiment, these relationships are stored in a database table, optionally optimized with an in-memory cache depending on the number of N-grams.

In state 1404, the probabilities P(Cⱼ|Wᵢ) are calculated for each N-gram Wᵢ and URN concept Cⱼ. Since there are no prior conditional probabilities in the system at bootstrap time, the probability is distributed evenly across all concepts in which Wᵢ occurs. For example, if the N-gram W₅₂ appears in three key_words fields of the URNs in the urn_data table, for URN concepts C₂, C₁₅, and C₈₇, the following equation is used to approximate the conditional probabilities:

P(C₂|W₅₂)+P(C₁₅|W₅₂)+P(C₈₇|W₅₂)=1.0 (5)

Equation 5 states that the conditional probabilities for each concept sum to 1.0; while equation (5) does not take into account the probability of the N-gram occurring without any concept being described, this is an adequate starting approximation for the learning system. In the absence of application-specific knowledge, the conditional probabilities are spread evenly. For example, each of the three conditional probabilities for the concepts in equation 5 would be 0.3333; if there were 7 conditional probabilities, each would have a value of 0.143.

Note that there can be overlap in N-grams; both “Working Capital” and “Working Capital Adjustment” can be present as a 2-gram and 3-gram, respectively.

Again, in a preferred embodiment, the values calculated in state 1404 are stored in a database table, optionally optimized with an in-memory cache.

In state 1405, the values of probabilities P(Wᵢ|Cⱼ) are computed using the values from states 1403 and 1404 via equation (3). Again, in a preferred embodiment, the values calculated in state 1405 are stored in a database table, optionally optimized with an in-memory cache.

In state 1406, the initialization of the system for bootstrap mode is complete, and the system is ready for training. This embodiment of the present invention learns to improve all conditional probabilities each time a new annotated document is fed into the system.

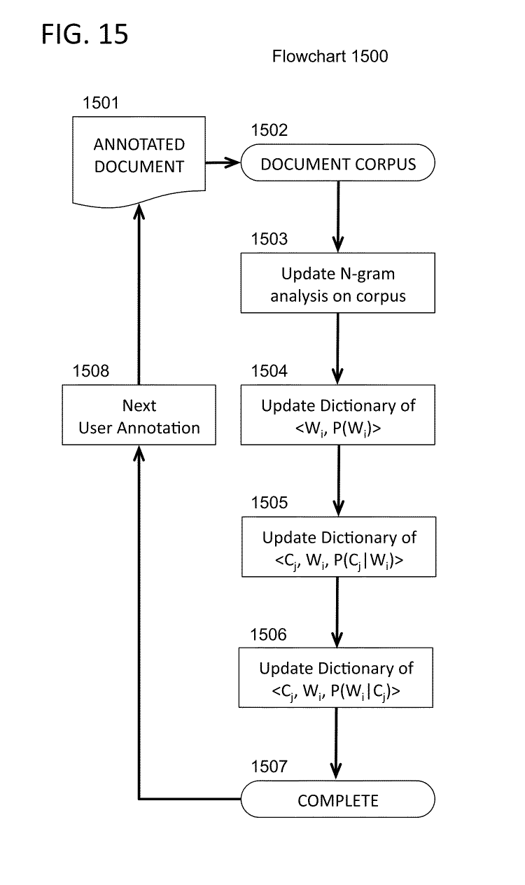

FIG. 15 depicts a flowchart in which an annotated document is input into one preferred embodiment of the present invention to update the conditional probabilities. It is similar to FIG. 14, with some calculations being done differently.

In state 1501 of flowchart 1500, a newly annotated document is entered into the system. In state 1502, this document is added to the document corpus. In state 1503, the N-gram analysis is performed on the updated corpus; this may be done anew, or incrementally to a previous analysis.

In state 1504, a dictionary of probabilities is created to replace the previous one, and is done analogously to the process used in state 1403 in FIG. 14.

In state 1505, the P(Cⱼ|Wᵢ) probabilities are updated, but according to equation (4). The resulting probabilities are not accurate until a minimum (N) documents are processed. The method of smoothly moving from the initial seed probabilities used in state 1404 of flowchart 1400 to the probabilities of state 1505 of flowchart 1500 is addressed below.

In state 1506, the P(Wᵢ|Cⱼ) probabilities are computed from the data of states 1504 and 1505 using equation (3).

In state 1507, processing of this document is complete. There is a feedback loop wherein as the user annotates another document with markup in state 1508, the new document is input into the system in 1501 again, constituting a continuous learning loop. This is referred to as the learning engine 162, shown in FIG. 1B.

In the initial stages of learning, when there are not enough text fragments to analyze for the presence of C, and W, occurrences, the conditional probabilities can swing widely as each new annotated document is added to the corpus. This preferred embodiment of the present invention mitigates this effect by using an exponential averaging technique to incorporate new data. The method is as follows:
1. For the first N annotations, the initial conditional probabilities for P(Cⱼ|Wᵢ) and P(Wᵢ|Cⱼ) are used from the computations of FIG. 14.
2. After the first N annotations, an exponential average EA of period N is used to compute new probabilities, according to the formula:

EA[P(Cⱼ|Wᵢ)]ₙ₊₁=(P(Cⱼ|Wᵢ)ₙ₊₁−EA[P(Cⱼ|Wᵢ)]ₙ)·k+EA[P(Cⱼ|Wᵢ)]ₙ (6)

where k=2/(N+1)
Wherever P(Cⱼ|Wᵢ) is called for in a calculation, its corresponding exponential average EA[P(Cⱼ|Wᵢ)] is used.

N is dependent on the attributes of the corpus of documents, but for legal documents a value of N between 10 and 50 is sufficient. As the number of documents increases, the exponential average converges on the arithmetic average.

In this manner, the initial seeding probabilities transition smoothly to the results of the learning algorithms, and each new document does not perturb the probabilities unduly.

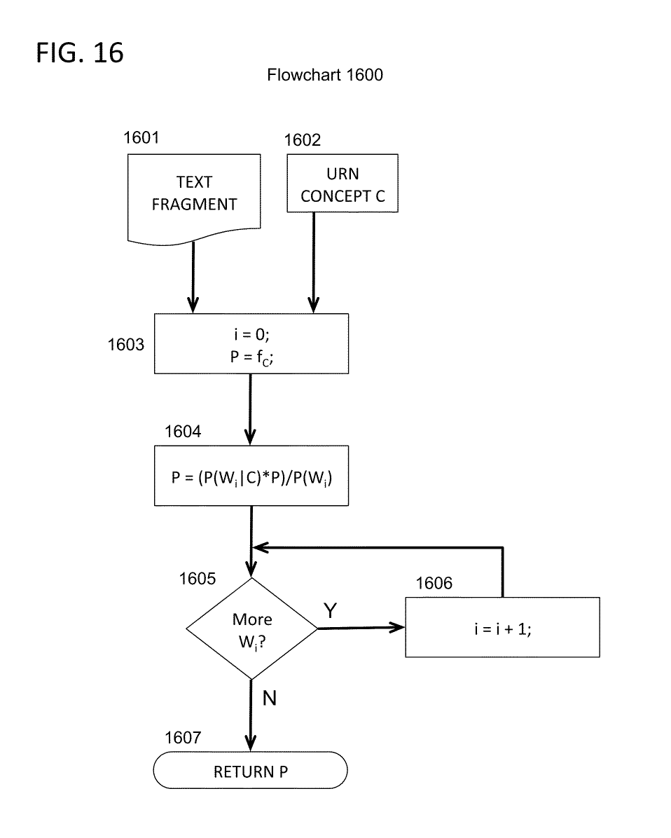

FIG. 16 illustrates how a text fragment is analyzed for a single concept C. The algorithm of flowchart 1600 is run repeatedly for each concept in the urn_data table of FIG. 10, yielding a vector of probabilities for each concept. The vector is used to rank order the concept applicability against the text fragment.

In state 1603 of flowchart 1600, a text fragment 1601 (parenthetical, sentence, paragraph, etc.), plus a specific concept C 1602 is submitted to the analysis algorithm. State 1603 initializes a counter i, as well as an initial estimate of the probability P of concept C being described by the text fragment. This probability is initialized to a value f_{c} that is empirically derived or simply set to the value 0.5 (effectively “ambivalence”).

In states 1605 and 1606, there is a loop in which Bayes' Theorem is applied repeatedly with each N-gram W, in the dictionary. Once the probability updates have been done for each Wᵢ, the process is complete in state 1607.

With the ranking of probabilities for each concept completed, an indication must be made to the user as to what the system recommends regarding annotations. For this task, two alternative embodiments are described: an aggressive embodiment and a conservative embodiment. The aggressive embodiment is described first.

In an aggressive embodiment, the following assumption is made: A document comprises several well-defined parts, and automatic labeling is done assuming that the highest probability sentences and paragraphs are the correct ones. An analogy is drawn with speech recognition for disambiguating entries in a telephone address book. The speech recognition algorithm doesn't have to solve the general natural language processing (NLP) problem. It just has to disambiguate amongst the values stored in the address book. This is a far simpler problem, which involves parsing with ambiguity, and then assigning the highest probability answer as the correct one.

In the aggressive embodiment, the system assumes the document contains a particular concept if the probability of the concept per flowchart 1600 exceeds some predetermined threshold. In the case where multiple text fragments exceed the threshold, the one with the highest probability is chosen.

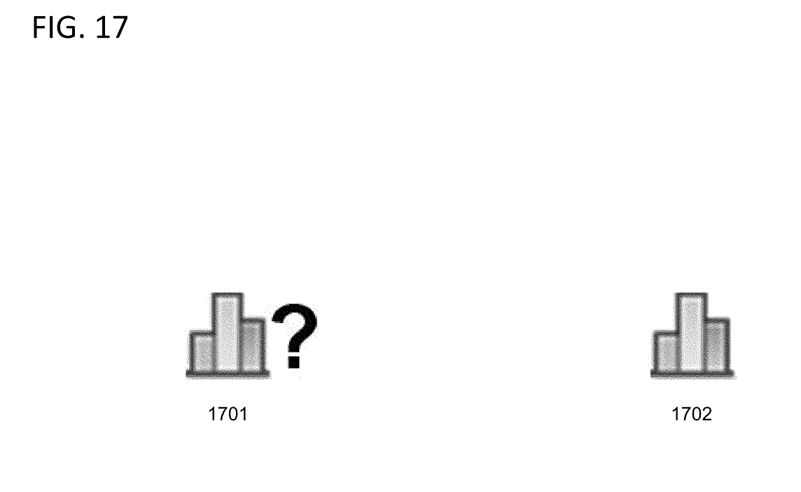

In the aggressive embodiment, it is desirable to mark the automatic annotations in such a way that a human operator (a user) has to approve of the annotation before the document is accepted as being fully annotated. FIG. 17 shows a visual means of achieving this. In this embodiment, if the annotation has been made automatically, but is not yet approved by the user, the icon takes a form similar to element 1701, which shows an icon followed by a question mark. Once the user has approved the annotation, the icon changes to the standard format shown in element 1702. The user also has the option of moving the tentative icon 1701 to a more suitable location, at which point it is accepted by the system.

The alternative embodiment to the aggressive embodiment is the conservative one. In the conservative embodiment, no automatic annotations are inserted. Instead, the cascading menus are dynamically rearranged so that the most likely menu item is at the top of the list.

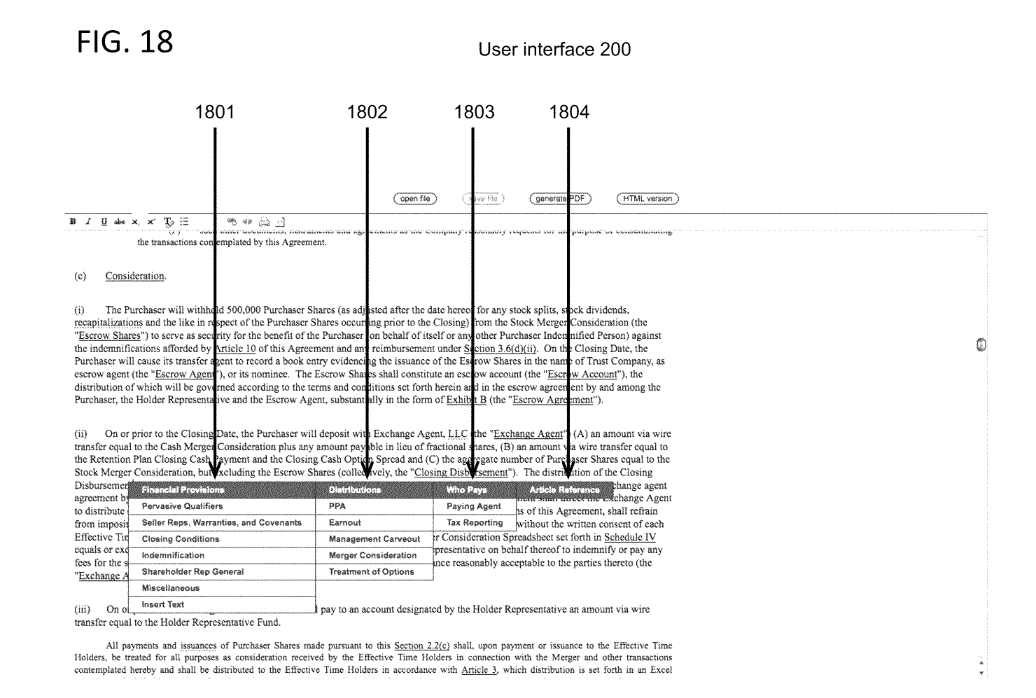

FIG. 18 shows a menu structure for the conservative embodiment. In this example, “Financial Provisions” was the most likely high-level concept, because the system had marked the paragraph as relevant to:

srs:||Financial Provisions|Distributions|Who Pays|

[symbol]
Article Reference

Thus, in top-level menu 1801, the top-most menu item is “Financial Provisions.” If the user accepts this and continues with the cascading menus, the second-level menu 1802 is organized by probability rank, so that “Distributions” is top of the list. This continues on through menu 1804, which is the leaf node, actionable menu item.

A user who disagrees with top level 1801, and who chooses “Pervasive Qualifiers” as the correct menu item for this paragraph, would see a dynamically re-arranged submenu 1802, ordered by the conditional probabilities computed for those items.

In this manner, the conservative embodiment does not put any annotations into the document, but if its computations agree with the user, the user will generally select the top menu item off of each level of the cascading menu, making the annotation job substantially easier. Further refinements in other embodiments may include, but are not limited to:
1. Altering the scope of the text fragment to include references to parent headings in the document.
2. Computing probabilities separately for different styles of icon insertion, including but not limited to cases where: the icon appears at the beginning of a paragraph; the icon appears at the end of a paragraph; the icon appears at the end of a sentence; the icon appears at the end of a parenthetical.
3. Incorporating a distance measure between the icon position and the location of the N-gram in the text fragment.

As an illustration of alternative embodiment #2 above, consider the following pseudo-code which switches based upon where users tend to place the icon:

```
switch (insertionStyle(icon)) {
      case PARAGRAPH_START:
          [code 1]
          break;
      case PARAGRAPH_END:
          [code 2]
          break;
      case SENTENCE_END:
          [code 3]
          break;
      case PARENTHETICAL END:
          [code 4]
          break;
}
```

Such an embodiment might be used to enforce particular annotation styles among a plurality of users of the present invention.

Initially, during training of the system, the insertion style of any particular icon will be unknown, so the distribution of probability of each insertion style is uniform. As a body of training examples is entered into the document corpus, the probability of, for example, the icon for concept C, occurring at the end of a sentence is the ratio of the number of times the inline icon for Cⱼ is placed at the end of a sentence to the number of times the inline icon for Cⱼ is placed in total. This probability is updated every time a new document is annotated and entered into the corpus.

Embodiments which use machine learning rely on two specific subsystems, an annotation ranking engine and an annotation placement engine; the latter is also called the disambiguation engine. The task of the annotation ranking engine is designed to rank-order each concept Cⱼ that appears in the document. This is important because nearly every concept will have some finite probability of the document referencing it. However, an annotated document has maximum utility when the most relevant concepts are referenced.

Once the most relevant annotations are determined, the disambiguation engine determines the most likely places to put the annotation, specifically, the location of the inline icon in document area 201 of FIG. 2.

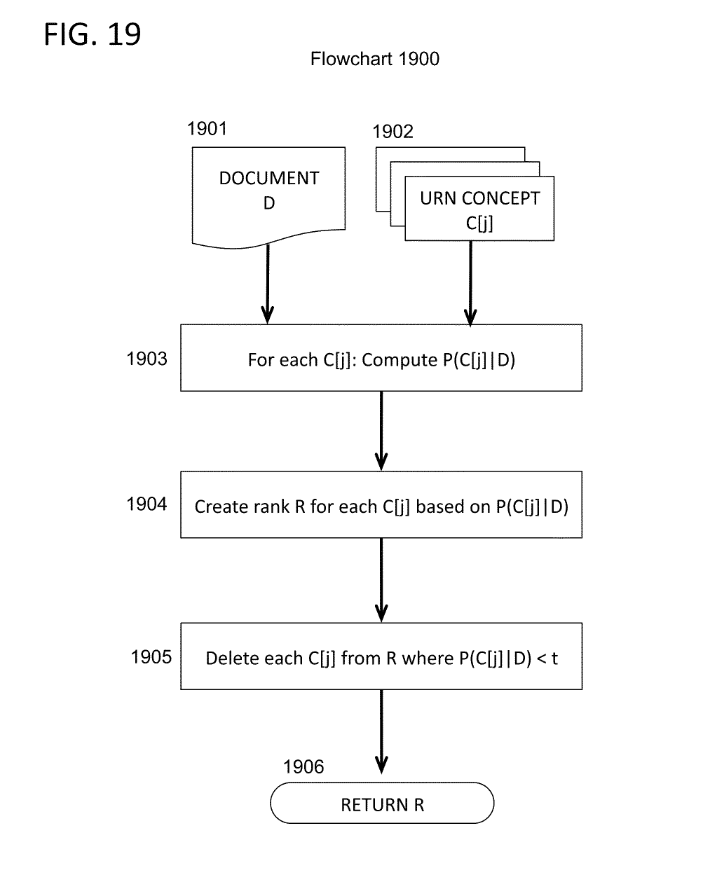

FIG. 19 illustrates the process used by the annotation ranking engine. Using computer array notation, concept Cⱼ is denoted as C[j]. The inputs to the annotation ranking engine are the document D 1901 and the set of URN concepts C[j], for j between 1 and N, the total number of concepts, shown in the flowchart as 1902. The set of all C[j] is also denoted as {C}. In state 1903, the annotation ranking engine computes the probability that the concept C[j] exists in the document D by applying the algorithm of FIG. 16 repeatedly for the entire document D as the text fragment, and each N-gram W[i] input. These conditional probabilities computed after repeated application of Bayes' Rule are denoted as P(C[j]|D). In state 1904, the annotation ranking engine rank orders all concepts C[j] by P(C[j]|D), in order from highest probability to last. In an optional, but recommended, state 1905, any probabilities that don't meet a minimum threshold t are eliminated from the rank R. In this manner, a relatively small number of concepts are deemed high enough rank to be of significant interest to an analyst.

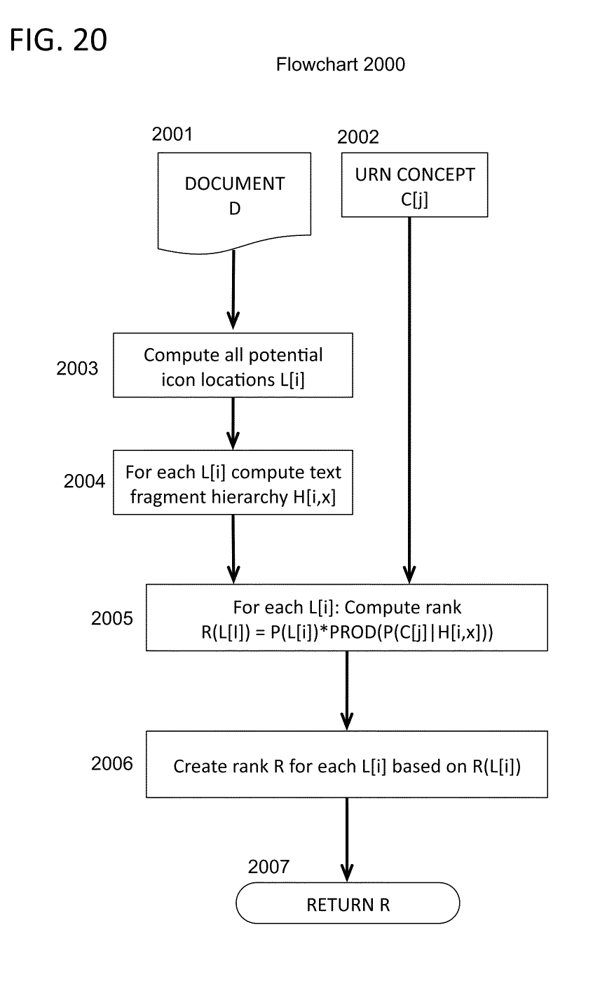

In this manner, the relevant concepts have been identified. The disambiguation engine is tasked with finding the most likely place to annotate the document, given a particular concept C[j]. FIG. 20 shows the flowchart for disambiguation. Document 2001 is first analyzed in step 2003 to find all potential locations to place the icon location (start of paragraph, end of sentence, etc.) Each location L[i] is a leaf node in a hierarchy of the document. L[i] may be placed at the end of a sentence, which may be part of a paragraph, which may be under a heading, an so forth. Thus, the probability P(L[I]) plus its entire hierarchy of text fragments H[i][x] must be examined, where H[i][x] represents the x levels of hierarchy (e.g., sentence, paragraph, heading 1, heading 2) until the document level. This hierarchy is computed in state 2004. The probability of the location L[i] being the best place for the annotation is performed by computing the product of the conditional probabilities up the entire chain, as shown in state 2005, the rank ordered in state 2006.

The computations used in the disambiguation engine make use of well-known search space optimization algorithms such as minimax or alpha-beta pruning to reduce the amount of effort required.

In the aggressive embodiment for machine learning, the top-ranked annotations are selected via the annotation ranking engine. For each such annotation, the top-ranked location for the inline icon, per the disambiguation engine, is chosen for the annotation location, and it is marked with the tentative icon 1701 as depicted in FIG. 17. Once a user has confirmed the placement, the icon is changed to the standard icon 1702.

The limiting case for the aggressive embodiment is where the annotations made by the system are automatically assumed correct, and the tentative icon 1701 is not used. Instead, just the standard icon 1702 is used. In this case, the system operates as a fully self-sufficient automated annotation system.

In the conservative embodiment for machine learning, the menu items in top-level menu 1801 of FIG. 18 are ordered such that the top-ranked concept for the location is at the top of the menu, and the lowest-ranked concept is at the bottom of the menu. This process is performed for each level 1802, 1803, and so forth, as the user selects a particular choice from the prior menu.

These and other refinements will be apparent to one skilled in the art, as will the fact that some small amount of experimentation with alternative embodiments may be needed depending on the subject matter of the document corpus, in order to achieve the best results.

Which preferred embodiment is employed depends on a number of factors, including but not limited to: the degree of uniformity of the corpus of documents; and, the amount of individual personal preference expressed among different users of the system regarding content identification and placement of annotations.

In documents such as contracts, once the contract is accepted, a workflow is established, whether implicit (someone keeping track of events in his/her head) or explicit (specific events being entered into a docketing system or Enterprise Resource Planning, or ERP, system). In the latter case, an employee or analyst may need to call up specific parts of a document to determine whether conditions have been met for certain actions. The annotations provided in the present invention have utility in such applications as docketing or ERP, the concepts identified may be associated with various docketing steps. Thus, once an annotation is entered, it may be used for a plurality of purposes.

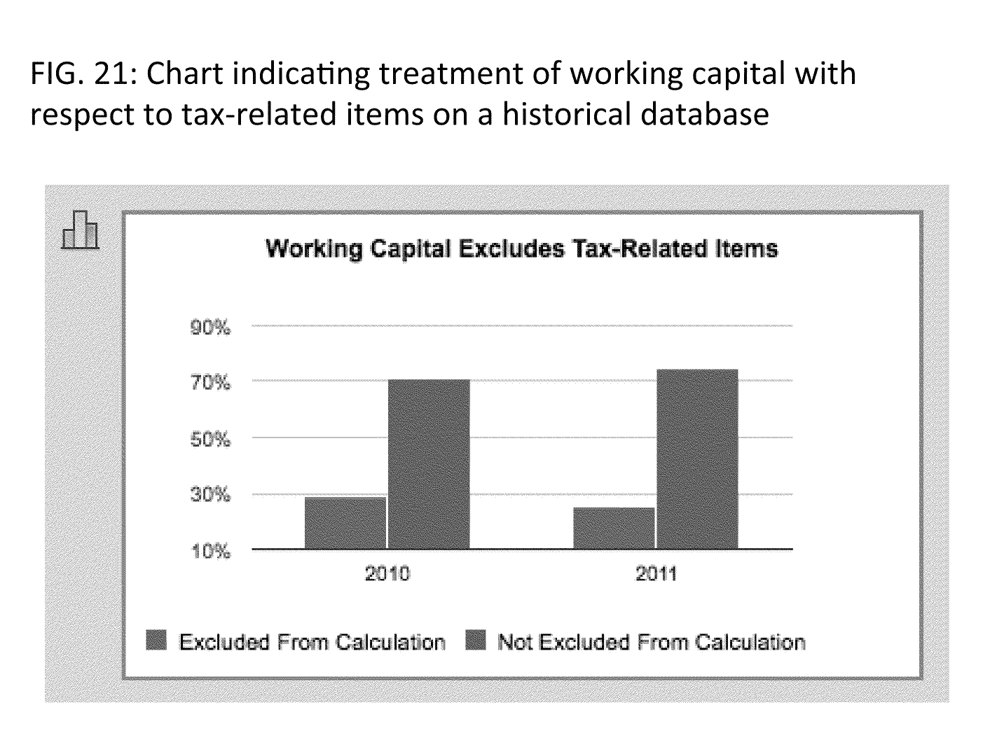

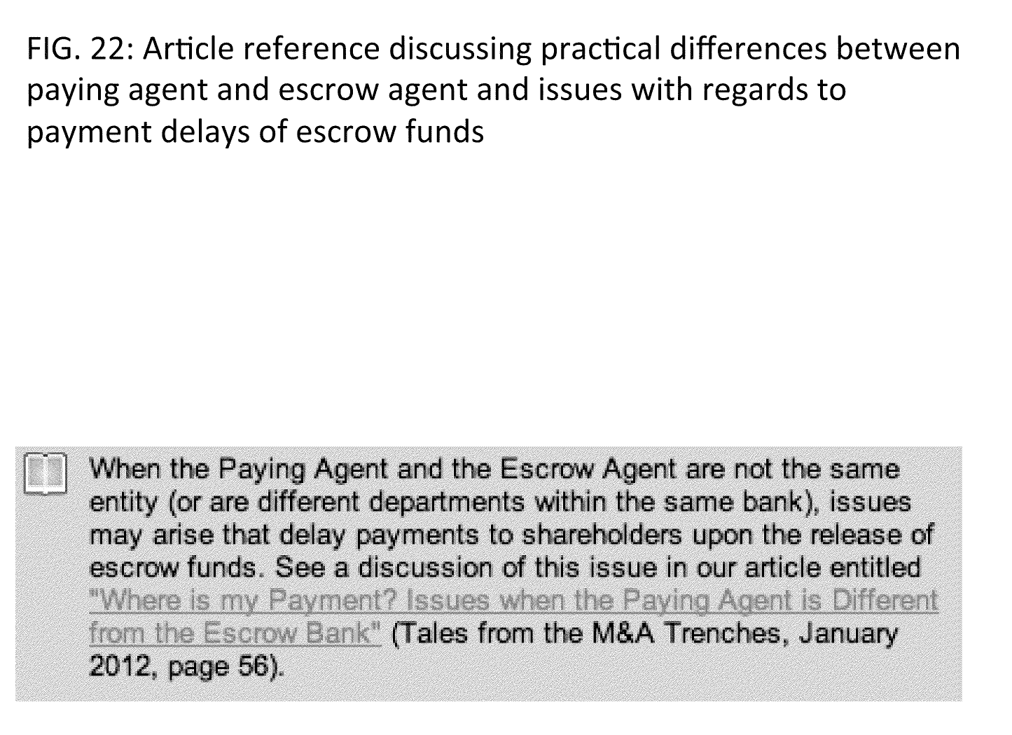

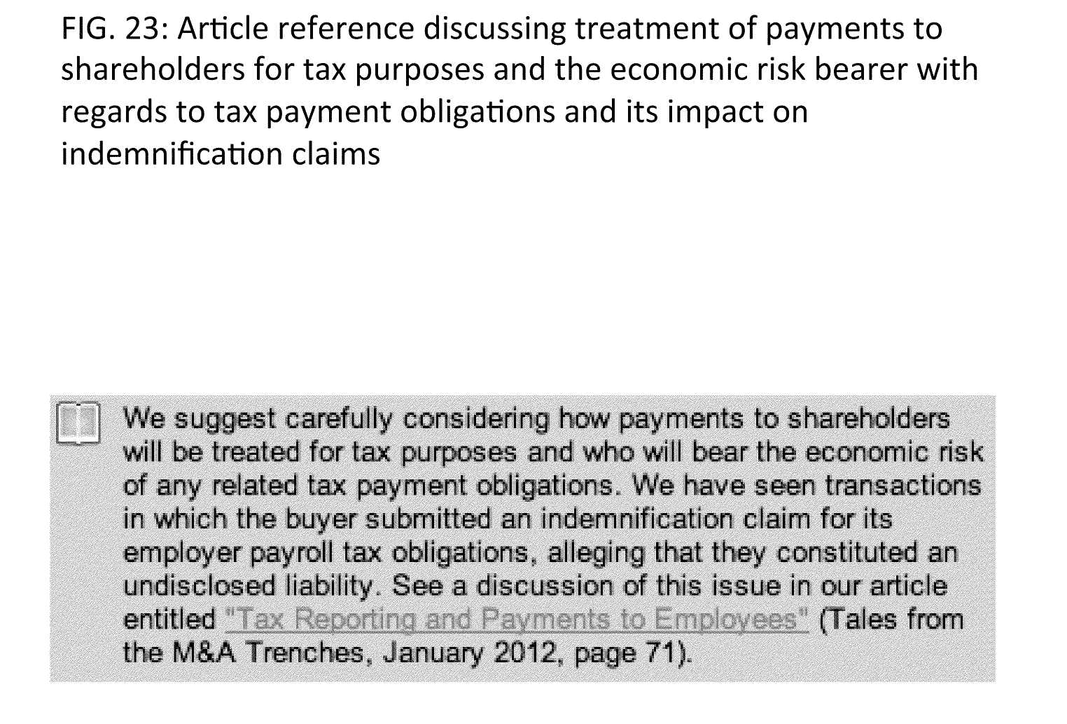

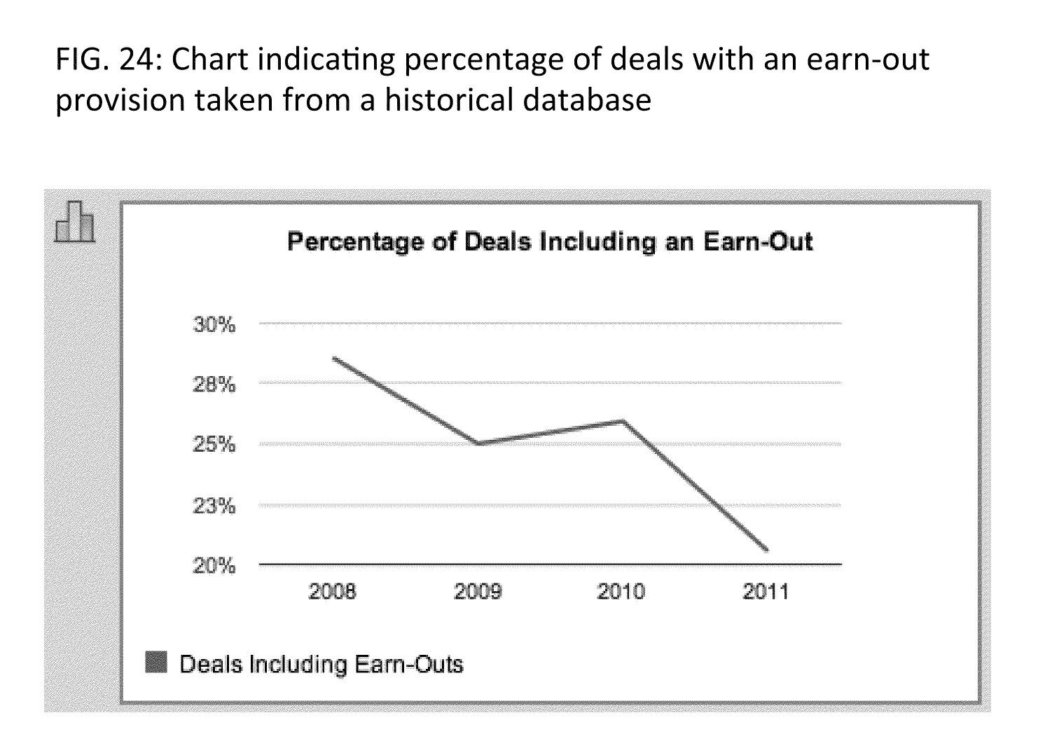

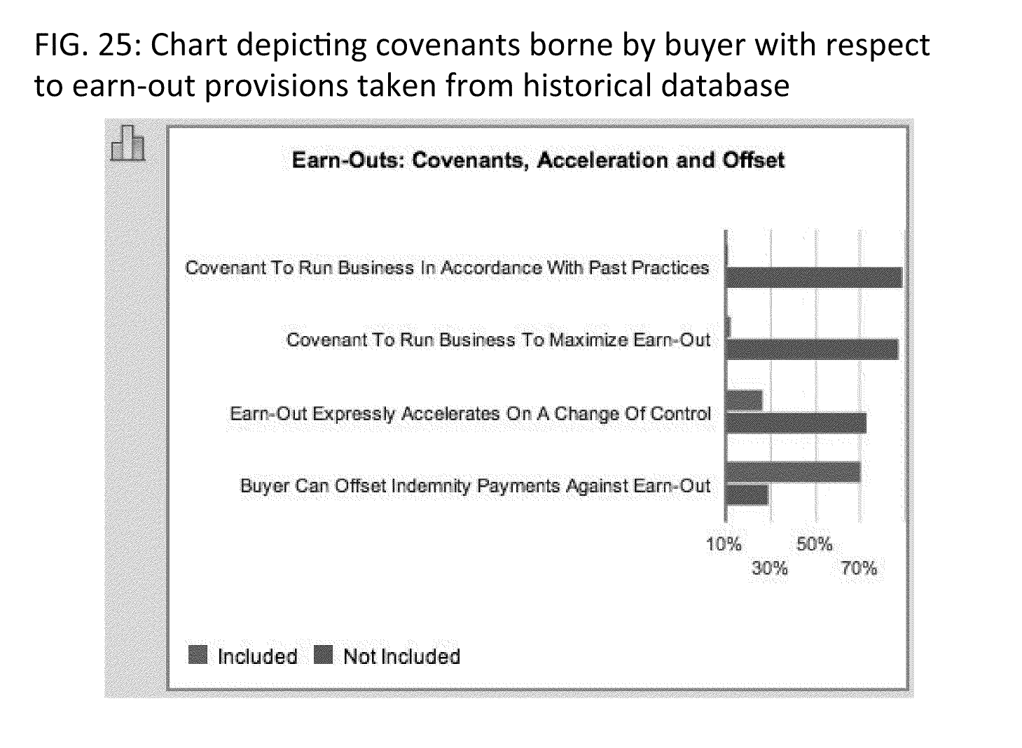

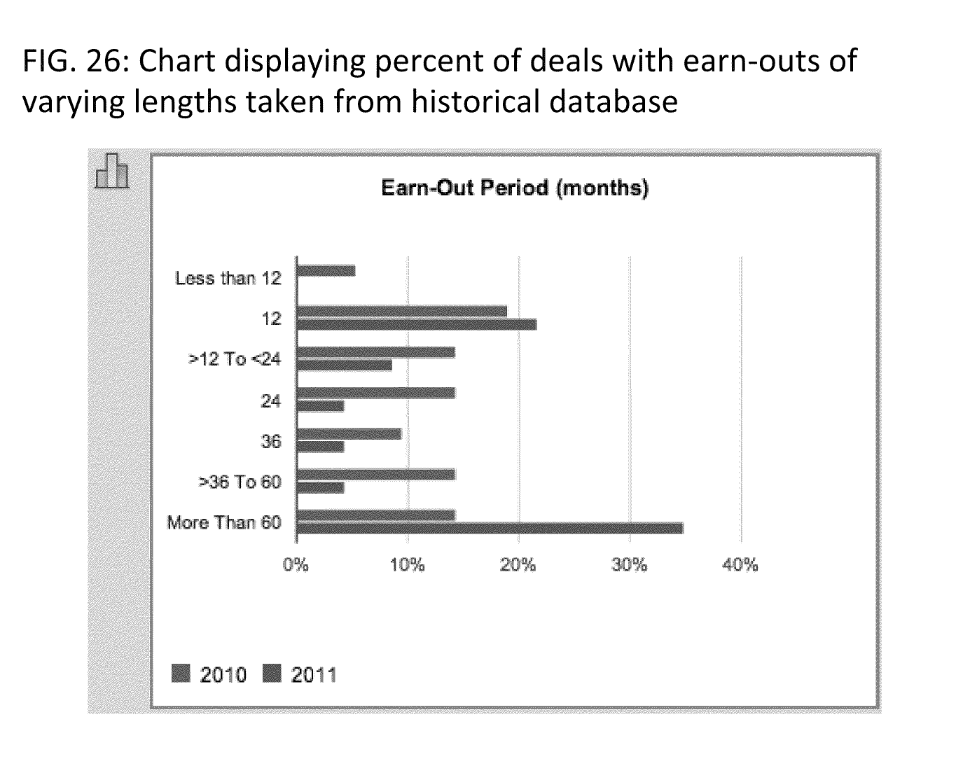

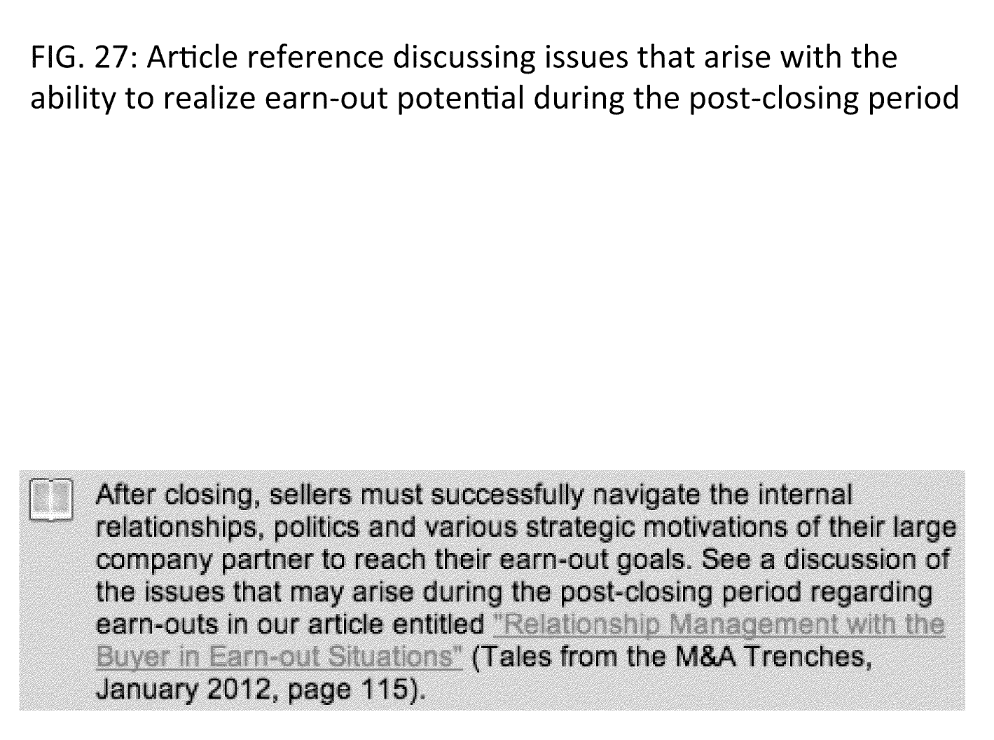

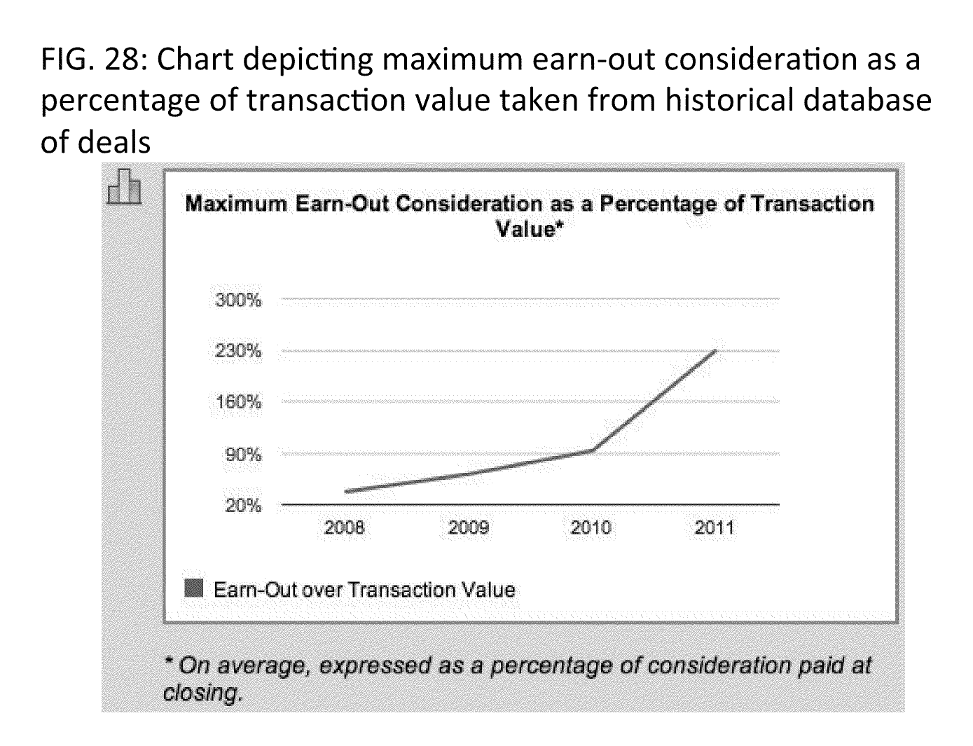

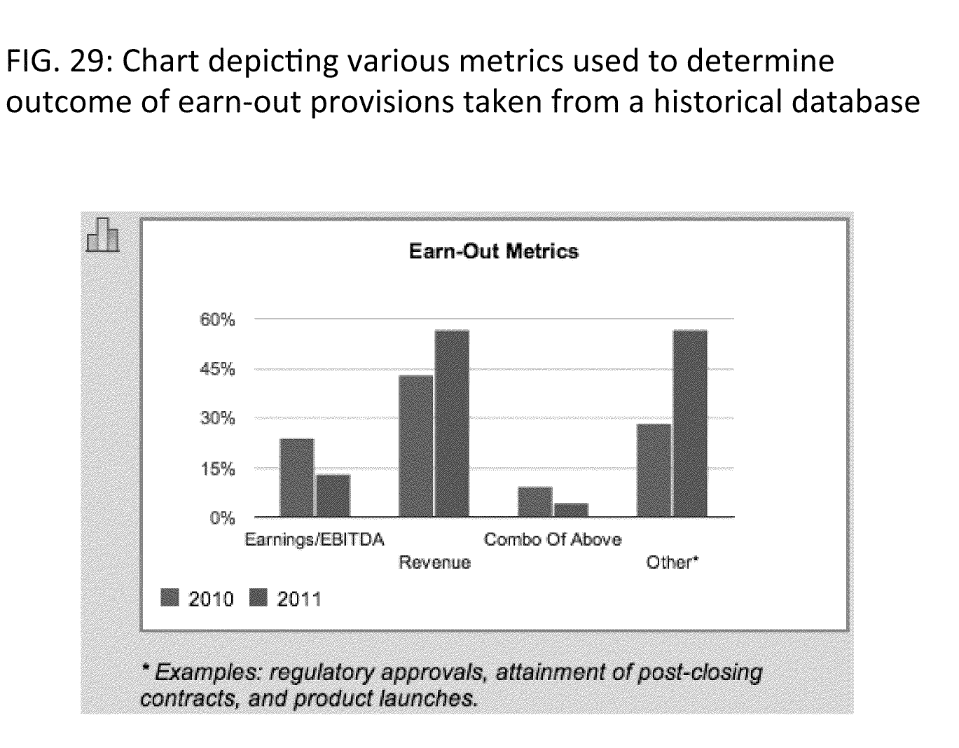

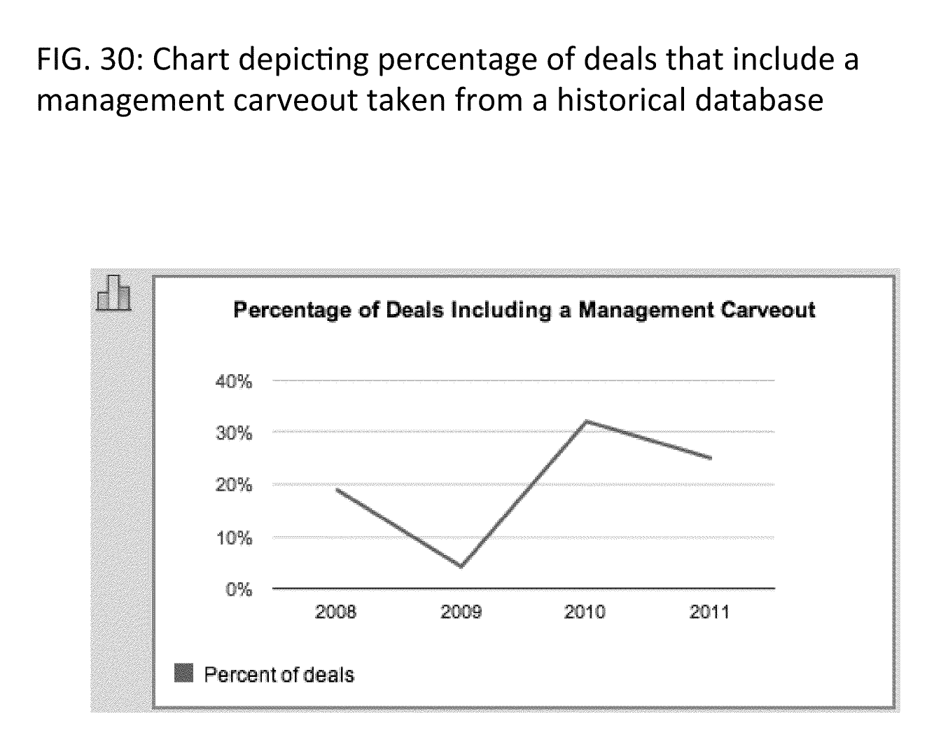

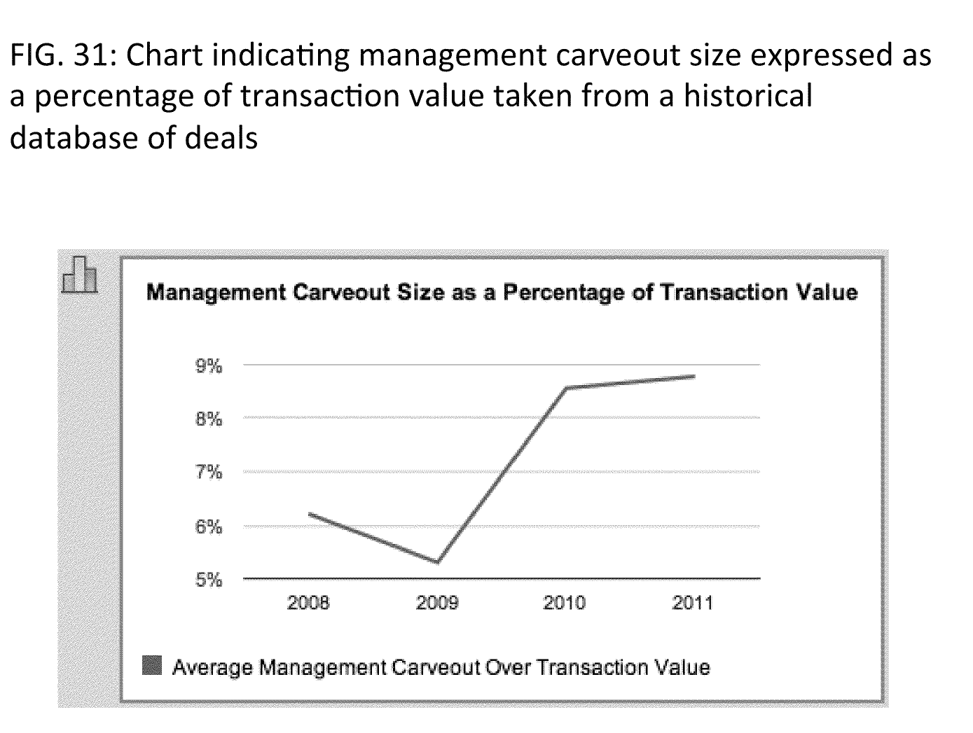

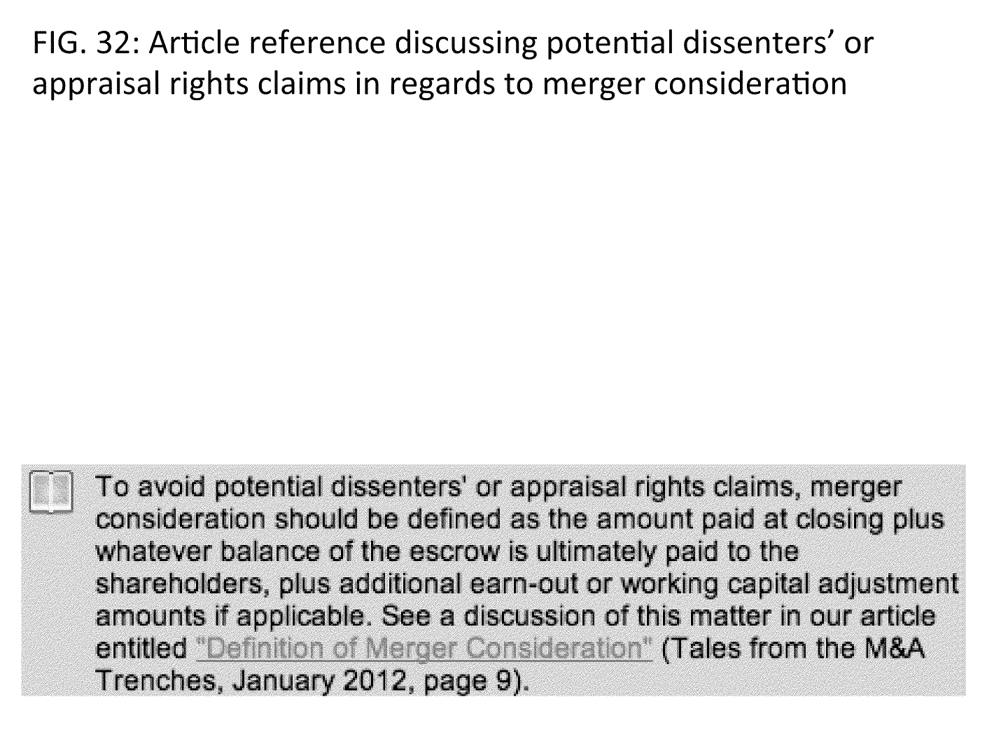

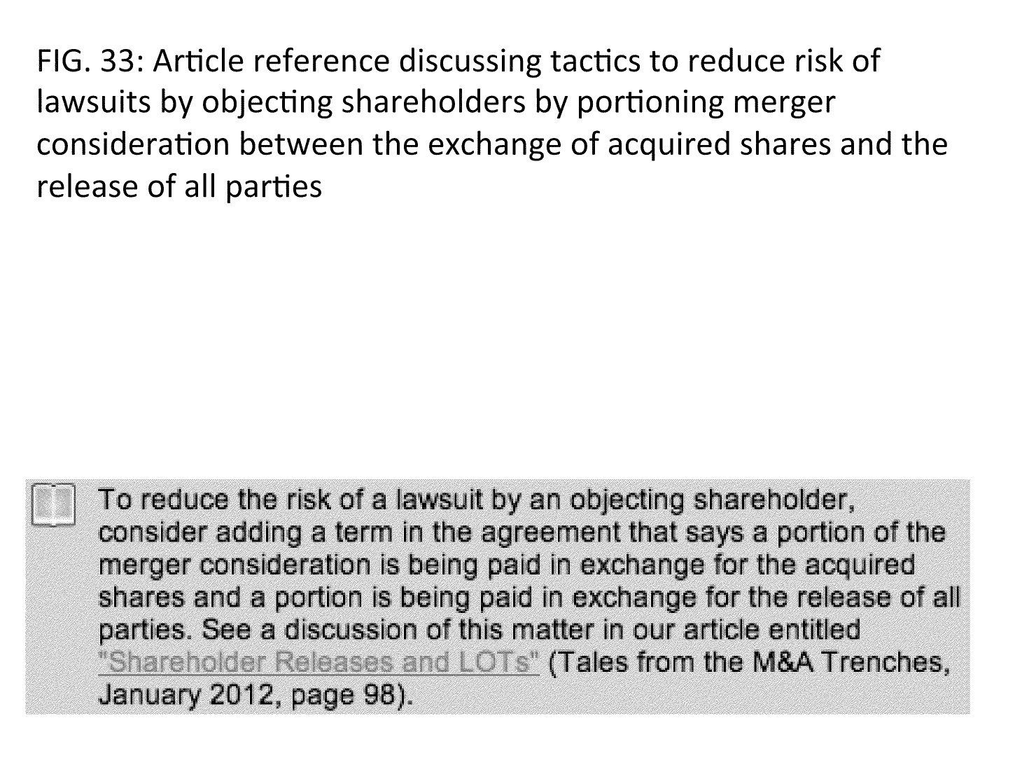

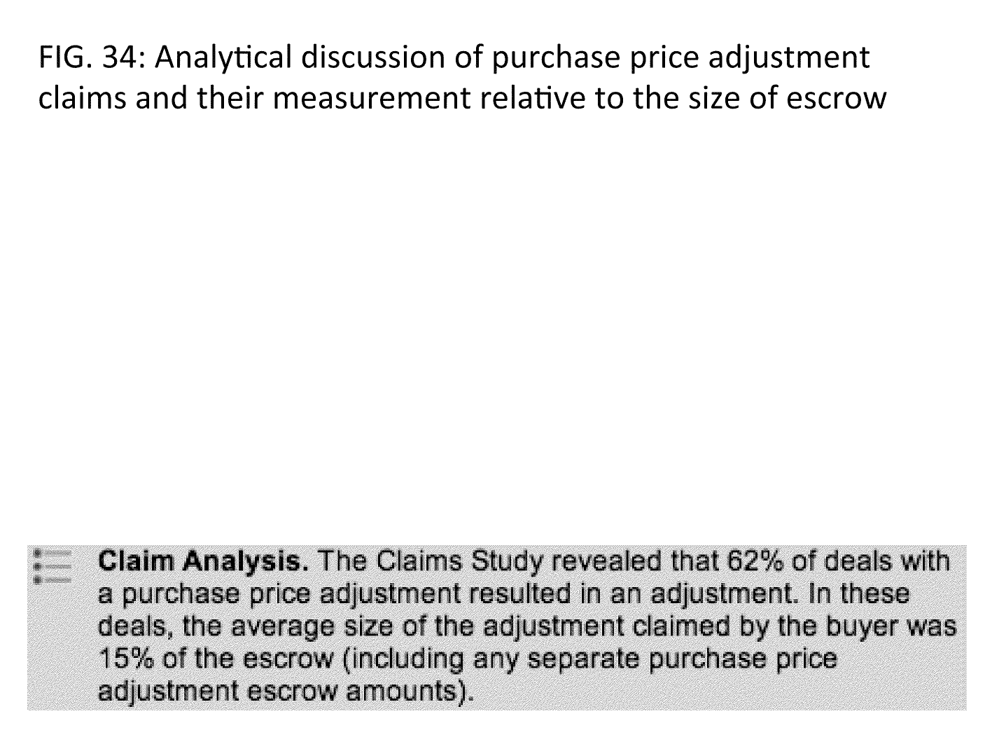

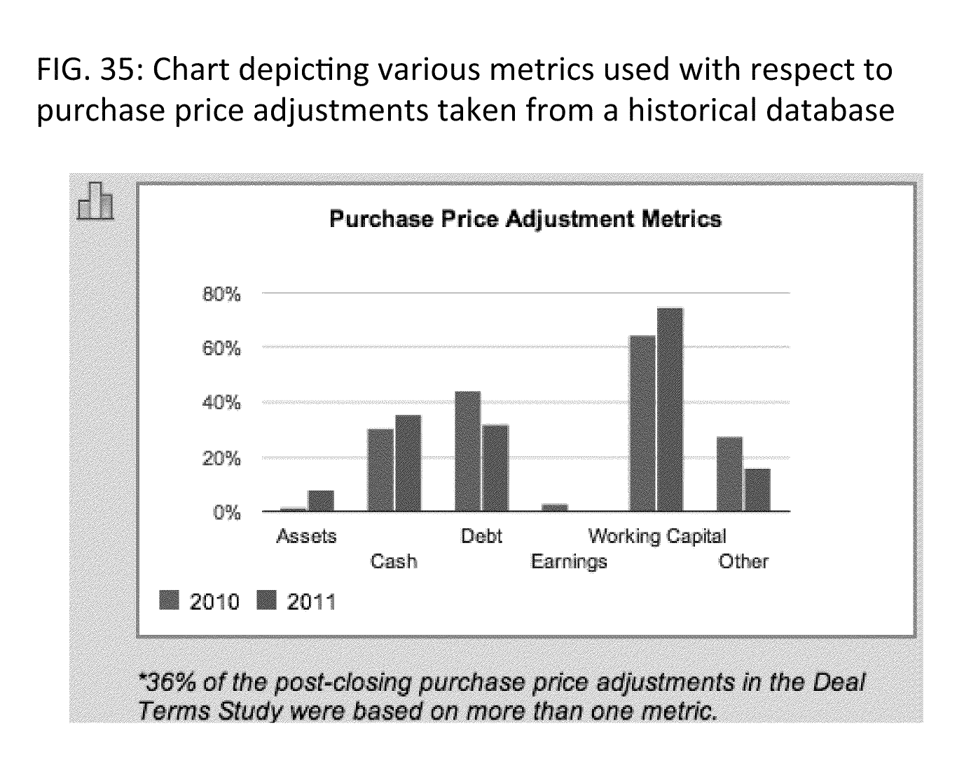

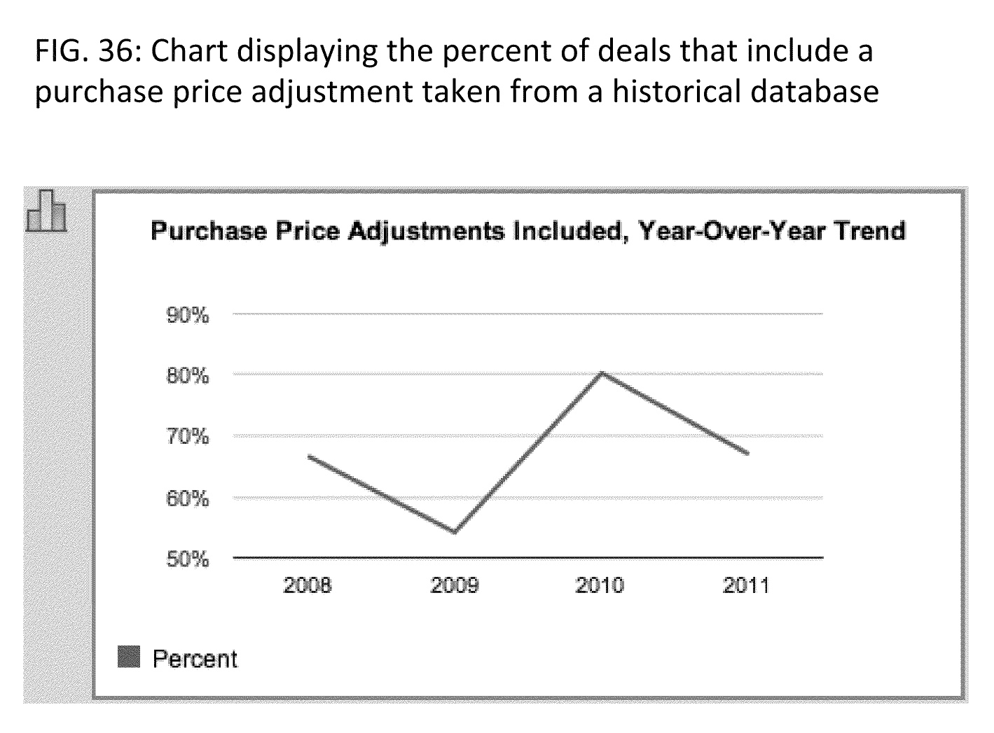

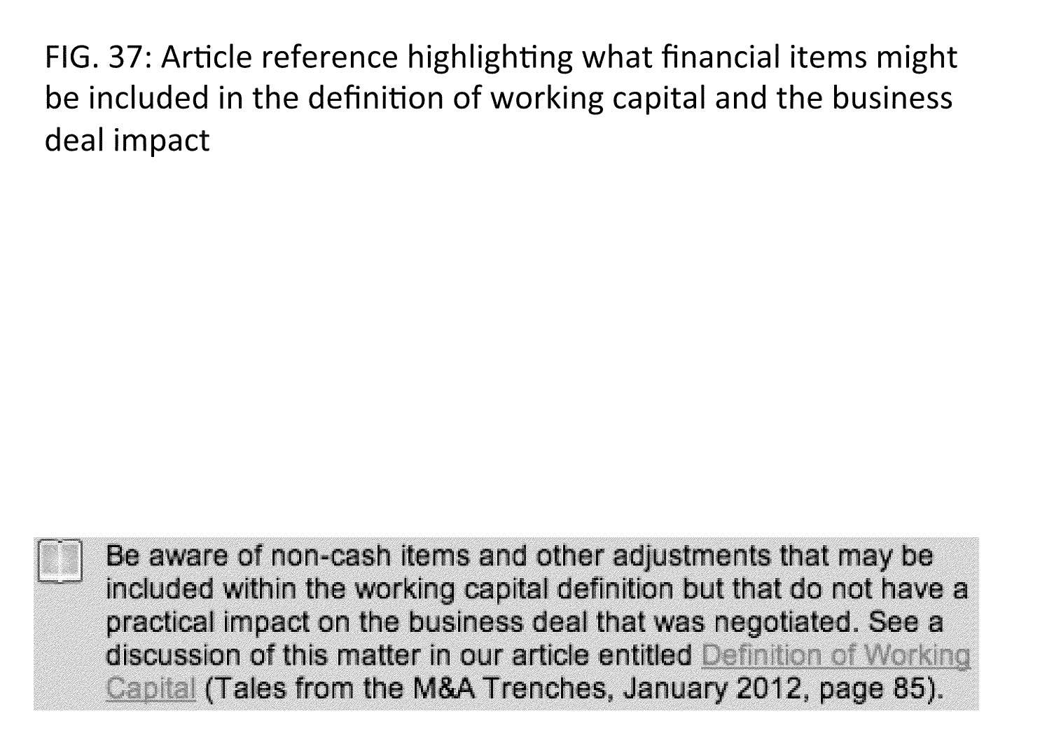

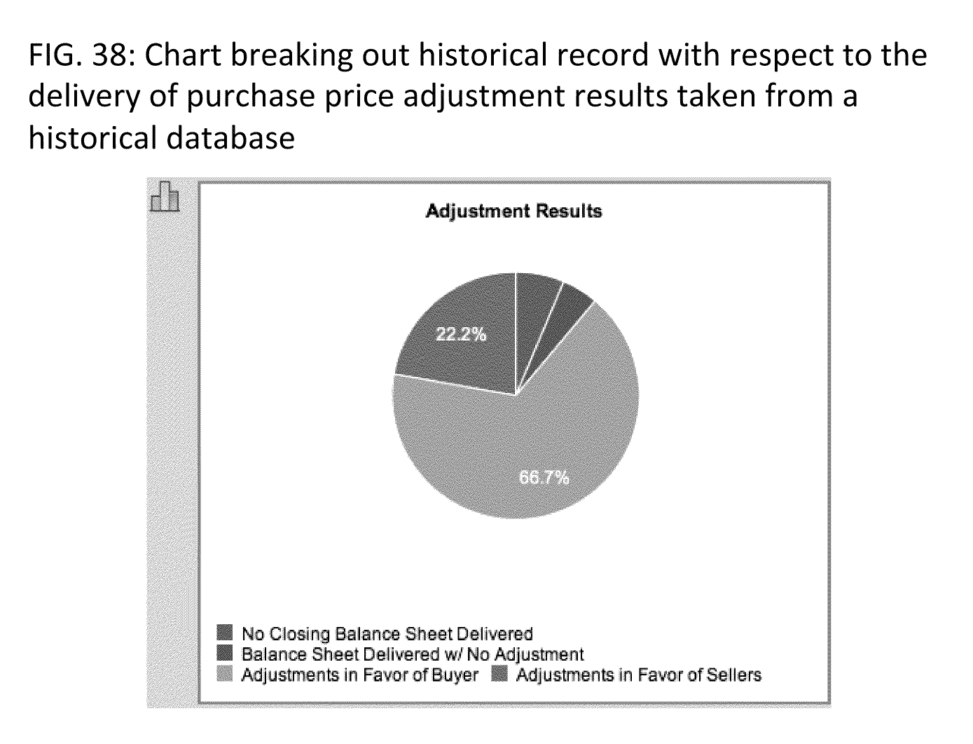

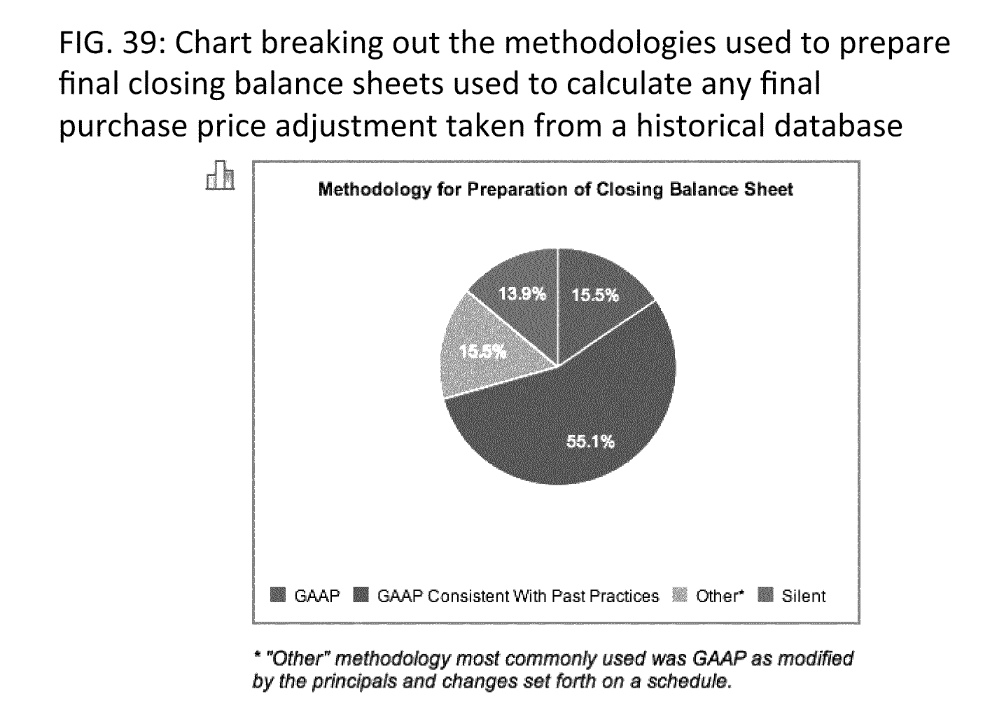

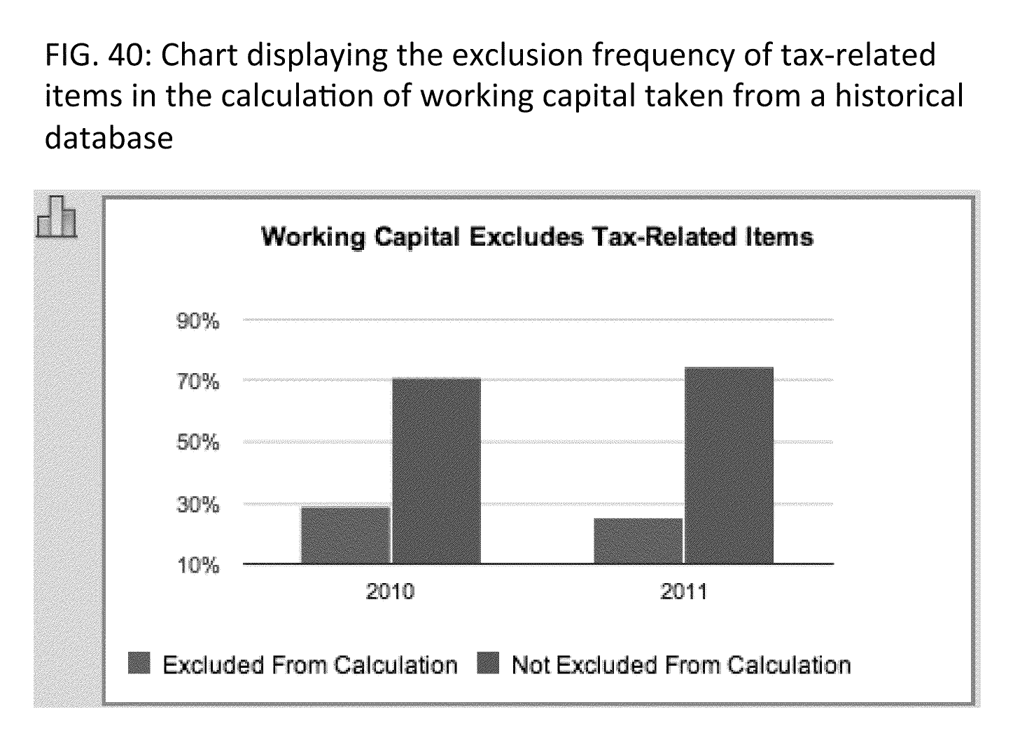

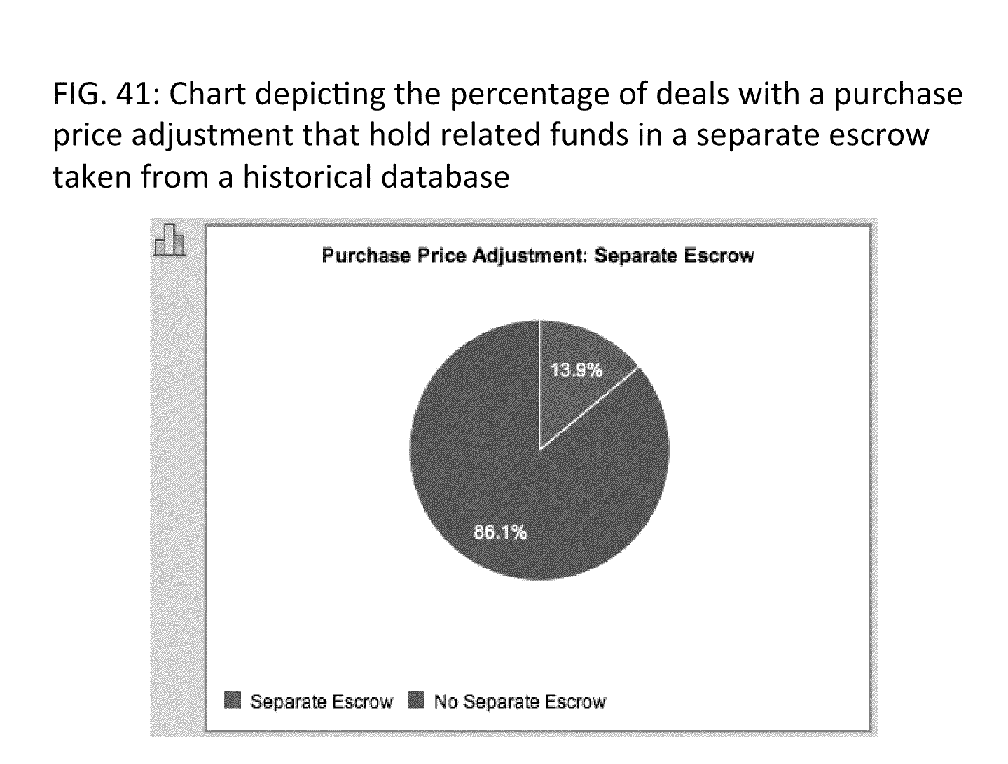

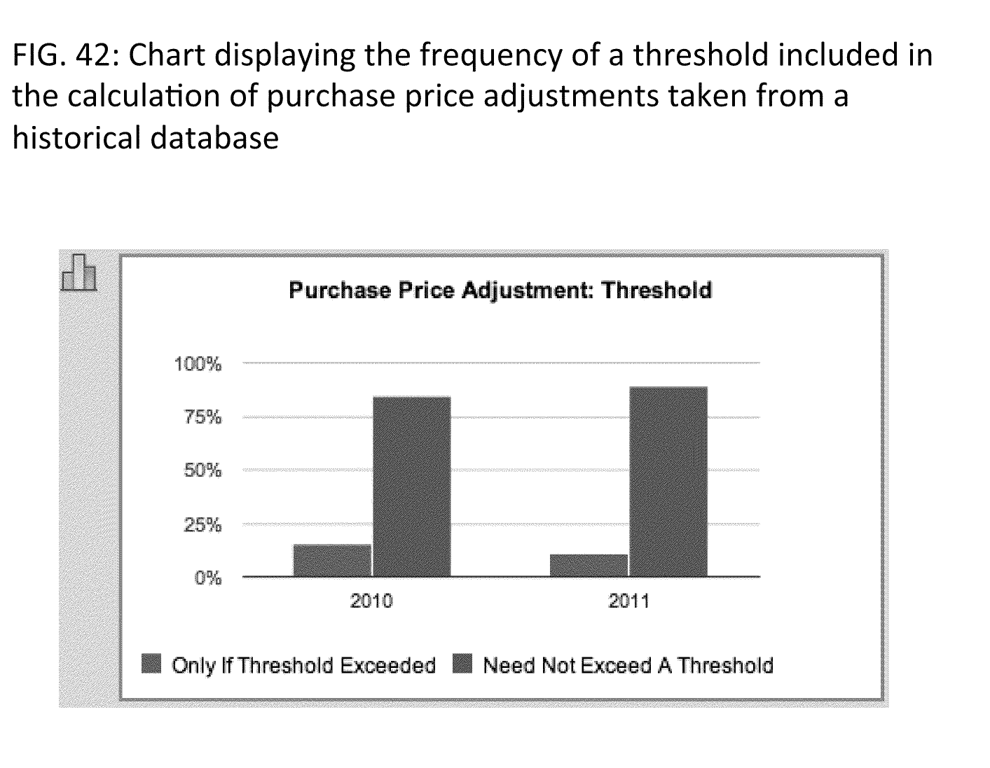

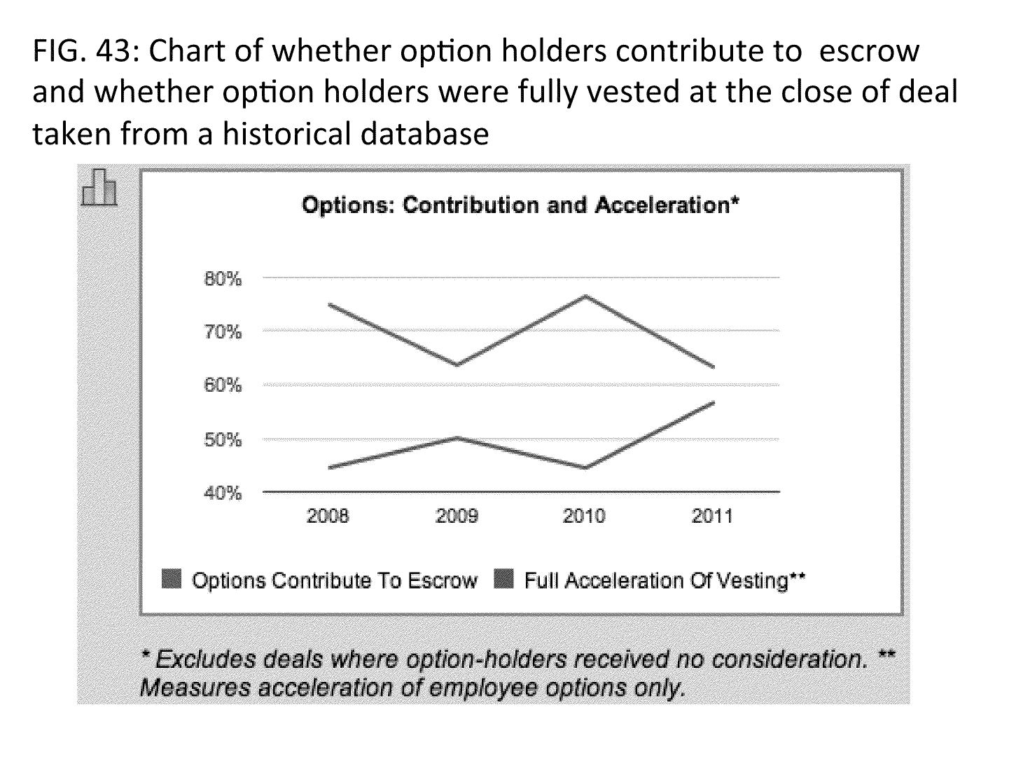

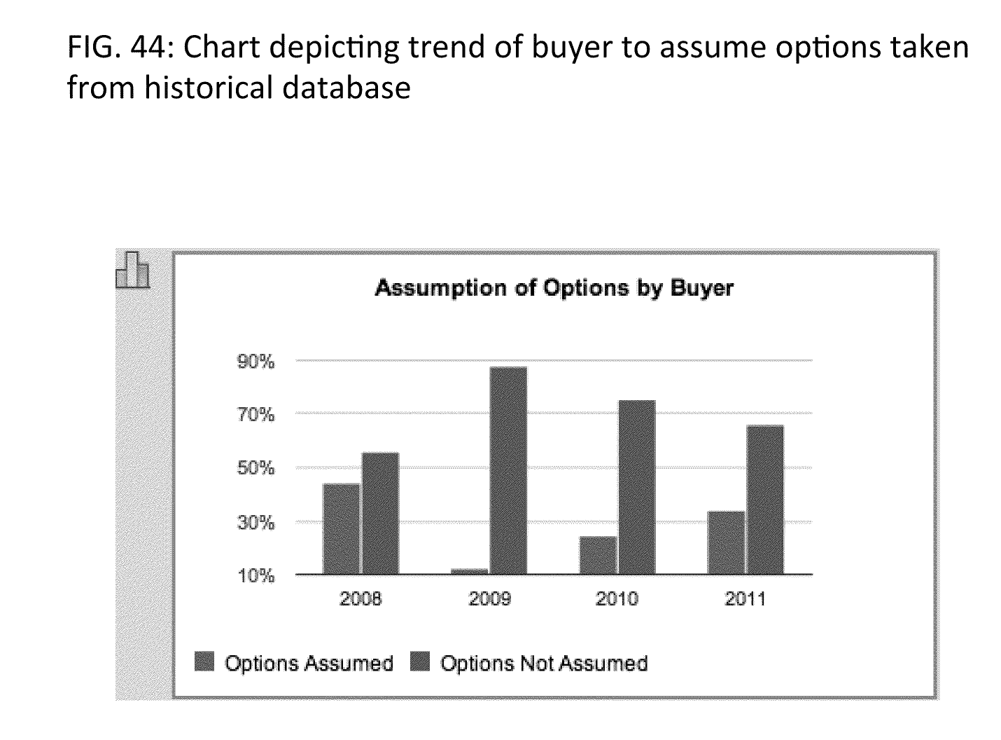

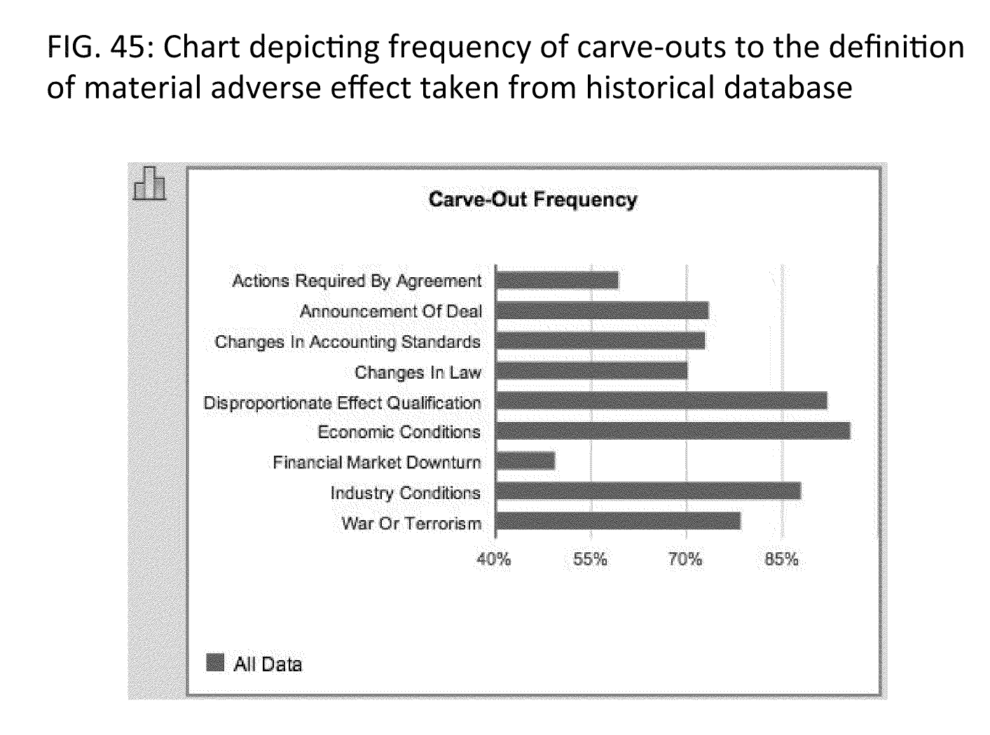

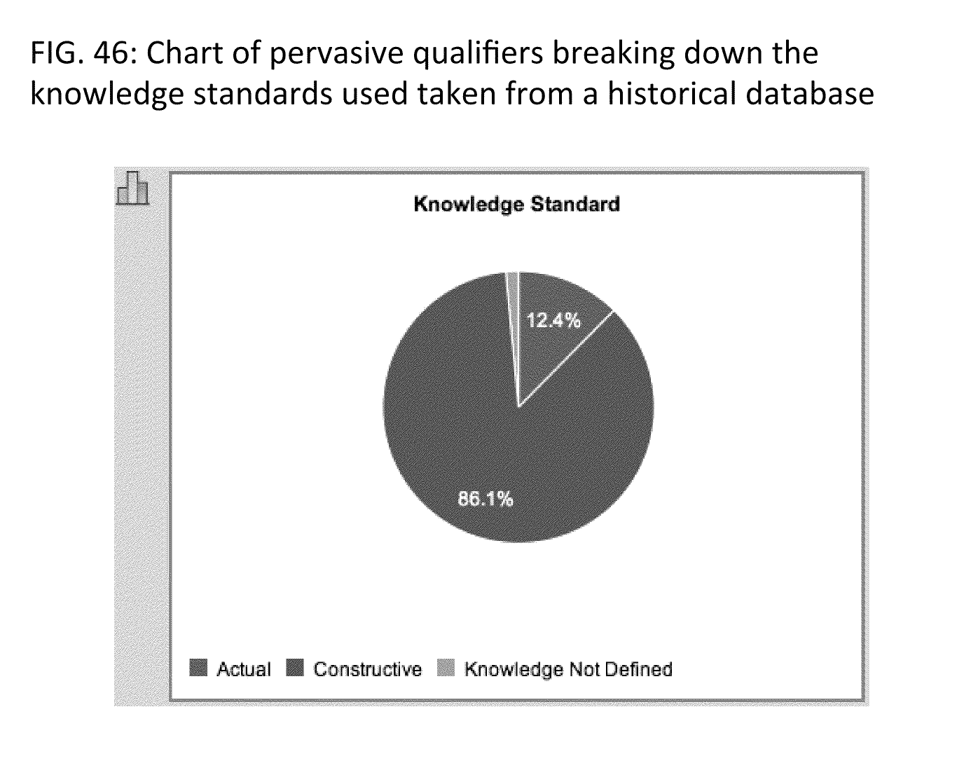

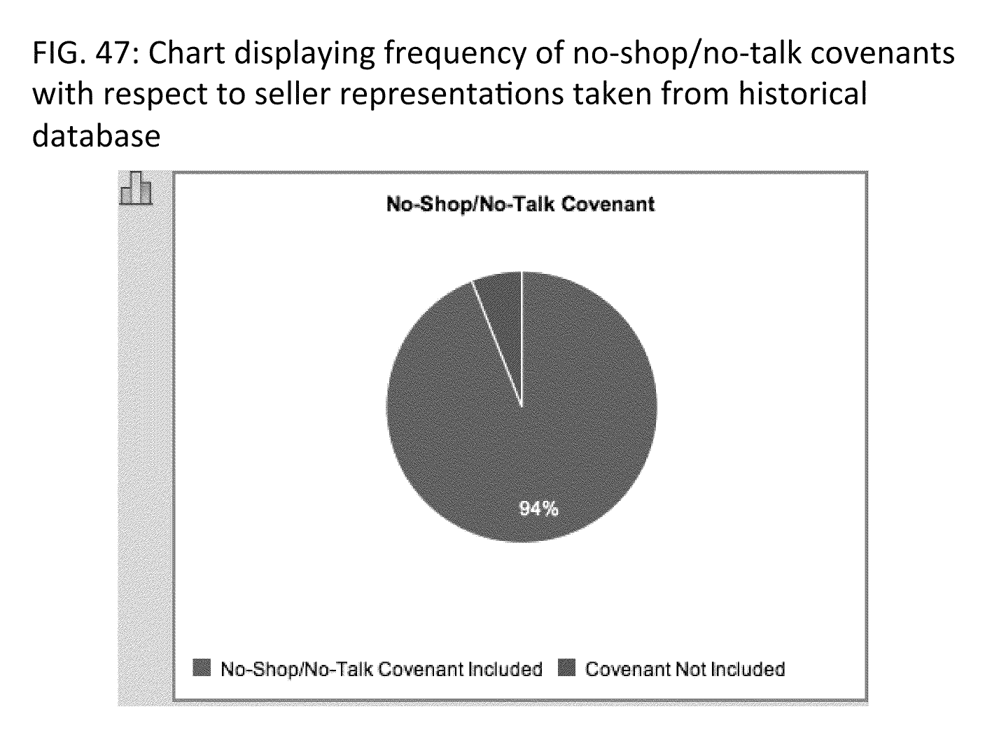

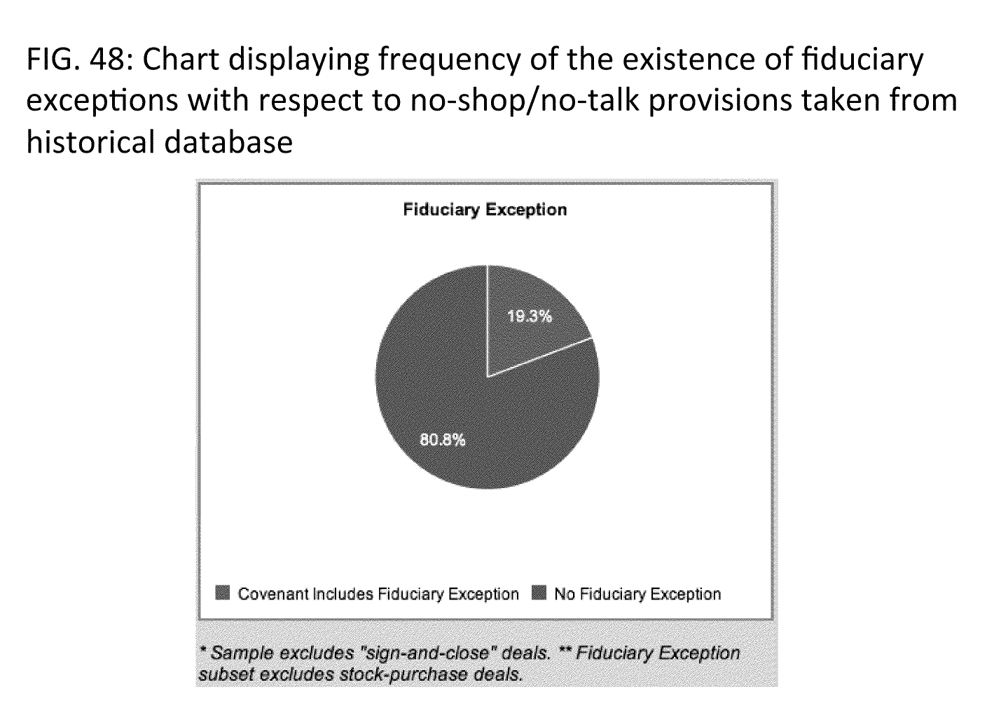

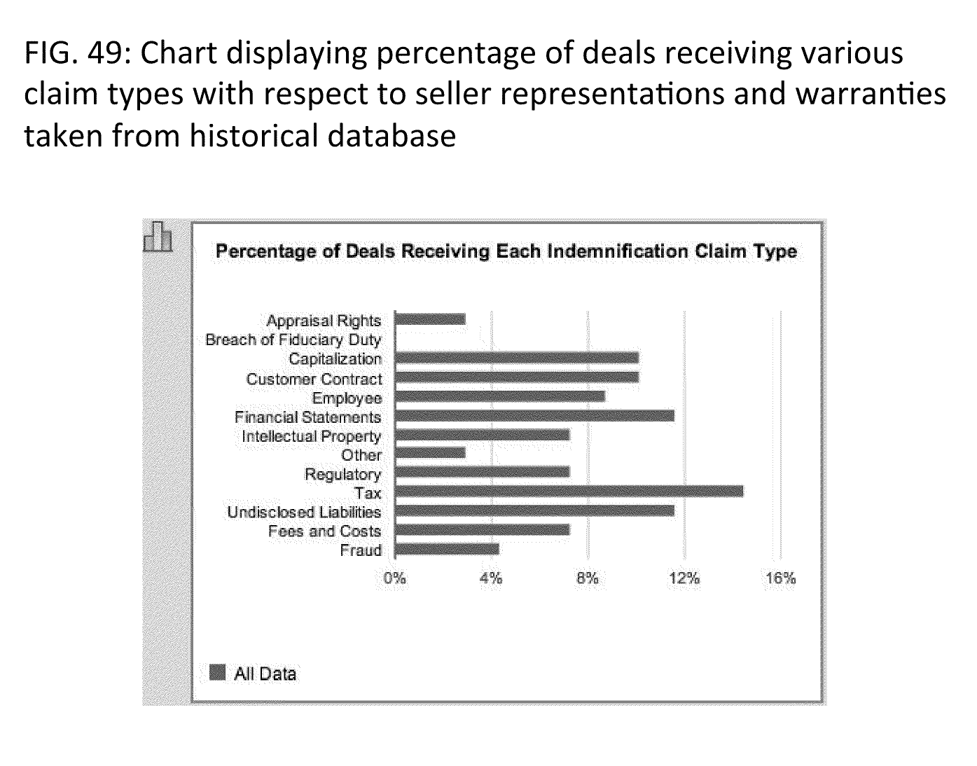

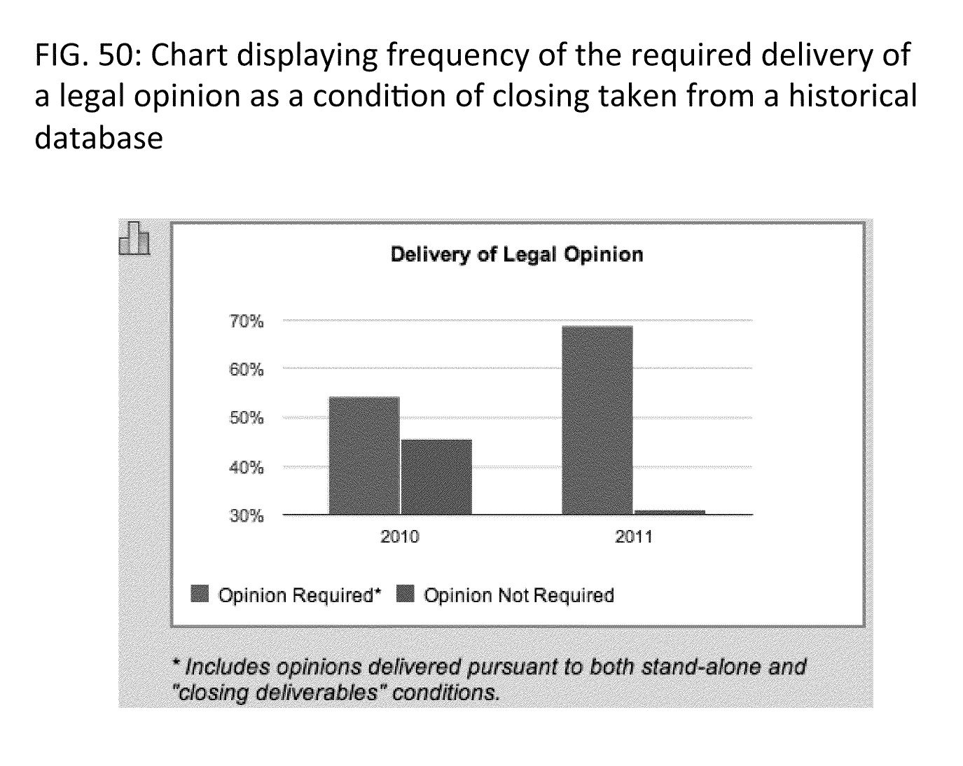

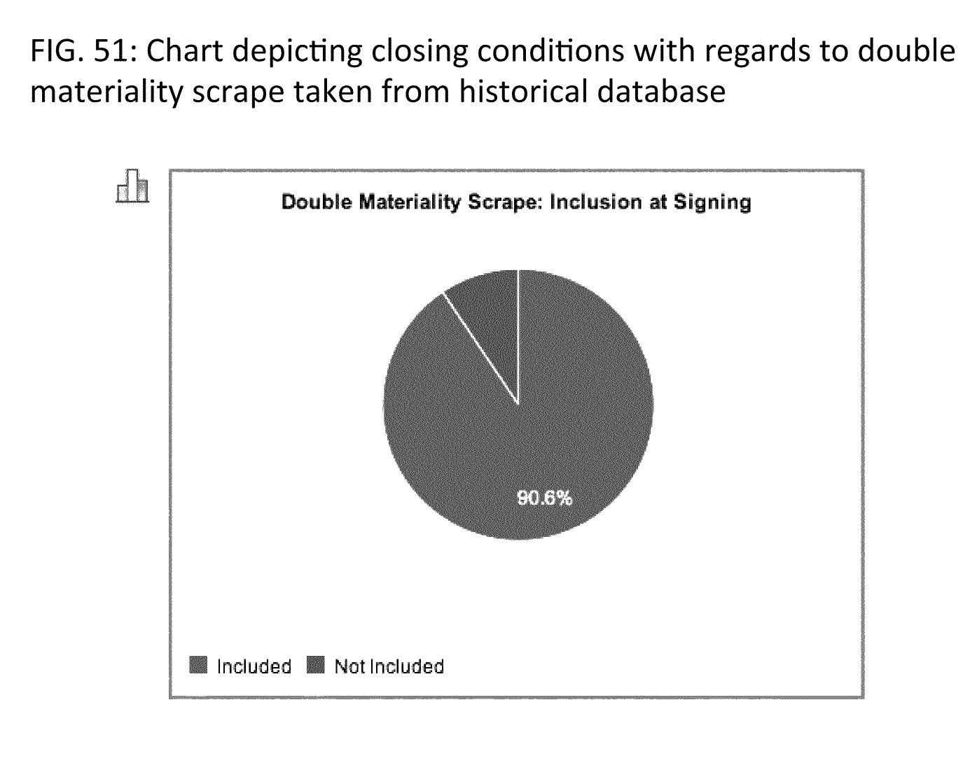

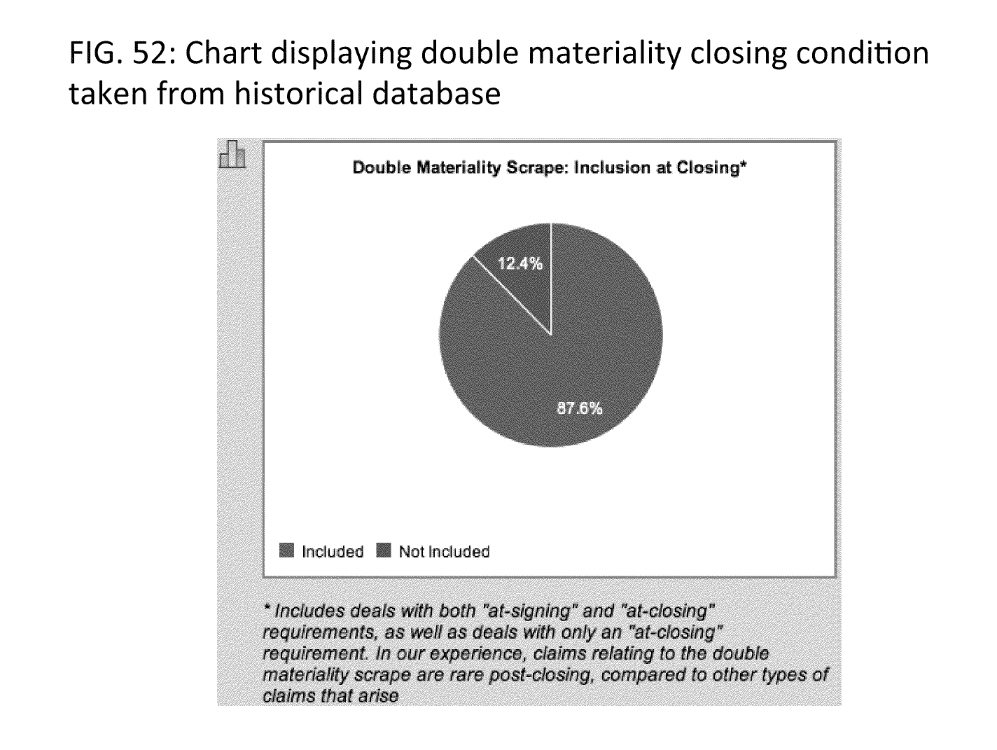

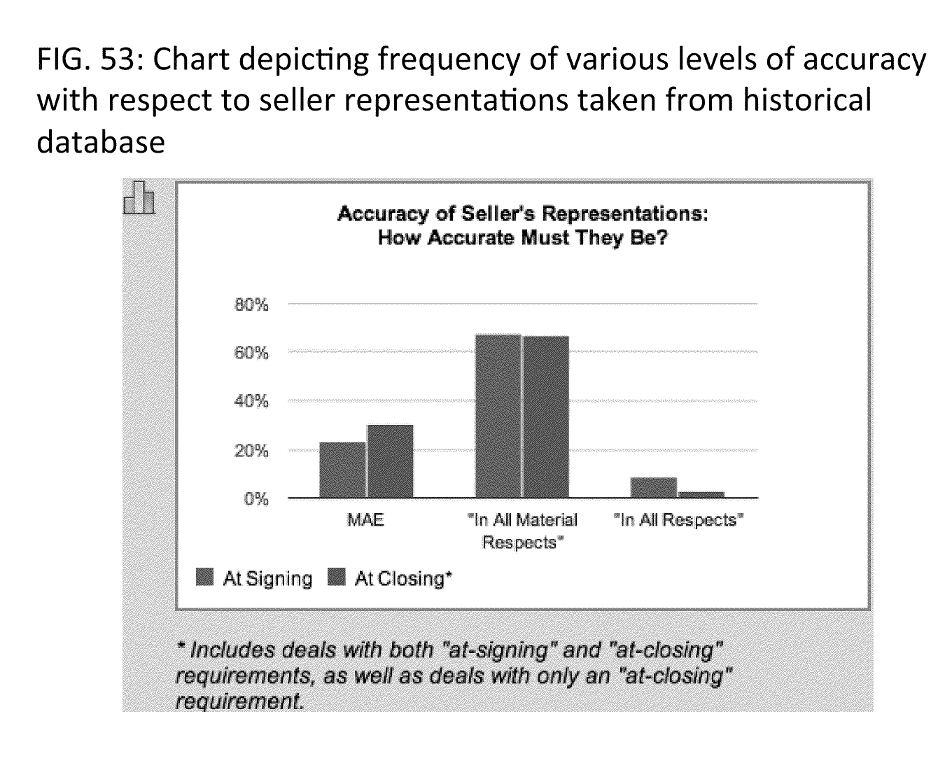

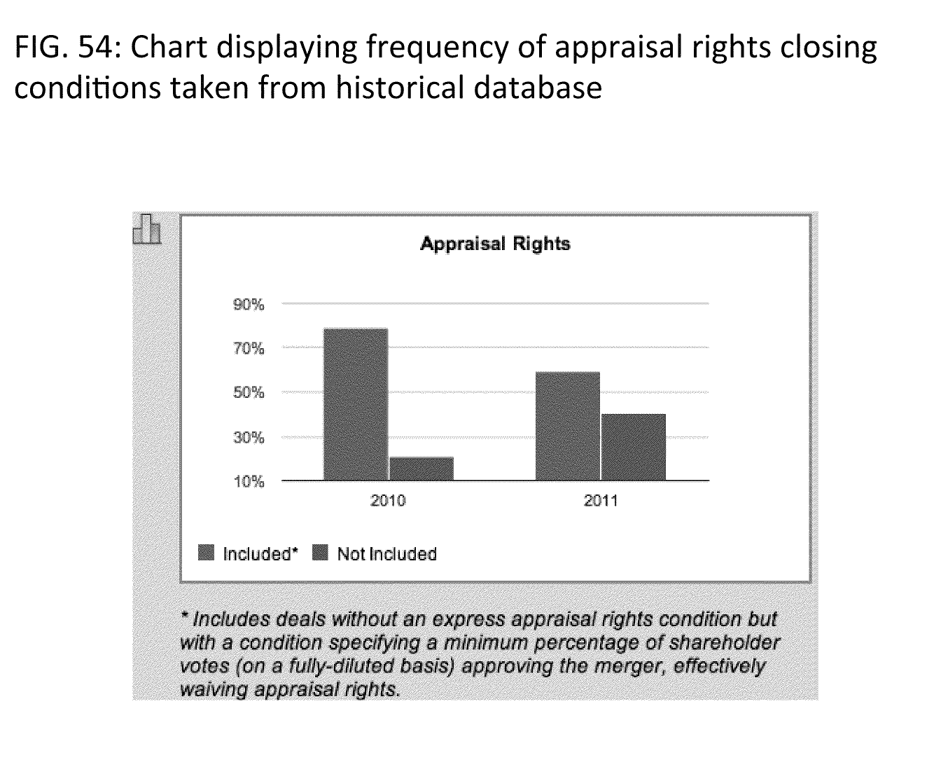

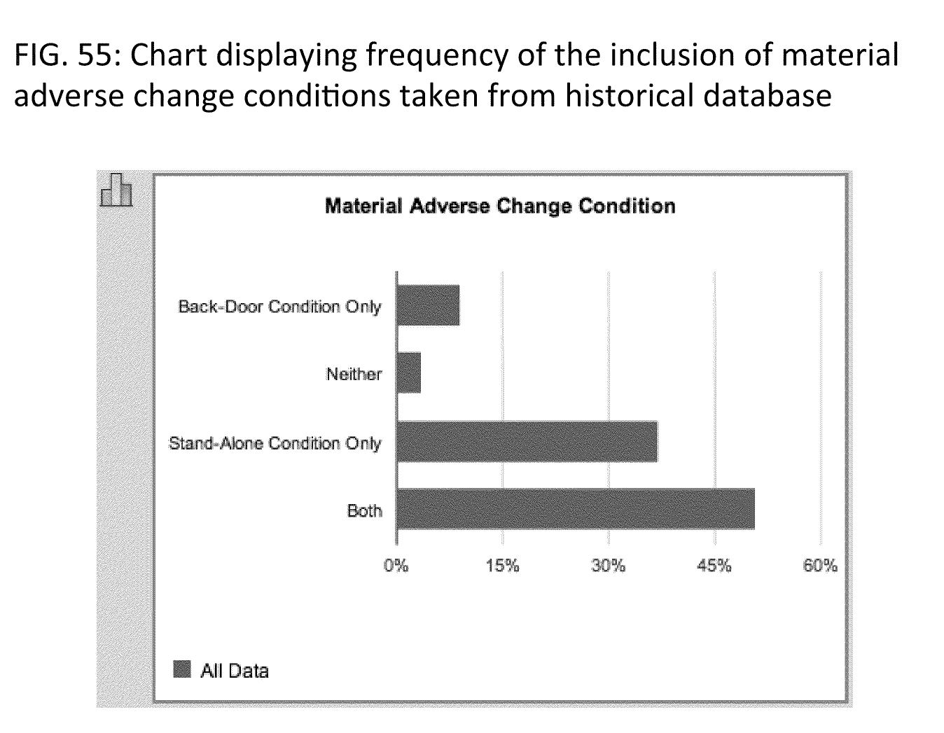

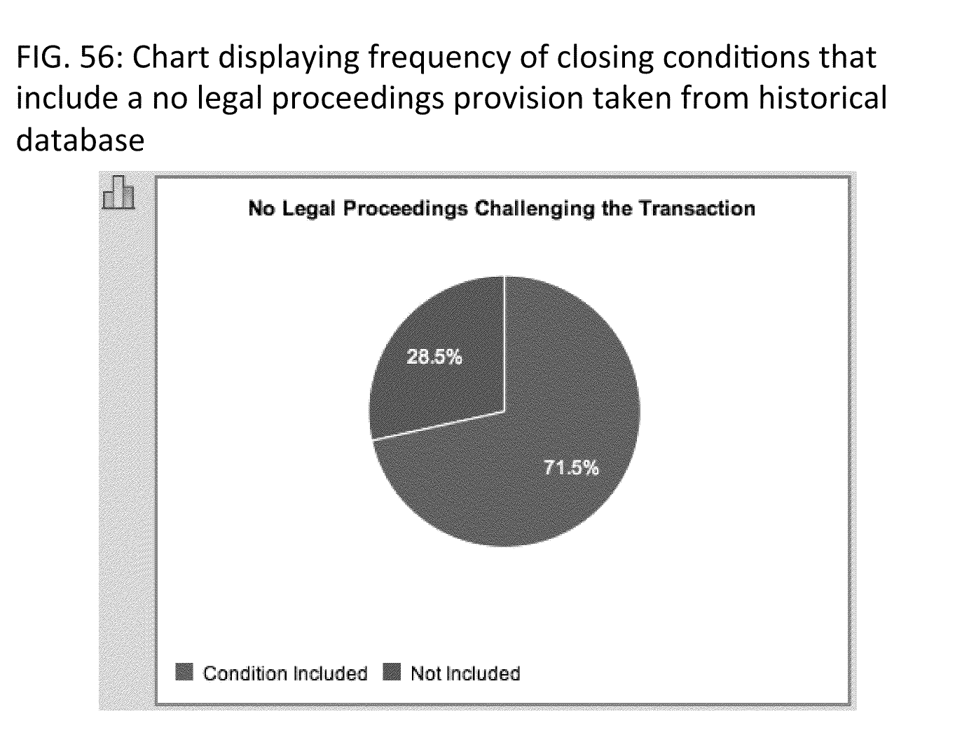

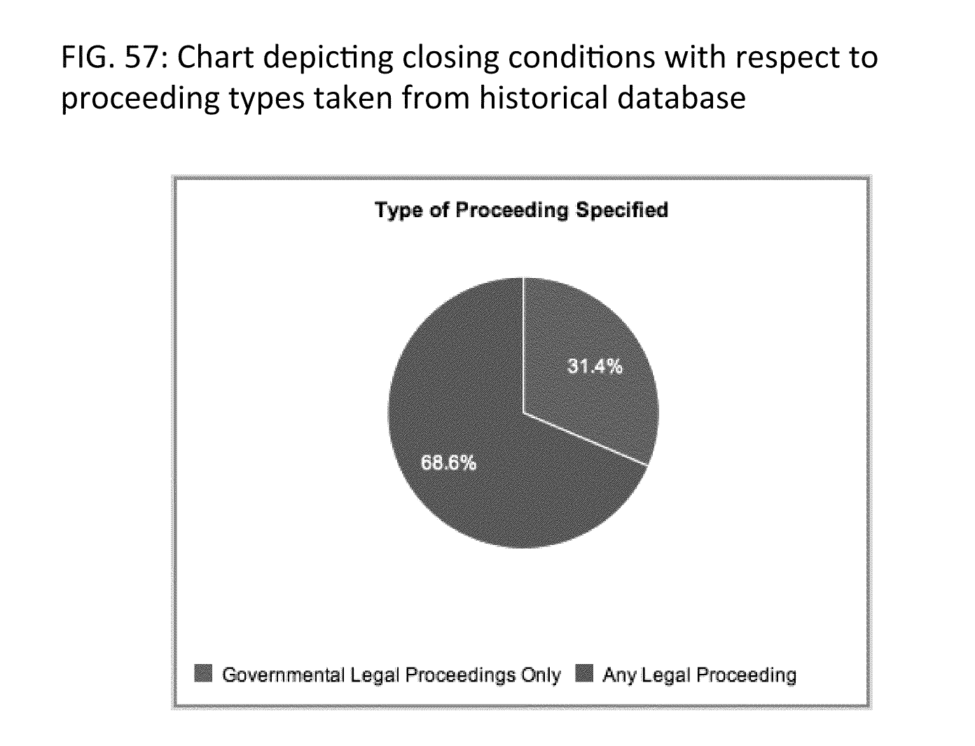

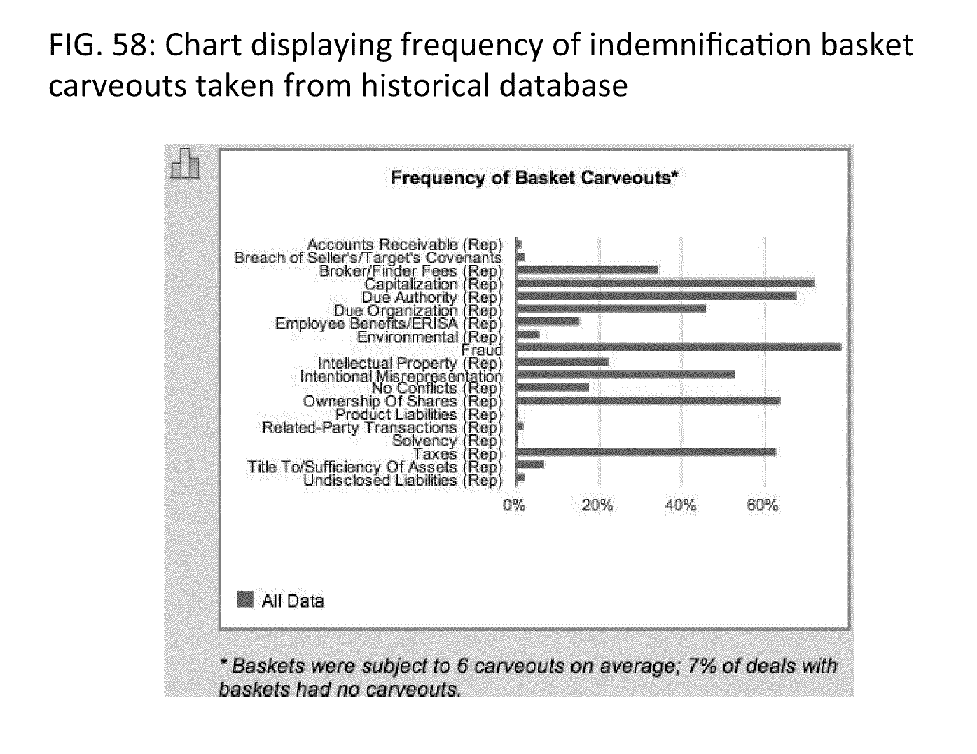

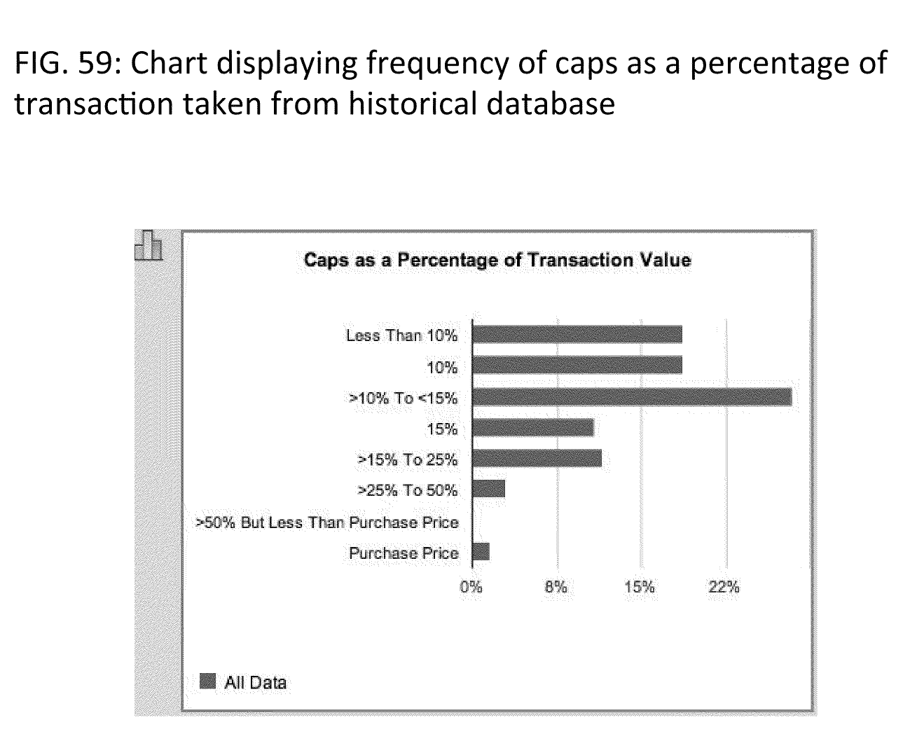

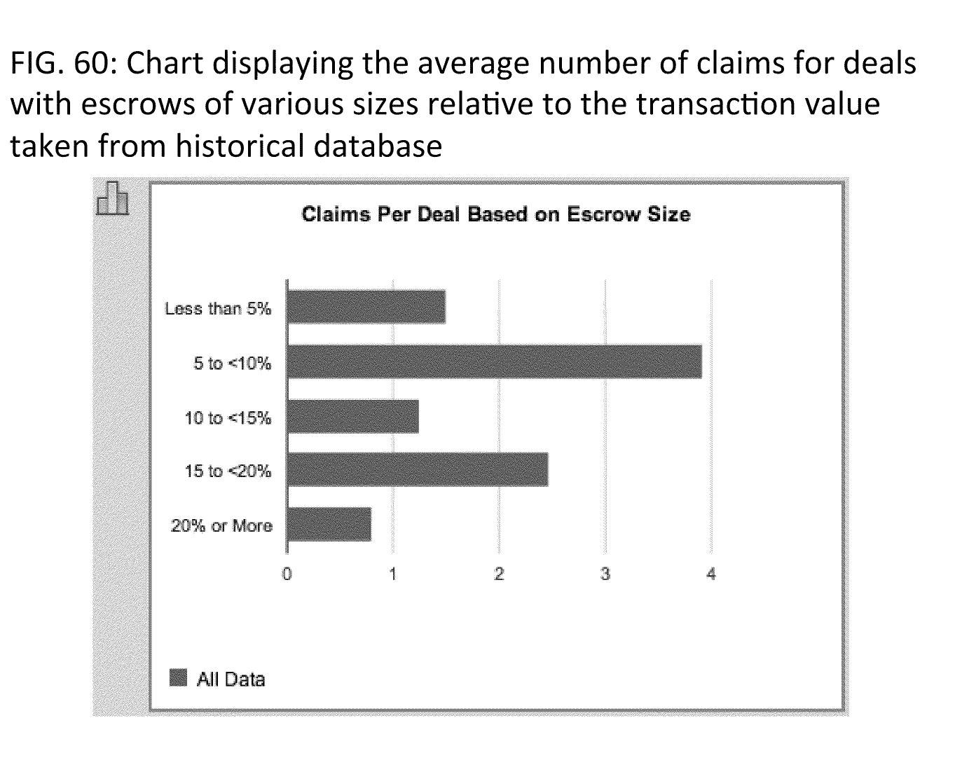

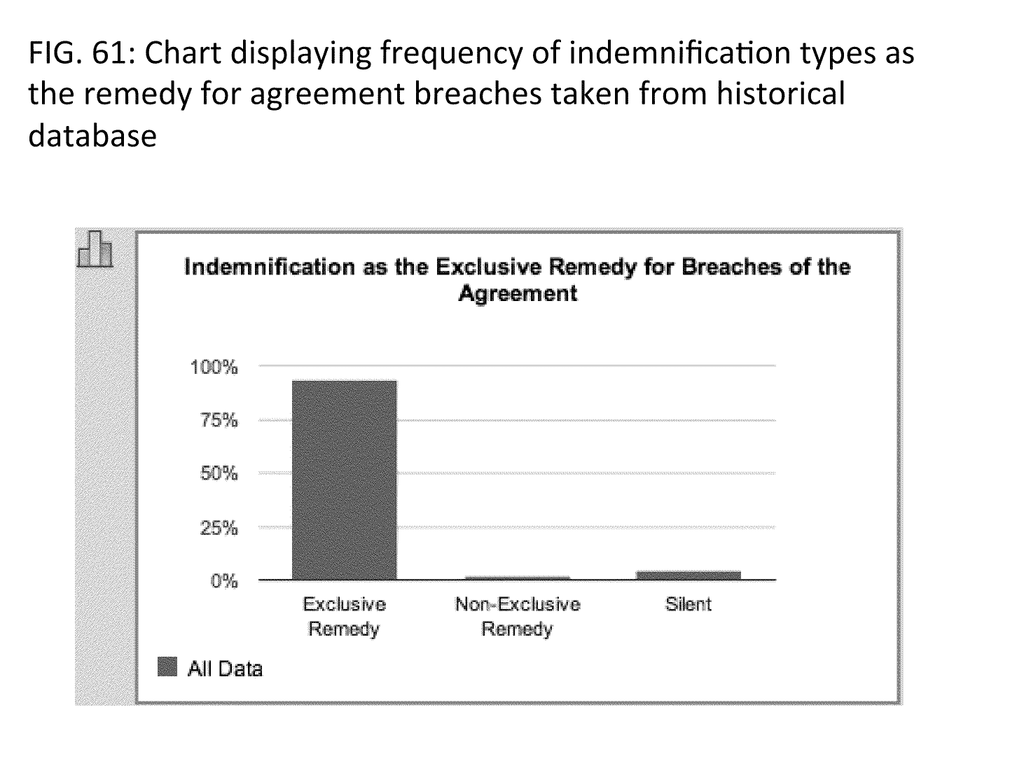

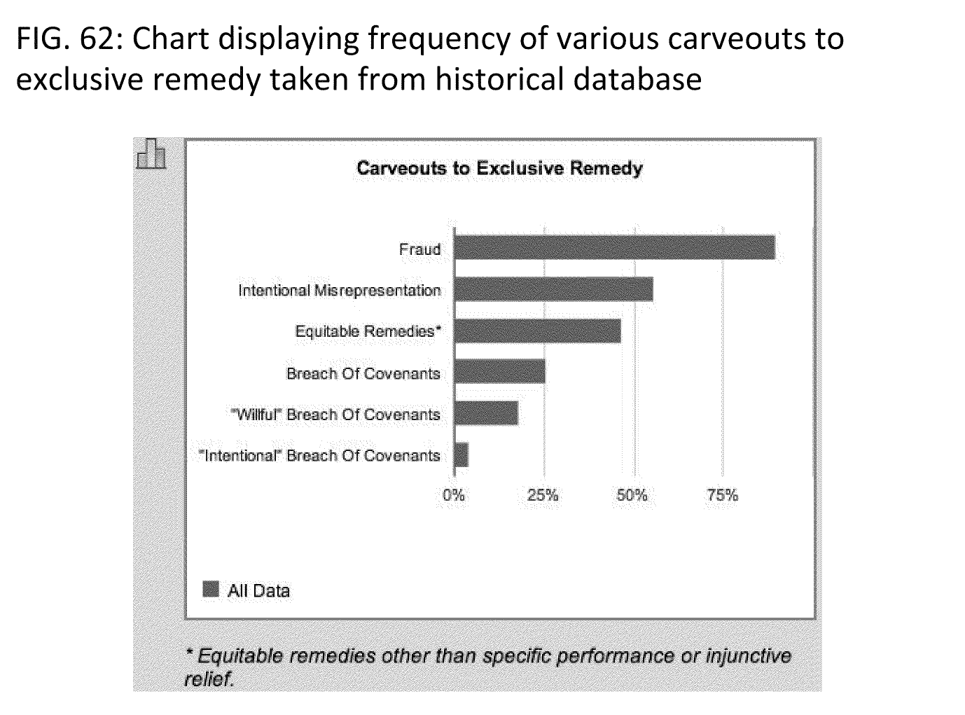

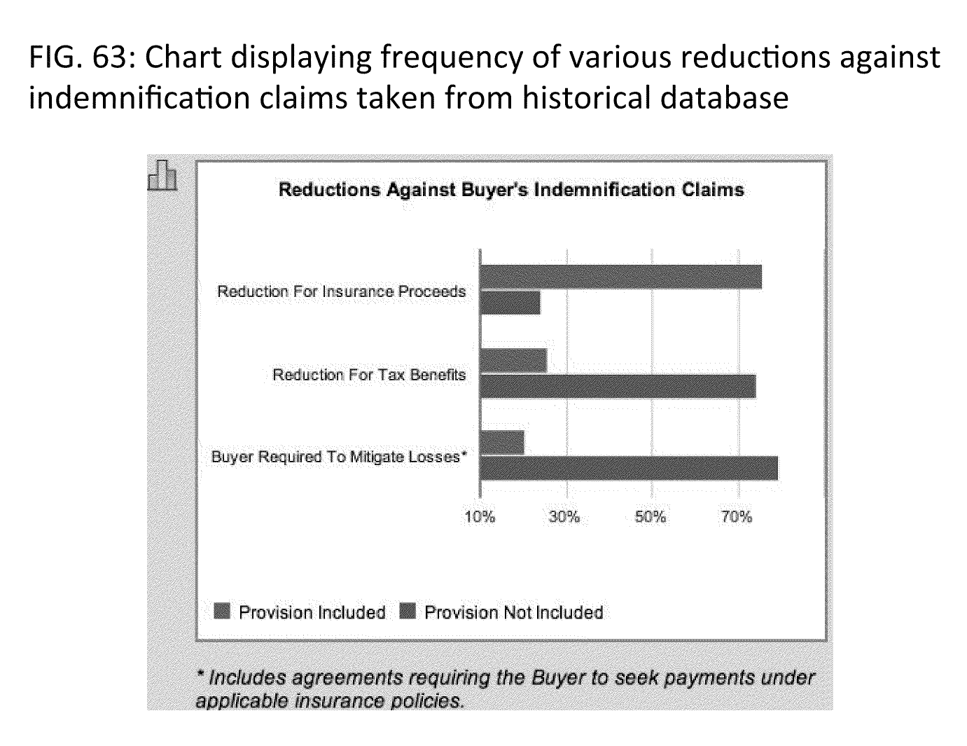

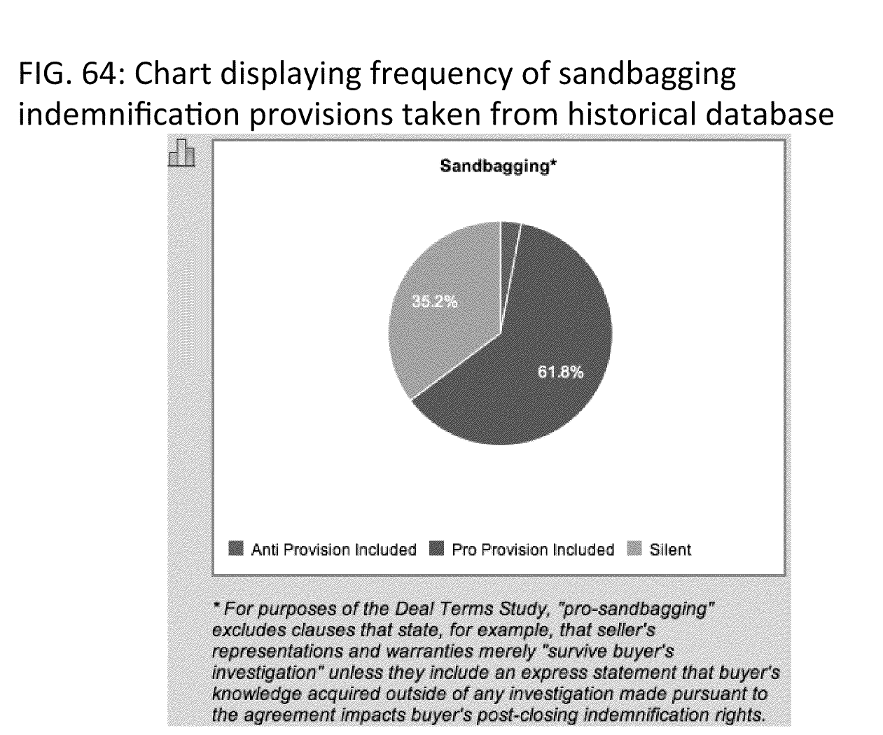

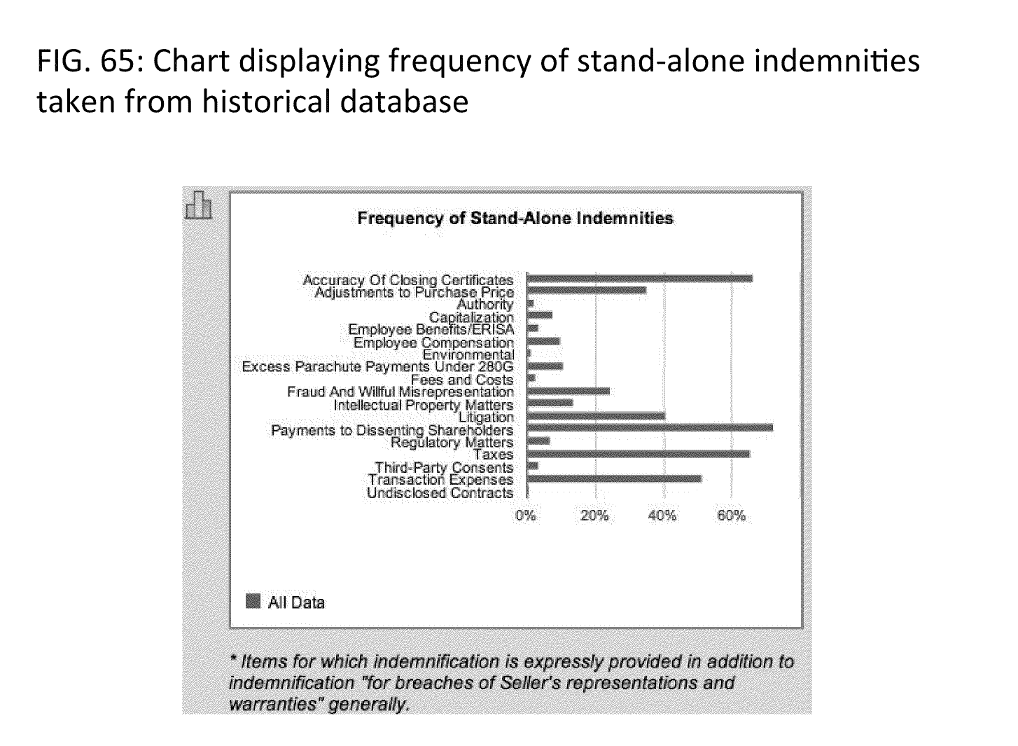

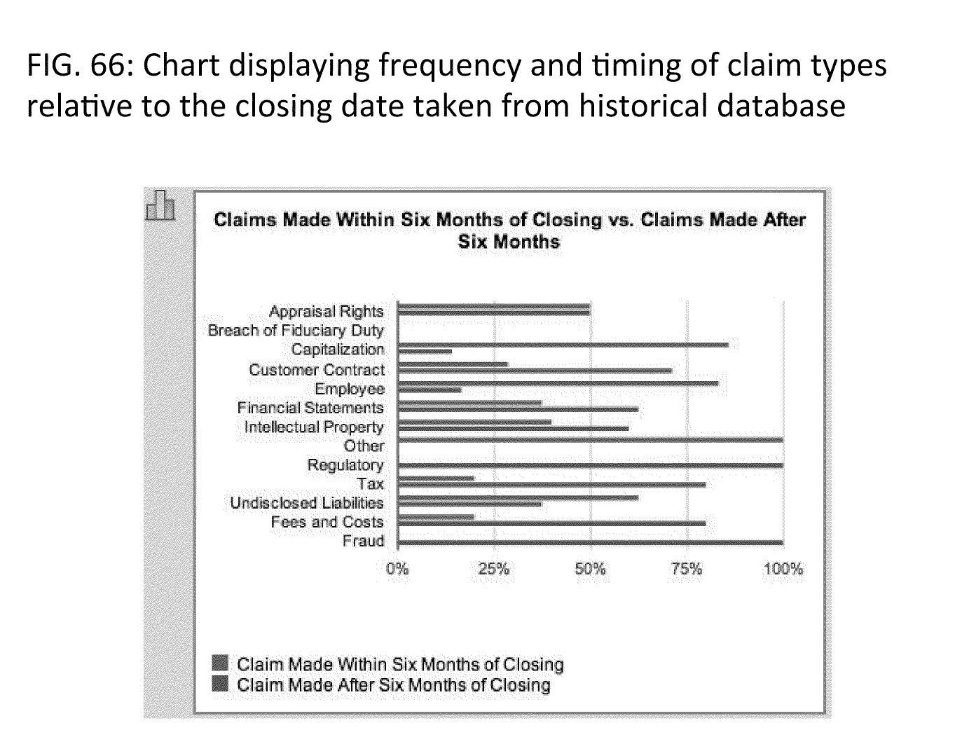

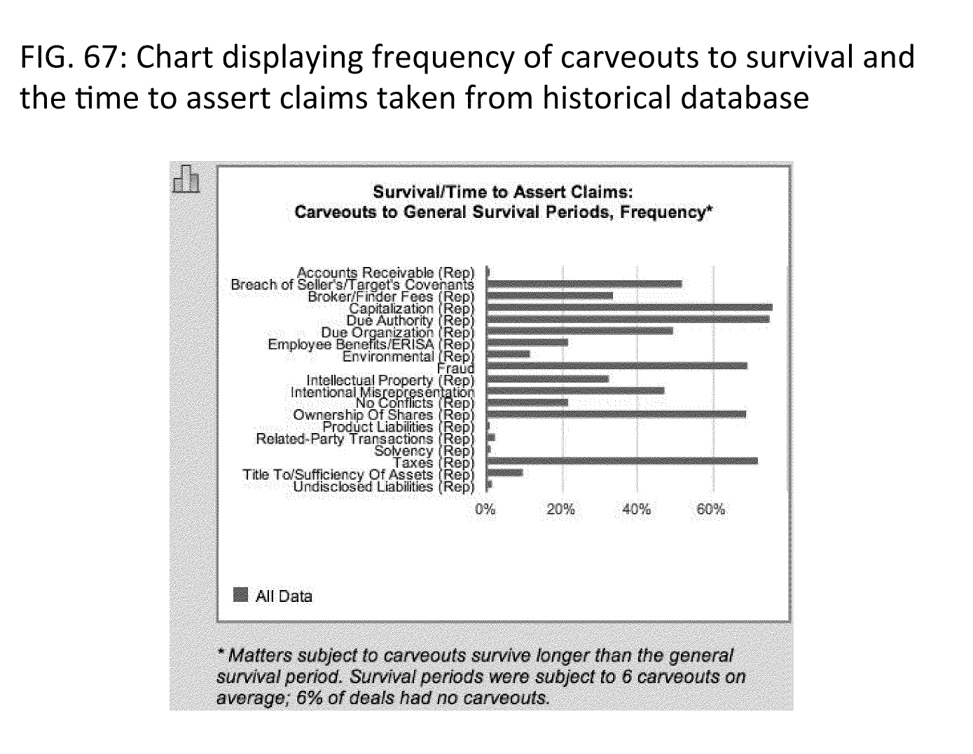

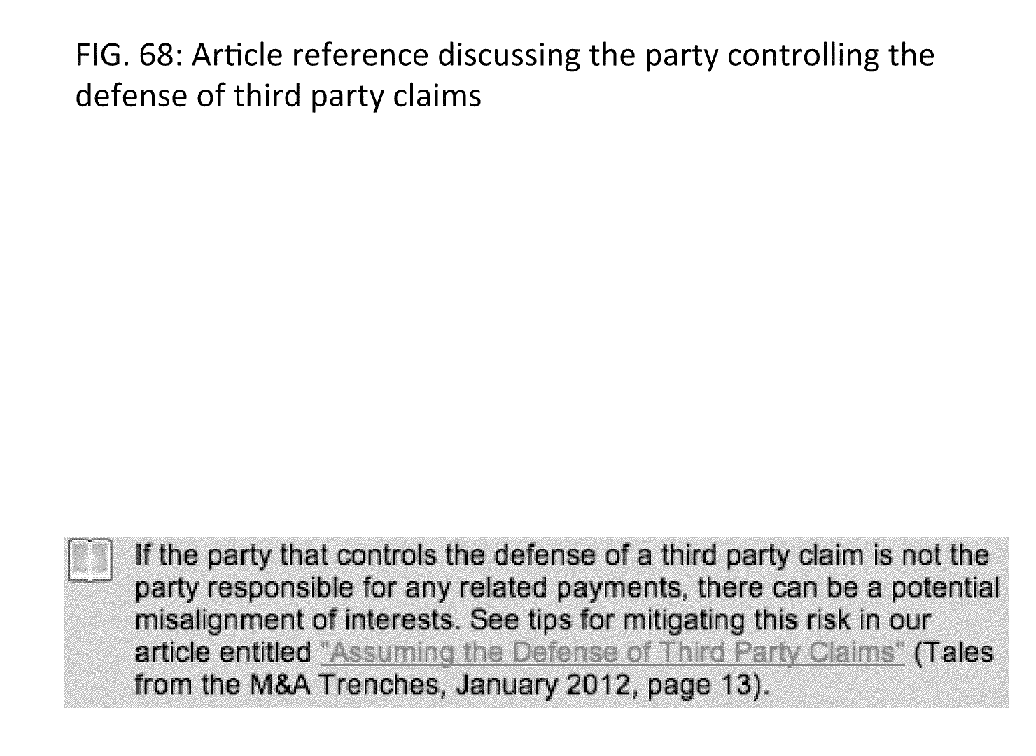

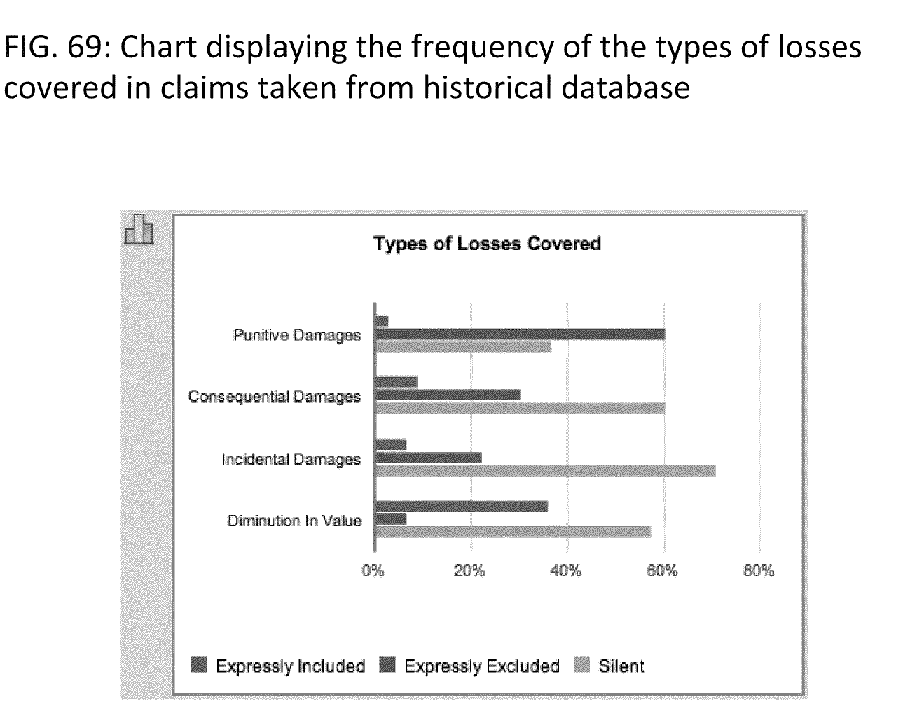

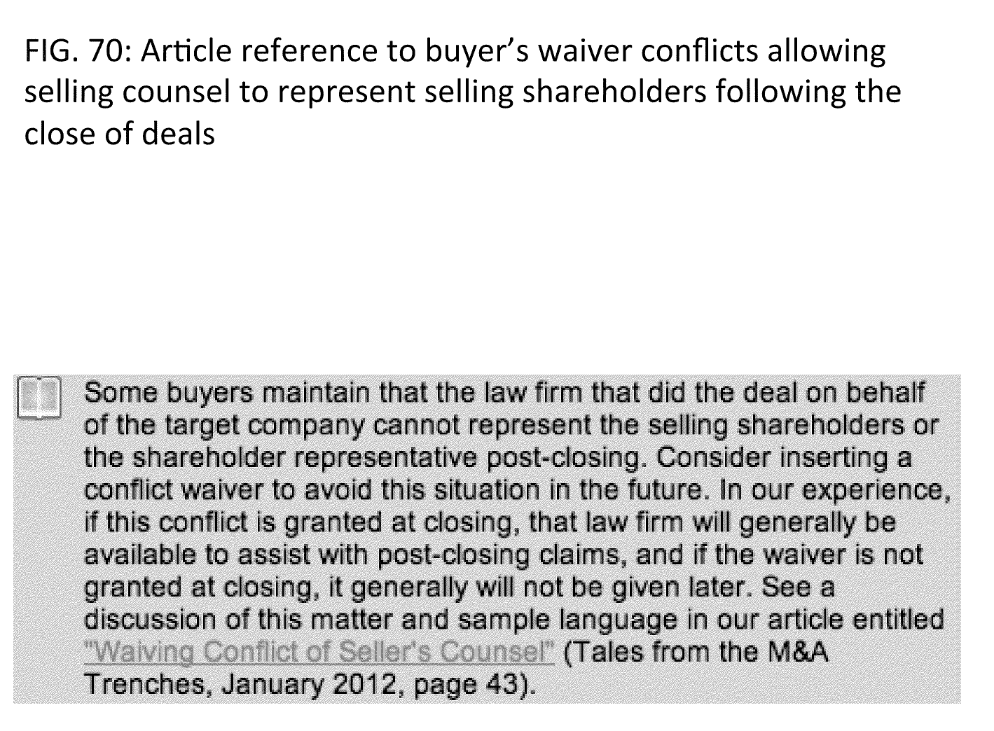

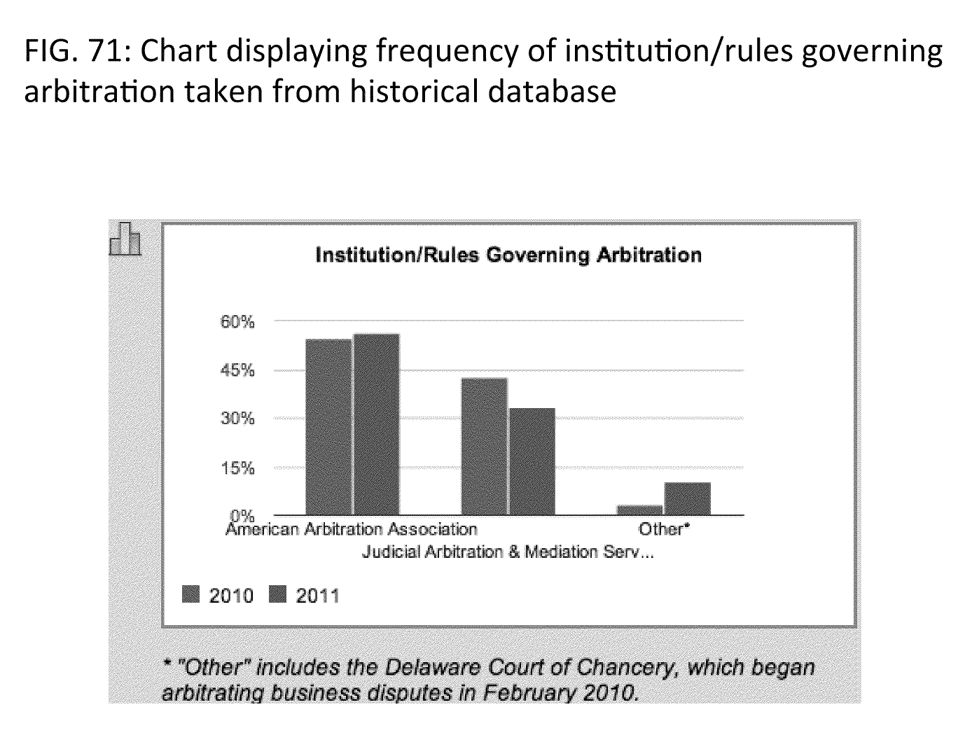

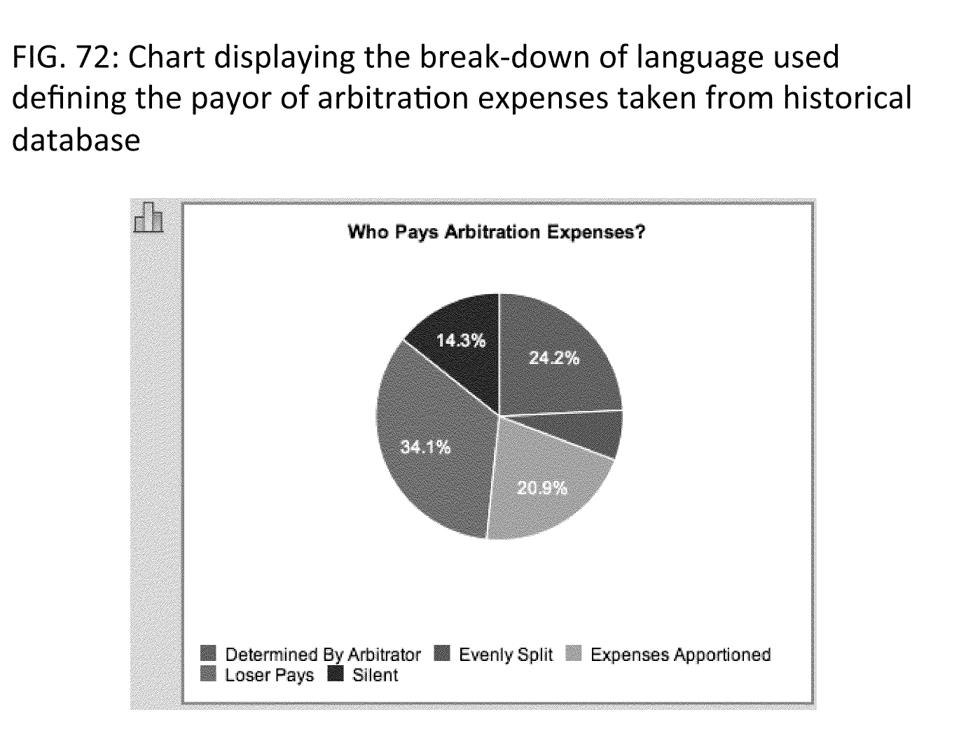

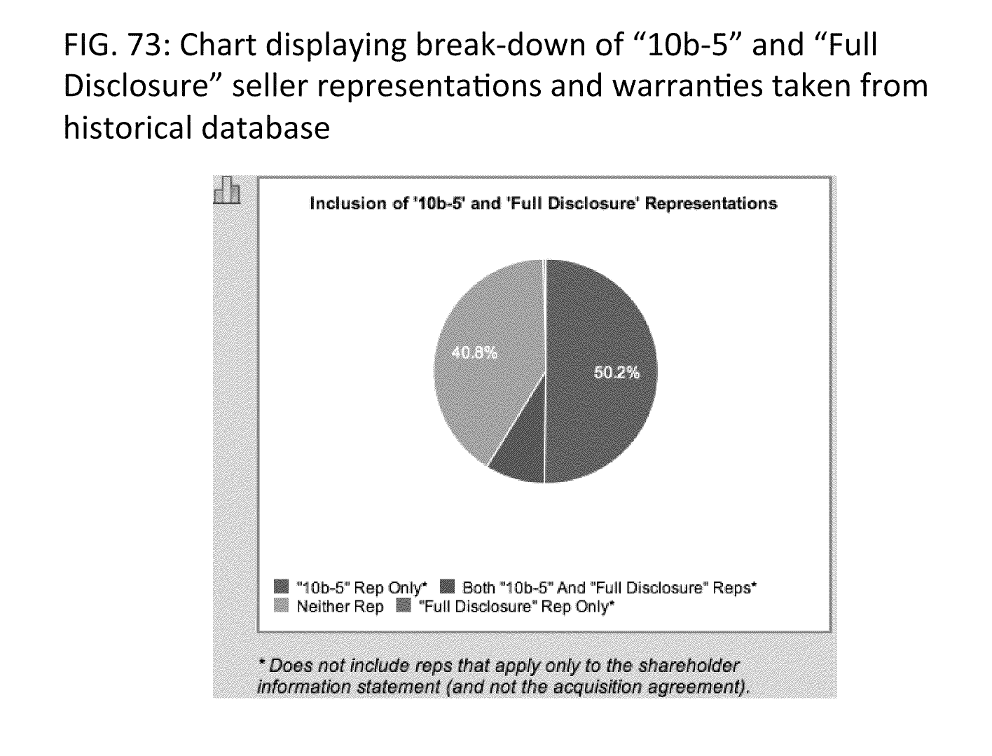

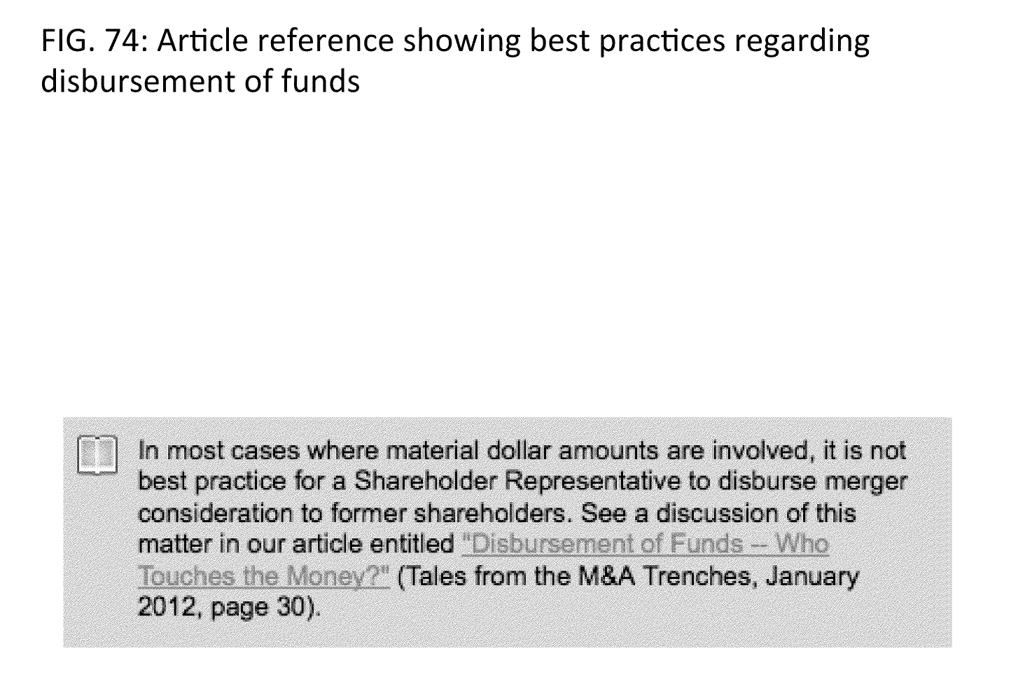

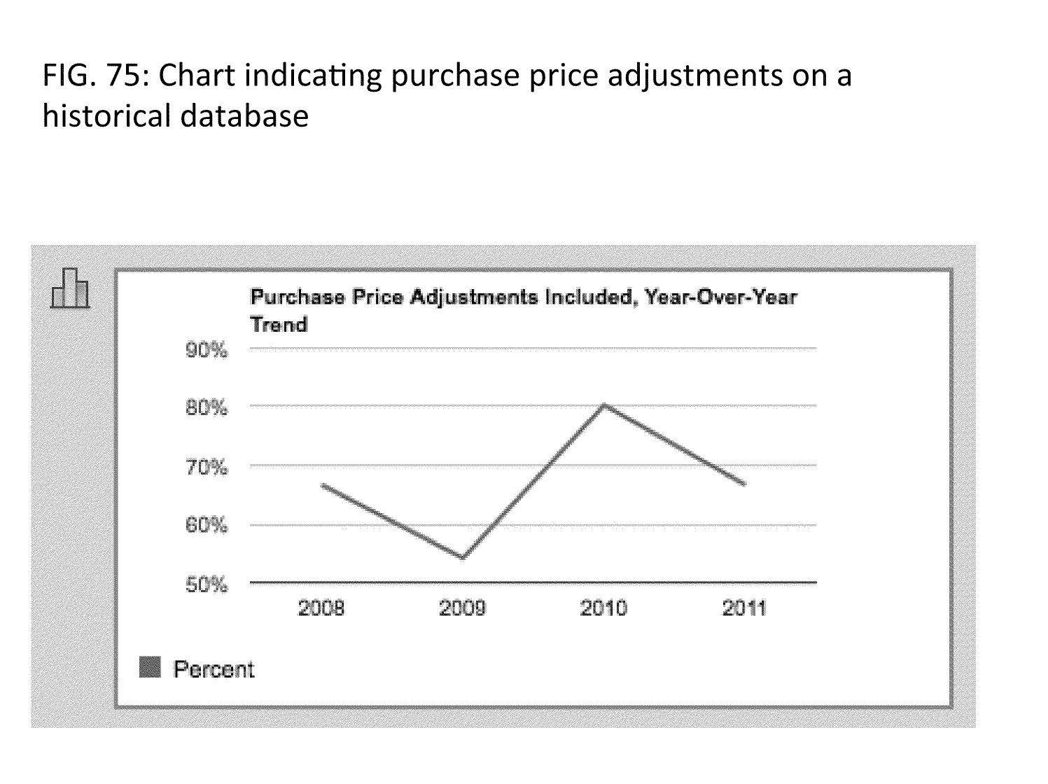

FIGS. 21-75 shows examples of annotations that may be suitable for an M&A agreement. (These figures only show the annotation portion of the display screen.) As discussed above, each of these annotations are built from information retrieved from a data source. In the case of the charts, graphs and the like, the annotations are created on-the-fly using the data stored in the electronic data source. The data stored in the electronic data source includes data related to a plurality of different metrics in M&A transactions. If the present invention is used to annotate documents in other fields, the metrics will relate to the respective fields.

Referring again to FIGS. 2-7, the user interface 200 provides a document editing environment for viewing the agreement document. In the preferred embodiment of FIGS. 2-7, the document editing environment includes a first region that displays the agreement document, and a second region that displays annotations of the agreement document. The second region is preferably presented to the right of the first region for maximum viewing efficiency and comprehension of how the agreement text relates to the respective annotations. However, in alternative embodiments of the present invention, other display layouts may be used to show the agreement document and the annotations. For example, the second region may by an overlay on the first region. The second region may also be on a separate display screen that can be toggled back and forth with respect to the first region. The second region could be shown as “pop up” data, which displays in response to a mouse click or the user moving (hovering) the pointing device over the inline annotation icon in the document text. The annotation icons, such as icon 401 shown in FIG. 4, may be hyperlinks that upon clicking, load a new page that shows the second region.

The present invention may be implemented with any combination of hardware and software. If implemented as a computer-implemented apparatus, the present invention is implemented using means for performing all of the steps and functions described above.

When implemented in software, the software code can be executed on any suitable processor or collection of processors, whether provided in a single computer or distributed among multiple computers.

The present invention can also be included in an article of manufacture (e.g., one or more computer program products) having, for instance, computer readable storage media. The storage media has computer readable program code stored therein that is encoded with instructions for execution by a processor for providing and facilitating the mechanisms of the present invention. The article of manufacture can be included as part of a computer system or sold separately.

The storage media can be any known media, such as computer memory, one or more floppy discs, compact discs, optical discs, magnetic tapes, flash memories, circuit configurations in Field Programmable Gate Arrays or other semiconductor devices, or other tangible computer storage medium. The storage media can be transportable, such that the program or programs stored thereon can be loaded onto one or more different computers or other processors to implement various aspects of the present invention as discussed above.

The computer(s) used herein may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable, mobile, or fixed electronic device.

The computer(s) may have one or more input and output devices. These devices can be used, among other things, to present a user interface. Examples of output devices that can be used to provide a user interface include printers or display screens for visual presentation of output and speakers or other sound generating devices for audible presentation of output.

Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The terms “program” or “software” are used herein in a generic sense to refer to any type of computer code or set of computer-executable instructions that can be employed to program a computer or other processor to implement various aspects of the present invention as discussed above. The computer program need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, and the like, that perform particular tasks or implement particular abstract data types. The functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Preferred embodiments of the present invention may be implemented as methods, of which examples have been provided. The acts performed as part of the methods may be ordered in any suitable way. Accordingly, embodiments may be constructed in which acts are performed in an order different than illustrated, which may include performing some acts simultaneously, even though such acts are shown as being sequentially performed in illustrative embodiments.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A machine-implemented method of annotating portions of a transactional legal document related to a merger or acquisition of a business entity using a computer, the method comprising:
(a) maintaining using the computer an electronic data source that stores data related to
(i) a plurality of different metrics in merger or acquisition transactions, wherein some of the metrics are derived from an analysis of actions that occurred as a result of performance of contracts governed by a plurality of previous transactional legal documents, and
(ii) a hierarchy of concepts relevant to mergers or acquisitions, including associated annotations selected from the group consisting of (A) a detailed analysis of concepts, and (B) metrics of performance of concepts;
(b) updating using the computer at least some of the data as new merger or acquisition transactions occur, the new merger or acquisition transactions providing additional data related to the different concepts and metrics, including the metrics derived from an analysis of actions that occurred as a result of performance of contracts governed by a plurality of previous transactional legal documents;
(c) linking concepts in the hierarchy of concepts using the computer to specific locations in a transactional legal document; and
(d) electronically annotating using the computer portions of the transactional legal document with one or more annotations that graphically display data related to different metrics in merger or acquisition transactions, wherein one or more of the annotations graphically display metrics derived from an analysis of actions that occurred as a result of performance of contracts governed by a plurality of previous transactional legal documents, wherein the annotations are created using the data stored in the electronic data source and linked to the specific location in the transactional legal document, the annotations reflecting the most current data stored in the electronic data source, and wherein at least some of the annotations change over time as new merger or acquisition transactions occur and additional data related to the metrics are obtained and stored in the electronic data source.

2. The method of claim 1 further comprising:
(e) providing a document editing environment on a user interface display screen to a user for viewing the legal document, the document editing environment including a first region that displays the legal document, and a second region that displays annotations of the legal document, wherein step (d) further comprises electronically annotating portions of the legal document with the one or more annotations that graphically display data related to different metrics in merger or acquisition transactions in the second region of the document editing environment.

3. The method of claim 2 wherein the second region is adjacent to the first region.

4. The method of claim 1 wherein the transactional legal document is a merger or acquisition agreement document.

5. The method of claim 1 wherein step (d) further comprises selecting by a user via a user interface display screen the one or more annotations from a plurality of annotation options presented to the user on the screen.

6. The method of claim 1 wherein the electronic data source includes at least one of:
(i) one or more databases, and
(ii) one or more tables, each table being associated with a respective spreadsheet.

7. A tangible computer program product for annotating portions of a transactional legal document related to a merger or acquisition of a business entity, the computer program product comprising non-transitory computer-readable media encoded with instructions for execution by a processor to perform a method comprising:
(a) maintaining an electronic data source that stores data related to:
(i) a plurality of different metrics in merger or acquisition transactions, wherein some of the metrics are derived from an analysis of actions that occurred as a result of performance of contracts governed by a plurality of previous transactional legal documents, and
(ii) a hierarchy of concepts relevant to mergers or acquisitions, including associated annotations selected from the group consisting of (A) a detailed analysis of concepts, and (B) metrics of performance of concepts;
(b) updating at least some of the data as new merger or acquisition transactions occur, the new merger or acquisition transactions providing additional data related to the different metrics, including the metrics derived from an analysis of actions that occurred as a result of performance of contracts governed by a plurality of previous transactional legal documents;
(c) linking concepts in the hierarchy of concepts using the computer to specific locations in a transactional legal document; and
(d) electronically annotating, via the processor, portions of the transactional legal document with one or more annotations that graphically display data related to different metrics in merger or acquisition transactions, wherein one or more of the annotations graphically display metrics derived from an analysis of actions that occurred as a result of performance of contracts governed by a plurality of previous transactional legal documents, wherein the annotations are created using the data stored in the electronic data source and linked to the specific location in the transactional legal document, the annotations reflecting the most current data stored in the electronic data source, and wherein at least some of the annotations change over time as new merger or acquisition transactions occur and additional data related to the metrics are obtained and stored in the electronic data source.

8. The computer program product of claim 7 wherein the instructions for execution by the processor perform a method further comprising:
(e) providing a document editing environment on a user interface display screen to a user for viewing the legal document, the document editing environment including a first region that displays the legal document, and a second region that displays annotations of the legal document, wherein step (d) further comprises electronically annotating portions of the legal document with the one or more annotations that graphically display data related to different metrics in merger or acquisition transactions in the second region of the document editing environment.

9. The computer program product of claim 8 wherein the second region is adjacent to the first region.

10. The computer program product of claim 7 wherein the transactional legal document is a merger or acquisition agreement document.

11. The computer program product of claim 7 wherein step (d) further comprises selecting by a user via a user interface display screen the one or more annotations from a plurality of annotation options presented to the user on the screen.

12. The computer program product of claim 7 wherein the electronic data source includes at least one of:
(i) one or more databases, and
(ii) one or more tables, each table being associated with a respective spreadsheet.
